(19) United States
(12) Patent Application Publication
(10) Pub. No.: US 2007/0174356 A1
(43) Pub. Date: Jul. 26, 2007

(54) Program execution device, program execution method, and program

(75) Inventors: Yuki Horii, Osaka (JP); Takakazu Shiomi, Osaka (JP); Yoshio Kawakami, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/597,779

(22) PCT Filed: Feb. 7, 2005
(86) PCT No.: PCT/JP05/01780

§ 371 Date: Aug. 8, 2006

(30) Foreign Application Priority Data
Feb. 10, 2004 (JP) 2004-033167

(51) Int. Cl. G06F 17/30

(52) U.S. Cl. 707/203

(57) ABSTRACT

There is provided a program execution device which a user can use with peace of mind. The program execution device includes: a secondary storage unit (510) having an area for storing a downloaded application program (application); a stored application determination unit (2602) which determines, based on a priority assigned to each of plural applications, whether or not the secondary storage unit (510) can store each application; a notification unit (2605) which notifies the user of a message regarding treatment of an application determined by the stored application determination unit (2602) to be unstorable; a storage unit (2603) which stores, in the stored application determination unit (2602), an application determined by the secondary storage unit to be storable (510); and a CPU (514) which executes the application stored in the secondary storage unit (510).

### TECHNICAL FIELD

The present invention relates to a program execution device that downloads and executes a program, and particularly to technology for managing an area where an application program is saved in a digital broadcast receiver, in which the area where the downloaded application program is saved has limited space.

### BACKGROUND ART

Technology for managing an area where an application is saved in a digital broadcast receiver, in which the area where the downloaded application program (hereafter, simply “application”) is saved has limited space, can be found in the OCAP specifications (OCAP 1.0 Profile OC-SP-OCAP 1.0-IF-I09-031121). In a digital broadcast receiver compliant with the OCAP specifications, upon receiving a save request and an execute request for an application, a digital broadcast receiver saves and executes the application in accordance with those requests. Here, the save request for the application is a request to save to a secondary storage memory such as a flash ROM. Hereafter, an area for saving the application is called a storage area; saving the application to the storage area is called storing; and a priority for saving the application to the storage area is called a storage priority. Here, a definition of the storage priority can be found in the OCAP specifications under “storage priority”.

In the case where a storage request for plural applications is received and the storage area is insufficient, the digital broadcast receiver compares the storage priority of the individual applications and preferentially stores the applications with a high storage priority. Here, in the case where some applications are already stored, these applications are deleted from the storage area in order, starting with applications with a low storage priority. However, operation of the application currently being executed must not be disturbed.

In the case of identical storage priorities, determination of which to store depends on the implementation status. In such a manner, by deleting or storing an application from or in the storage area, it is possible to always store, preferentially, the application with a high storage priority, from among the applications for which a storage request has been received.

Like the present invention, a proposal for notifying a user when a storage area is insufficient for an application has been given in Patent Reference 1 (Japanese Laid-Open Patent Application No. 6-324812 Publication, “External Storage Writing Method for Image Data”).

Patent Reference 1 provides a means for notifying a user of an amount of remaining space in which saving is possible when, at the time of a request to additionally write a file, writing of the file is rejected upon obtaining a comparison result indicating that the space remaining in the save area is less than the size of the file.

FIG. 1 is a flowchart showing an external storage writing method for image data, as described in Patent Reference 1.

The physical available space in each block of the external storage, which has been divided into the blocks, is calculated (S5000); the space remaining in the external storage is determined by subtracting a value, in which the total number of blocks is multiplied by the maximum data size of one image, from the calculated value (S5002); if the size of the image data specified to be additionally written is known, that value is determined to be the file size, and if the size is not known, the maximum size of the image is determined to be the file size (S5003). The file size is compared with the space remaining in the external storage (S5004); writing of the image data is rejected when a result of the comparison indicates that the space remaining is insufficient for the file size (S5006); a block with physical remaining space larger than the file size is searched for when the result of the comparison indicates that the remaining space is sufficient for the file size (S5008); and the image data is written into the block indicated by the search result in additional mode (S5010).

Thus, with the technology of Patent Reference 1, the user can know that it is not possible to store a new application.

In addition, a proposal for carrying out interaction with a user during installation of an application has been made in Patent Reference 2 (Japanese Laid-Open Patent Application No. 10-21058 Publication, “Method and Device for Managing Version of Application Module”).

FIG. 2 is a flowchart showing a processing for a version-upgrade of an application module through the version management method as described in Patent Reference 2.

The version management method described in Patent Reference 2 includes: a version information saving step of saving version information for each module already installed (S5103); a version comparing step of comparing version information for a version of each module to be installed with the version information of the already-installed module that has been saved in the version information saving step (S5105); a messaging step of sending a message, in accordance with a comparison result obtained in the version comparing step, to a user who will carry out installation procedures; a module rewriting step of adding, deleting, or changing each module in accordance with the comparison result obtained in the version comparing step (S5108); and an output step of outputting, to a user interface, one or both of a result of the version comparing step and a result of the messaging step. A selecting step in which the user who performs installation selects adding, deleting, changing, or not changing each module based on the output result obtained from the output step is further proposed as an addition to the version management method.

Thus, with Patent Reference 2, at the time of installation of an identical application, the application is updated based on the version information comparison. At this time, a means for displaying the message to the user in accordance with the version information comparison result, and furthermore, a means for allowing the user to select adding, deleting, changing, or not changing the application, are provided. Through this technology, it is possible for the user to know that an application is newly installed. Moreover, it is possible to control the installation procedure in the case where installation that rolls back to an older version is carried out.

### DISCLOSURE OF INVENTION

Problems that Invention is to Solve

However, in a digital broadcast receiver (program execution device) described in the OCAP specifications, in the case where a storage area is insufficient at the time of a storage request for an application, the application is stored in/deleted from the storage area based on a result of comparing storage priorities of applications, but because the storage operation for the application is performed automatically, it is not possible for the user to know the result of the storage operation for the application; for example, which application has been stored in/deleted from the storage area.

For this reason, the user cannot know of a change in the behavior of the application caused by a result of the storage operation such as deletion of the application from the storage area, such as, for example, when startup of the application is slow; there is concern that the user will experience anxiety when starting the application that has been deleted from storage because the startup of the application is slow.

In Patent Reference 1, there is no means for deleting an already-stored application; therefore, no means for notifying the user that the application has been deleted from storage is provided. Moreover, the technology of Patent Reference 1 does not make use of a storage priority.

In addition, Patent Reference 2 deals with a function for replacing identical applications; a certain application being installed results in insufficient space in the install destination, and other applications are not deleted. Therefore, Patent Reference 2 does not provide a means for deleting an already-installed application from the storage area based on a comparison of storage priorities upon receiving a request to newly store an application, and does not provide a means for notifying the user that an already-stored application has been deleted from the storage area.

Accordingly, an object of the present invention is to provide a program execution device that a user can use with peace of mind.

Means to Solve the Problems

To solve the abovementioned problems, a program execution device according to the present invention is a program execution device that downloads and executes a program, and includes: a storage unit having an area for storing the downloaded program; a storage judgment unit that judges whether or not it is possible for each of plural programs, including a program to be downloaded, to be held in the storage unit, based on a priority assigned to each of the programs; a notification unit that notifies a user of a message regarding treatment of the program judged by the storage judgment unit as being impossible to be held; a storage processing unit operable to store, in said storage unit, the program to be downloaded which has been judged by said storage judgment unit as being possible to be held; and an execution unit operable to execute the program stored in said storage unit. Also, for example, the program execution device may further include a deletion unit which deletes a program stored in the storage unit, the program having been judged by the storage judgment unit as being impossible to be held; the notification unit notifies the user of a message regarding the deletion of the program; and the storage processing unit stores, in the storage unit from which the program has been deleted, the program to be downloaded that has been judged by the storage judgment unit as being possible to be held. In addition, the deletion unit deletes the program stored in the storage unit after detecting that the user has been notified by the notification unit.

To be more specific, when a new program is downloaded while there is already a program stored in the storage unit, there are cases in which the programs cannot be held in the storage unit together. In such cases, with the program execution device according to the present invention, the priority of the new program is compared with the priority of the program already stored in the storage unit; when the priority of the program stored in the storage unit is lower, that program is deleted from the storage unit, and a message regarding the deletion of that program is provided to the user. Therefore, even if there is a change in the behavior of the program execution device due to the deletion, the user knows the reason for this change from the message, and thus can use the program execution device with peace of mind.

In addition, the notification unit may notify the user of a message requesting the user to confirm the deletion of the program stored in the storage unit; the program execution device may further include a confirmation acquisition unit that acquires a result of a confirmation which the user has made in response to the message, and the deletion unit may delete the program stored in the storage unit upon detecting that the confirmation acquisition unit has acquired the result of the confirmation.

Through this, the program is deleted after the user confirms the message; therefore, it is possible to prevent the program from being deleted without the user confirming the message, and possible to reliably provide the message to the user.

Moreover, the notification unit may notify the user of a message inquiring whether or not it is acceptable to delete the program stored in the storage unit, and the program execution device may further include an answer acquisition unit that acquires a result of an answer which the user has made in response to the message; the deletion unit may delete the program stored in the storage unit upon detecting that the result of the answer acquired by the answer acquisition unit indicates that deletion has been allowed.

Through this, the program is deleted after receiving permission to delete the program from the user; therefore, it is possible to prevent the program from being deleted without permission from the user, thus improving the usability.

Here, the program execution device may further include a priority change unit that raises the priority of the program stored in the storage unit, the program having been judged by the storage judgment unit as being impossible to be held, upon detecting that the result of the answer acquired by the answer acquisition unit indicates that deletion has been rejected; the storage judgment unit may judge, again, whether or not it is possible to hold each of the programs in the storage unit, based on the priority changed by the priority change unit.

Through this, when the user rejects deletion of the program, the priority of that program is raised, and a program that cannot be stored is once again selected from among the plural programs based on that priority; therefore, a program unnecessary to the user can be deleted, and the usability improved.

Moreover, the storage judgment unit may further judge whether or not the plural programs judged as being impossible to be held are stored in the storage unit; the notification unit may notify the user of a message prompting selection of which program, from among the plural programs judged to be stored by the storage judgment unit, to delete. The program execution device may further include a selection result acquisition unit that acquires a result of the selection made by the user in response to the message; the deletion unit is operable to delete the program indicated by the result of the selection acquired by said selection result acquisition unit.

For example, in a situation where the capacity of the storage unit is too small to store two programs together in the storage unit, but one of the programs can be stored, and the priorities of the two programs are identical, the storage judgment unit cannot judge the merits/demerits of each program, and thus judges that both programs cannot be stored. As mentioned above, the present invention allows the user to select which of the two programs to delete even when such a case arises; therefore, it is possible to delete a program unnecessary to the user, and improve the usability.

In addition, the program execution device may further include an execution judgment that judges whether or not the program, which has been judged by the storage judgment unit as being impossible to be held, is being executed by the execution unit; and the notification unit may notify the user of a message regarding deletion of the program judged by the execution judgment unit as being executed. For example, the deletion unit terminates execution of the program judged by the execution judgment unit as being executed, and deletes the program.

Through this, when the program being executed is judged as being impossible to be held, the user is notified, and the program is forcibly terminated and deleted; therefore, it is possible to set the space required for saving the program to be downloaded in the storage unit in a timely manner.

Here, the notification unit may notify the user of a message inquiring whether or not it is acceptable to delete the program judged by the execution judgment unit as being executed. The program execution device may further include an answer acquisition unit that acquires a result of an answer which the user has made in response to the message, and the deletion unit may terminate and delete the program being executed, upon detecting that the result of the answer acquired by the answer acquisition unit indicates that deletion has been allowed.

Through this, the user can select whether or not to delete the program, thus improving the usability.

In addition, upon detecting that the program being executed has been terminated based on a result of the judgment carried out by the execution judgment unit, the deletion unit may delete the program.

Through this, when the program being executed is judged as being impossible to be held, the user is notified, and the program being executed is deleted after waiting for it to terminate; therefore, the program being executed can be used by the user with peace of mind.

Moreover, the notification unit may notify the user of a message regarding storage of the program to be downloaded that has been judged by the storage judgment unit as being impossible to be held. For example, the storage judgment unit may further judge whether or not the plural programs judged as being impossible to be held are stored in the storage unit, and the notification unit may notify the user of a message prompting selection of which program to store, from among the plural programs judged not to be stored by the storage judgment unit. The program execution device may further include a selection result acquisition unit that acquires a result of the selection made by the user in response to the message, and the deletion may store the program indicated in the result of the selection acquired by the selection result acquisition unit.

For example, in a situation where the capacity of the storage unit is too small to store two programs together in the storage unit, but one of the programs can be stored, and the priorities of the two programs are identical, the storage judgment unit cannot judge the merits/demerits of each program, and thus judges that both programs cannot be stored. As mentioned above, the present invention allows the user to select which of the two programs to save even when such a case arises; therefore, it is possible to delete a program unnecessary to the user, and improve the usability.

Note that the present invention can be realized not only as a program execution device, but also as a method or program that for performing the operations of the program execution device, as well as a storage medium for storing that program.

### EFFECTS OF THE INVENTION

The program execution device of the present invention provides an operational effect in which a user can use the device with peace of mind.

### BRIEF DESCRIPTION OF DRAWINGS

FIG. 1 is a flowchart showing a conventional external storage writing method for image data.

FIG. 2 is a flowchart showing a processing for a version-upgrade of an application module through a conventional version management method.

FIG. 3 is a block diagram of a cable system according to the first embodiment of the present invention.

FIG. 4 is a diagram showing an example of the usage of frequency bands used for communications between the head end and the terminal apparatuses in the cable system according to the present invention.

FIG. 5 is a diagram showing an example of the usage of frequency bands used for communications between the head end and the terminal apparatuses in the cable system according to the present invention.

FIG. 6 is a diagram showing an example of the usage of frequency bands used for communications between the head end and the terminal apparatuses in the cable system according to the present invention.

FIG. 7 is a block diagram of a terminal apparatus (program execution device) according to the present invention.

FIG. 8 is a diagram showing an example of an external appearance of a terminal apparatus according to the present invention.

FIG. 9 is a block diagram showing an internal configuration of a POD according to the present invention.

FIG. 10 is a structural diagram showing an example of a structure of a program stored in the POD according to the present invention.

FIG. 11 is a diagram showing a structure of a packet defined by the MPEG standard.

FIG. 12 is a diagram showing an example of an MPEG-2 transport stream.

FIG. 13 is a diagram showing an example of an external appearance of an input unit in the case where it is configured as a front panel.

FIG. 14 is a diagram showing a structure of a program stored in a terminal apparatus according to the present invention.

FIG. 15A is a diagram showing an example of a display screen displayed by the display according to the present invention.

FIG. 15B is a diagram showing an example of a display screen displayed by the display according to the present invention.

FIG. 16 is a diagram showing an example of information stored in a secondary storage unit 510 according to the present invention.

FIG. 17A is a diagram showing an example of information stored in a primary storage unit 511 according to the present invention.

FIG. 17B is a diagram showing an example of information stored in a primary storage unit 511 according to the present invention.

FIG. 17C is a diagram showing an example of information stored in a primary storage unit 511 according to the present invention.

FIG. 18 is a schematic diagram showing the details of a PAT specified by the MPEG-2 standard according to the present invention.

FIG. 19 is a schematic diagram showing the details of a PMT specified by the MPEG-2 standard according to the present invention.

FIG. 20 is a schematic diagram showing details of AIT prescribed by the OCAP specifications according to the present invention.

FIG. 21 is a schematic diagram showing a file system sent in DSMCC format according to the present invention.

FIG. 22 is a schematic diagram showing details of XAIT according to the present invention.

FIG. 23 is a diagram showing an example of information stored in a secondary storage unit according to the present invention.

FIG. 24 is a diagram showing an example of a state in which an application described in the XAIT information is stored in a storage area for the application, according to the present invention.

FIG. 25 is a flowchart showing an example of a process from when an AM accepts XAIT information to when the AM provides an application start instruction to a VM, in the first embodiment of the present invention.

FIG. 26 is a diagram showing an example of a state of an application stored in a storage area in accordance with XAIT information in the first embodiment of the present invention.

FIG. 27 is a diagram showing an example of a state of an application stored in a storage area in accordance with XAIT information in the first embodiment of the present invention.

FIG. 28 is a structural diagram showing a structure of an AM in the first embodiment of the present invention.

FIG. 29 is a flowchart showing an example of an operation of storage processing for an application carried out by an AM that has accepted XAIT information, in the first embodiment of the present invention.

FIG. 30 is a flowchart showing an example of an operation of storage processing for an application carried out by an AM that has accepted XAIT information, in the first embodiment of the present invention.

FIG. 31 is a descriptive diagram for describing a display position of a deletion notification in the first embodiment of the present invention.

FIG. 32 is a flowchart which has consolidated an example of an operation in which an AM stores an application in the first embodiment of the present invention.

FIG. 33 is a diagram showing a deletion notification displayed in a display.

FIG. 34A is a diagram showing an example of a state of an application stored in a storage area prior to acquisition of XAIT information, in the first embodiment of the present invention.

FIG. 34B is a diagram showing an example of a state of an application stored in a storage area after acquisition of XAIT information, in the first embodiment of the present invention.

FIG. 35A is a flowchart showing an example of an operation of storage processing for an application carried out by an AM that has accepted XAIT information, in the first embodiment of the present invention.

FIG. 35B is a flowchart showing an example of an operation of storage processing for an application carried out by an AM that has accepted XAIT information, in the first embodiment of the present invention.

FIG. 36 is a diagram showing an example of a message for prompting selection of an application to store.

FIG. 37 is a structural diagram showing a structure of an AM in the second embodiment of the present invention.

FIG. 38 is a diagram showing an example of a deletion notification in the second embodiment of the present invention.

FIG. 39 is a flowchart showing an example of an operation of storage processing for an application carried out by an AM that has accepted XAIT information, in the second embodiment of the present invention.

FIG. 40 is a diagram showing an example of a deletion notification in the third embodiment of the present invention.

FIG. 41 is a flowchart showing an example of an operation of storage processing for an application carried out by an AM that has accepted XAIT information, in the third embodiment of the present invention.

FIG. 42 is a flowchart showing an example of an operation of storage processing for an application carried out by an AM that has accepted XAIT information, in the third embodiment of the present invention.

FIG. 43 is a flowchart showing an example of an operation of storage processing for an application, and treatment of XAIT information, carried out by an AM that has accepted XAIT information from a head end, in the fourth embodiment of the present invention.

FIG. 44 is a flowchart showing an example of an operation of a monitor application in the fourth embodiment of the present invention.

FIG. 45 is a structural diagram showing a structure of an AM in the fifth embodiment of the present invention.

FIG. 46 is a flowchart showing an example of an operation of storage processing for an application carried out by an AM that has accepted XAIT information, in the fifth embodiment of the present invention.

FIG. 47 is a flowchart showing an example of an operation of storage processing for an application carried out by an AM that has accepted XAIT information, in the fifth embodiment of the present invention.

FIG. 48 is a diagram showing an example of an enquiry dialog in the fifth embodiment of the present invention.

FIG. 49 is a diagram showing another example of an enquiry dialog in the fifth embodiment of the present invention.

FIG. 50 is a diagram showing yet another example of an enquiry dialog in the fifth embodiment of the present invention.

FIG. 51 is a flowchart showing an example of an operation of storage processing for an application carried out by an AM that has accepted XAIT information, in the sixth embodiment of the present invention.

FIG. 52 is a flowchart showing an example of an operation of storage processing for an application carried out by an AM that has accepted XAIT information, in the sixth embodiment of the present invention.

FIG. 53 is a diagram showing an example of a dialog in the sixth embodiment of the present invention.

FIG. 54 is a flowchart showing an example of an operation of storage processing for an application carried out by an AM that has accepted XAIT information, in the seventh embodiment of the present invention.

FIG. 55 is a diagram showing an example of a message in the seventh embodiment of the present invention.

FIG. 56 is a diagram showing an example of XAIT information necessary for downloading a Java program via IP.

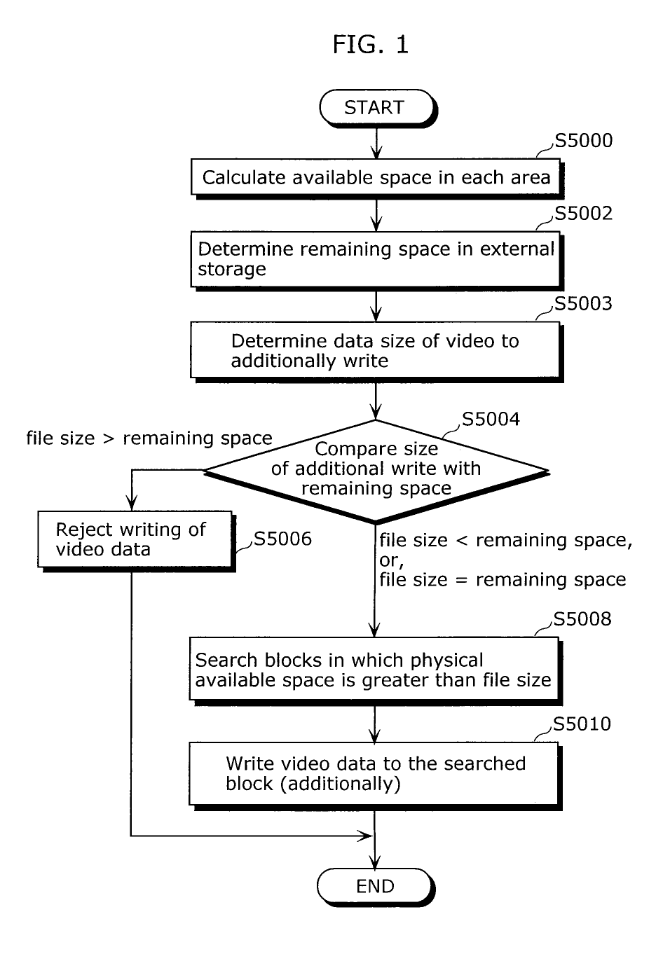

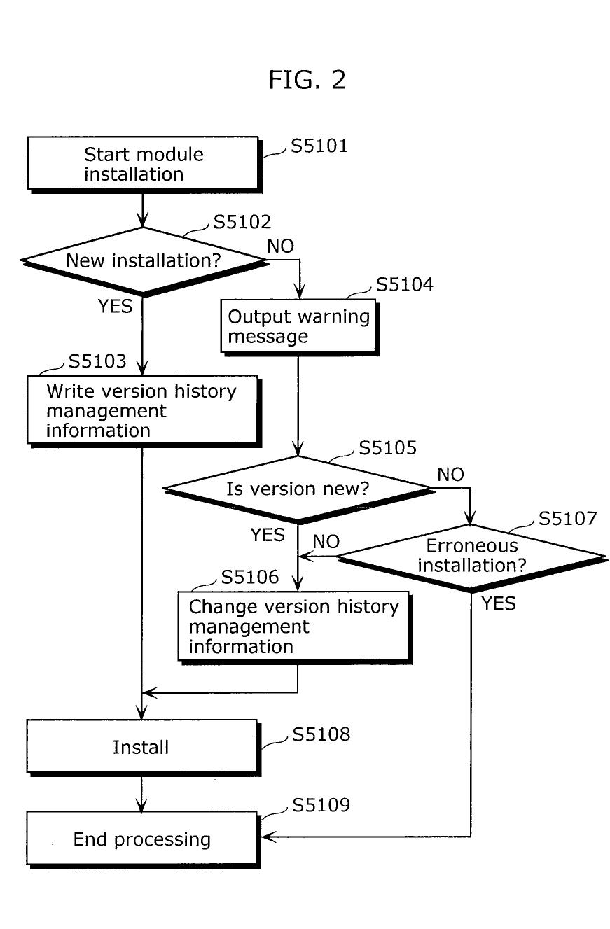

### NUMERICAL REFERENCES

1200 program

1201 OS

1201a kernel

1201b library

1202 EPG

1202a TV show display unit

1202b reproduction unit

1203 VM

1204 service manager

1205 library

1205a JMF

1205b AM

1205c Tuner

1205d CA

1205e PODLib

2601 storage priority comparison unit

2602 stored application determination unit

2603 storage unit

2604 storage deletion unit

2605 notification unit

2606 storage area remaining space acquisition unit

2607 application size acquisition unit

### BEST MODE FOR CARRYING OUT THE INVENTION

### First Embodiment

The embodiment of the cable television system in the present invention shall be explained with reference to the diagrams.

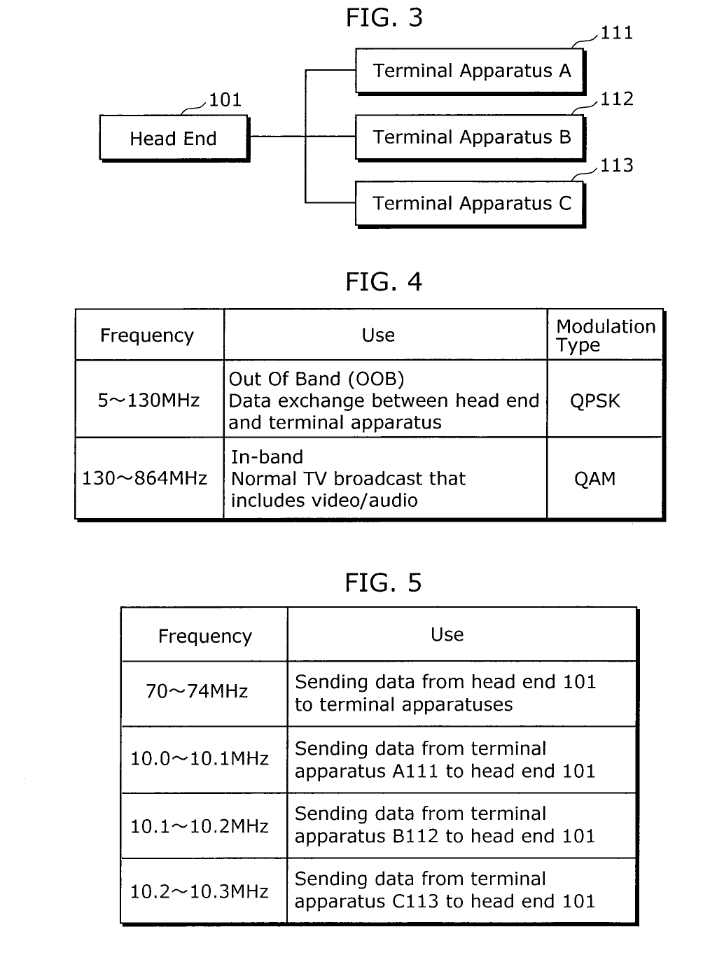

FIG. 3 is a block diagram expressing a relationship between apparatuses that make up the cable system. This cable system is configured of a head end 101 and three terminal apparatuses, a terminal apparatus A111, a terminal apparatus B112, and a terminal apparatus C113, which are program execution devices. In the present embodiment, three terminal apparatuses are connected to one head end, but it is possible to implement the present invention even with an arbitrary number of terminal apparatuses being connected to the head end.

The head end 101 transmits, to plural terminal apparatuses, broadcast signals such as video, audio and data, and receives data transmissions from the terminal apparatuses. In order to realize this, frequency bands are divided for use in data transmission between the head end 101, and the terminal apparatus A111, the terminal apparatus B112, and the terminal apparatus C113.

FIG. 4 is a diagram showing one example of a division of the frequency bands. The frequency band is roughly divided into two types: Out Of Band (abbr. OOB) and In-Band. A frequency band of 5 to 130 MHz is allocated to OOB to be mainly used for data exchange between the head end 101 and the terminal apparatus A111, the terminal apparatus B112, and the terminal apparatus C113. 130 MHz to 864 MHz is assigned as In-Band, and is mainly used in a broadcast channel including video and audio. QPSK is employed for OOB, whereas QAM64 is employed for In-Band as modulation techniques. Modulation type technology is generally known and of little concern to the present invention, and therefore detailed descriptions are omitted.

FIG. 5 is a diagram showing one example of further detailed use of the OOB frequency band. A frequency band of 70 MHz to 74 MHz is used to transmit data from the head end 101; all of the terminal apparatus A111, the terminal apparatus B112, and the terminal apparatus C113 receive the same data from the head end 101. On the other hand, a frequency band of 10.0 MHz to 10.1 MHz is used to transmit data from the terminal apparatus A111 to the head end 101; a frequency band of 10.1 MHz to 10.2 MHz is used to transmit data from the terminal apparatus B112 to the head end 101; and a frequency band of 10.2 MHz to 10.3 MHz is used to transmit data from the terminal apparatus C113 to the head end 101. Accordingly, data which is unique to each terminal apparatus can be transmitted to the head end 101 from each of the terminal apparatus A111, the terminal apparatus B112, and the terminal apparatus C113.

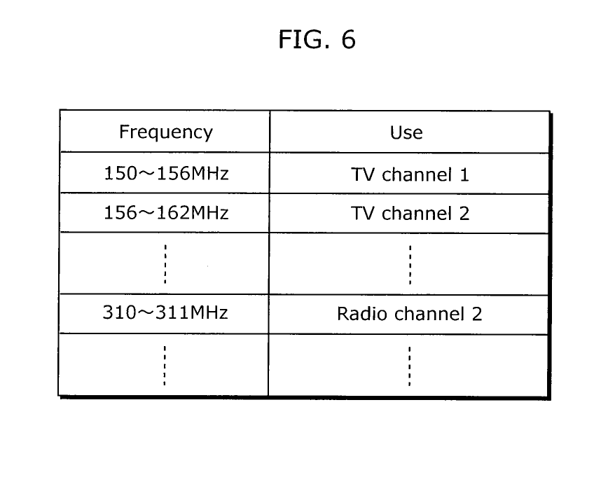

FIG. 6 is a diagram showing one example of use of an In-Band frequency band. 150 MHz to 156 MHz and 156 MHz to 162 MHz are assigned to a TV channel 1 and a TV channel 2 respectively, and thereafter, TV channels are assigned in 6 MHz intervals. Radio channels are assigned in 1 MHz units from 310 MHz on. Each of these channels may be used as analog broadcast or as digital broadcast. In the case of digital broadcast, data is transferred in the transport packet format compliant with the MPEG-2 specifications, in which case data intended for various data broadcast can be transmitted, in addition to audio and video.

The head end 101 is equipped with a QPSK modulation unit, a QAM modulation unit, and the like in order to transmit suitable broadcast signals in the respective frequency ranges. In addition, the head end 101 has a QPSK demodulator for receiving data from the terminal apparatuses. Also, the head end 101 is assumed to be further equipped with various devices related to the above modulation units and demodulation unit. However, the present invention relates mainly to the terminal apparatuses, and therefore detailed descriptions are omitted.

The terminal apparatus A111, the terminal apparatus B112, and the terminal apparatus C113 receive and reproduce broadcast signals transmitted from the head end 101. Furthermore, the terminal apparatus A111, the terminal apparatus B112, and the terminal apparatus C113 transmit data unique to each terminal apparatus to the head end 101. In the present embodiment, these three terminal apparatuses have the same configuration.

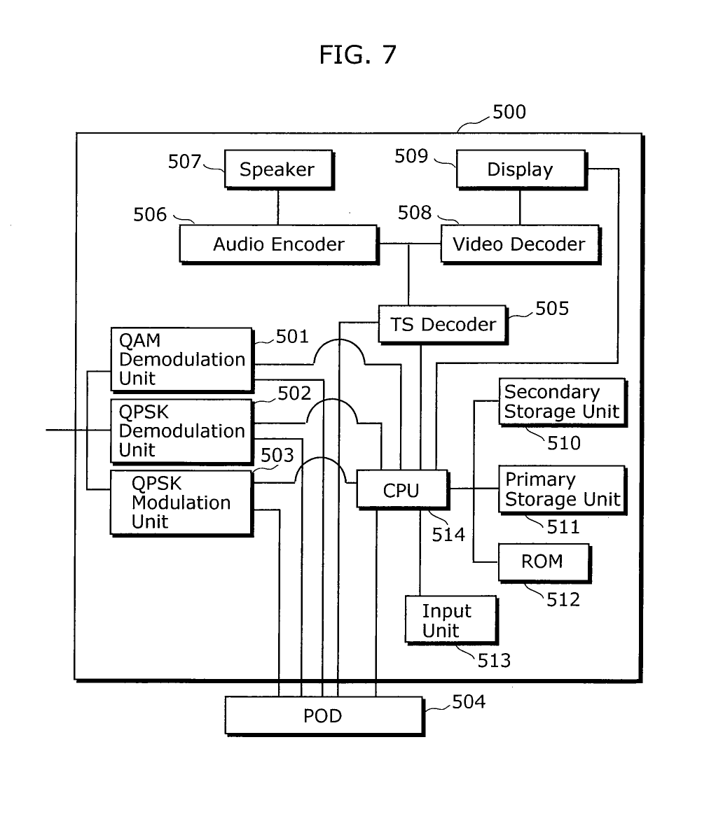

FIG. 7 is a block diagram expressing a hardware configuration of the terminal apparatus (program execution device). A terminal apparatus 500, which is equivalent to each of the abovementioned terminal apparatus A111, terminal apparatus B112, and terminal apparatus C113, is made up of a QAM demodulation unit 501, a QPSK demodulation unit 502, a QPSK modulation unit 503, a TS decoder 505, an audio decoder 506, a speaker 507, a video decoder 508, a display 509, a secondary storage unit 510, a primary storage unit 511, a ROM 512, an input unit 513, and a CPU 514. Furthermore, a POD 504 can be attached to/detached from the terminal apparatus 500.

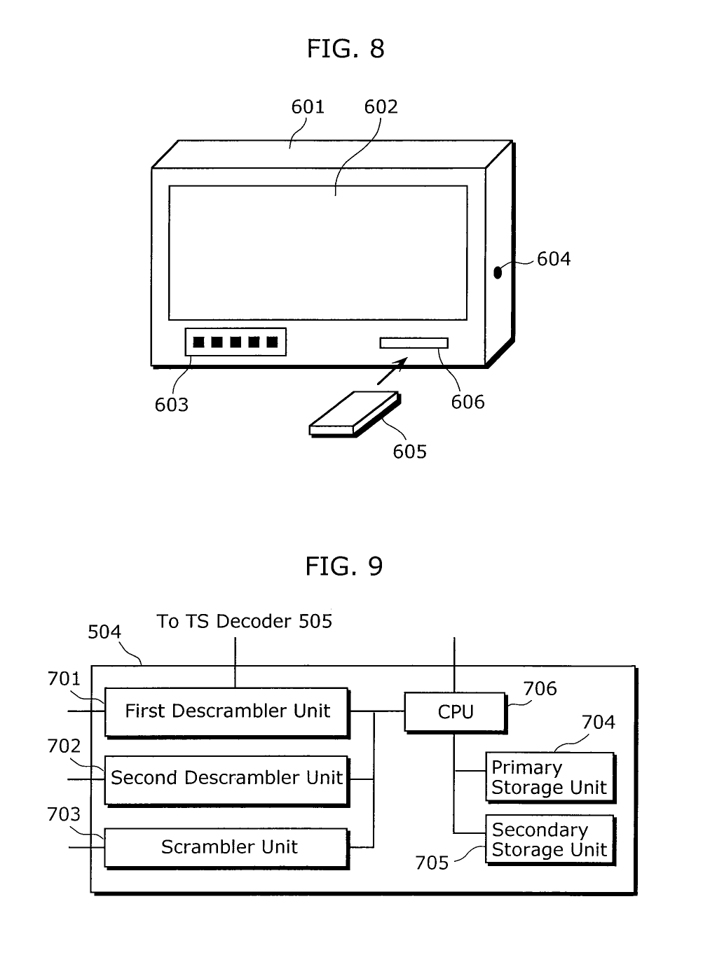

FIG. 8 is a diagram showing an example of an external appearance of the terminal apparatus 500 that is configured as a flat-panel TV.

601 is a housing of the flat-panel TV, which contains all constituent elements of the terminal apparatus 500 except for the POD 504.

A display 602 corresponds to the display 509 in FIG. 7. A front panel unit 603 is configured of a plurality of buttons, and corresponds to the input unit 513 in FIG. 7.

604 is a signal input terminal, to which a cable line is connected for transmitting/receiving signals to and from the head end 101. In addition, the signal input terminal 604 is connected to the QAM demodulation unit 501, the QPSK demodulation unit 502, and the QPSK modulation unit 503 shown in FIG. 7.

A POD card 605 corresponds to the POD 504 in FIG. 7. The POD 504 is embodied independently of the terminal apparatus 500 and can be attached to/detached from the terminal apparatus 500, as in the case of the POD card 605 in FIG. 8. A detailed description of the POD 504 is given later.

The POD card 605 is inserted into an insertion slot 606. As shown in FIG. 7, the QAM demodulation unit 501 demodulates a signal which has been QAM-modulated in and transmitted from the head end 101, according to tuning information that includes a frequency specified by the CPU 514, and passes the resultant to the POD 504.

The QPSK demodulation unit 502 demodulates a signal which has been QPSK-modulated in and transmitted from the head end 101, according to tuning information that includes a frequency specified by the CPU 514, and passes the resultant to the POD 504.

The QPSK modulation unit 503 QPSK-modulates a signal passed from the POD 504, according to modulation information that includes a frequency specified by the CPU 514, and transmits the resultant to the head end 101.

As shown in FIG. 8, the POD 504 is detachable from the main body of the terminal apparatus 500. The definition of the connection interface between the main body of the terminal 500 and the POD 504 is given in OpenCable (R) HOST-POD Interface Specification (OC-SP-HOSTPOD-IF-I12-030210) and in specifications referred to by this specification. Here, a detailed description is omitted, and description is given only of portions relevant to the present invention.

FIG. 9 is a block diagram showing an internal configuration of the POD 504. The POD 504 is made up of a first descrambler unit 701, a second descrambler unit 702, a scrambler unit 703, a primary storage unit 704, a secondary storage unit 705, and a CPU 706.

The first descrambler unit 701, under instruction from the CPU 706, receives a scrambled signal from the QAM demodulation unit 501 of the terminal apparatus 500 and descrambles the signal. Then, the first descrambler unit 701 transmits the descrambled signal to the TS decoder 505 of the terminal apparatus 500. Information required for decoding such as a key is provided by the CPU 706 as necessary. More specifically, the head end 101 broadcasts several fee-based channels, and when the user purchases the right to view these fee-based channels, the first descrambler unit 701 receives required information such as a key from the CPU 706 and performs descrambling, and the user is able to view these fee-based channels. When required information such as a key is not provided, the first descrambler unit 701 passes the received signal directly to the TS decoder 505 without performing descrambling.

The second descrambler unit 702, under instruction from the CPU 706, receives a scrambled signal from the QPSK demodulation unit 502 of the terminal apparatus 500 and descrambles the signal. Then, the second descrambler unit 702 passes the descrambled data to the CPU 706.

The scrambler unit 703, under instruction from the CPU 706, scrambles the data received from the CPU 706 and sends the resultant to the QPSK modulation unit 503 of the terminal apparatus 500.

The primary storage unit 704, specifically made up of a primary memory such as a RAM, is utilized for storing data temporarily when the CPU 706 performs processing.

The secondary storage unit 705, specifically made up of a secondary storage memory such as a flash ROM, is utilized for storing a program to be executed by the CPU 706 as well as for storing data which should not be deleted even when the power is turned off.

The CPU 706 executes the program stored in the secondary storage unit 705. The program is made up of plural subprograms.

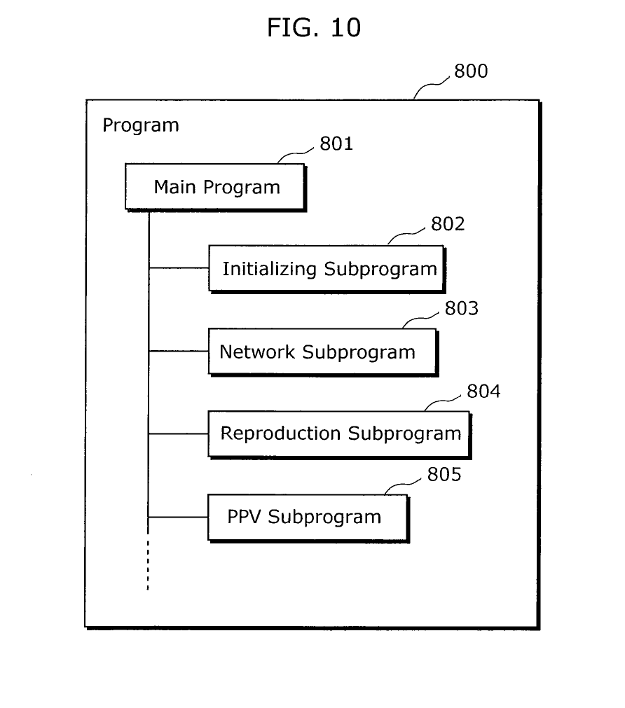

FIG. 10 is a diagram showing an example of the program stored in the secondary storage unit 705. In FIG. 10, a program 800 is made up of plural subprograms including a main program 801, an initialization subprogram 802, a network subprogram 803, a reproduction subprogram 804, and a PPV subprogram 805.

Here, PPV, which is an abbreviation of Pay Per View, refers to a service that allows the user to view a certain TV show, such as a movie, by paying a fee. When the user enters his/her personal identification number, the purchase of the right to view the program is notified to the head end 101, scrambling is cancelled, and the program can be viewed by the user. With this viewing, the user is required to pay the purchase price at a later date.

The main program 801, which is the first subprogram activated by the CPU 706 when the power is turned on, controls the other subprograms.

The initialization subprogram 802, which is activated by the main program 801 when the power is turned on, performs information exchange with the terminal apparatus 500 and performs initialization processing. This initialization processing is defined in detail in OpenCable (R) HOST-POD Interface Specification (OC-SP-HOSTPOD-IF-I12-030210) and in specifications referring to this specification. Furthermore, the initialization subprogram 802 also performs initialization processing not defined in these specifications. Here, a part of this initialization processing is introduced. When the power is turned on, the initialization subprogram 802 notifies the QPSK demodulation unit 502 of a first frequency stored in the secondary storage unit 705 via the CPU 514 of the terminal apparatus 500. The QPSK demodulation unit 502 performs tuning using the provided first frequency, and transmits the resulting signal to the secondary scrambler unit 702. Moreover, the initialization subprogram 802 provides the secondary descrambler unit 702 with descrambling information such as a first key stored in the secondary storage unit 705. As a result, the secondary descrambler unit 702 performs descrambling and passes the resultant to the CPU 706 executing the initialization subprogram 802. Thus, the initialization subprogram 802 can receive the information. In the present embodiment, the initialization subprogram 802 receives information via the network subprogram 803. A detailed description on this is given later.

Furthermore, the initialization subprogram 802 notifies the QPSK modulation unit 503 of a second frequency stored in the secondary storage unit 705 via the CPU 514 of the terminal apparatus 500. The initialization subprogram 802 provides the scrambler unit 703 with scrambling information stored in the secondary storage unit 705. When the initialization subprogram 802 provides, via the network subprogram 803, the scrambler unit 703 with information required to be sent, the scrambler unit 703 scrambles the data using the provided scrambling information, and provides the scrambled data to the QPSK modulation unit 503. The QPSK modulation unit 503 modulates the scrambled information which it received, and sends the modulated information to the head end 101.

As a result, it becomes possible for the initialization subprogram 802 to carry out two-way communications with the head end 101 via the terminal apparatus 500, the secondary descrambler unit 702, the scrambler unit 703, and the network subprogram 803.

The network subprogram 803, which is used by plural subprograms such as the main program 801 and the initialization subprogram 802, is a subprogram intended for carrying out a two-way communication with the head end 101. More specifically, the network subprogram 803 behaves as if other subprograms using the network subprogram 803 were carrying out a two-way communication with the head end 101 in accordance with TCP/IP. A detailed explanation of TCP/IP is omitted here, since it is a publicly known technique for specifying the protocols to be used when exchanging information between plural terminals. When activated by the initialization subprogram 802 when power is turned on, the network subprogram 803 notifies, via the terminal apparatus 500, the head end 101 of a MAC address (an abbreviation of Media Access Control address) which is an identifier for identifying the POD 504 and which is stored in the secondary storage unit 705 beforehand, so as to request for the obtainment of an IP address. The head end 101 notifies the POD 504 of the IP address via the terminal apparatus 500, and the network subprogram 803 stores the IP address in the primary storage unit 704. Thereafter, the head end 101 and the POD 504 communicate with each other using the IP address as the identifier of the POD 504.

The reproduction subprogram 804 provides the first descrambler unit 701 with descrambling information such as a second key stored in the secondary storage unit 705 as well as descrambling information such as a third key provided by the terminal apparatus 500, so as to allow descrambling to be performed. Furthermore, the reproduction subprogram 804 receives, via the network subprogram 803, information indicating that the signal inputted in the first descrambler unit 701 is a PPV channel. On the notification that the signal is a PPV channel, the reproduction subprogram 804 activates the PPV subprogram 805.

When activated, the PPV subprogram 805 displays, on the terminal apparatus 500, a message that prompts the user to purchase the TV show, and accepts an input from the user. More specifically, when information intended to be displayed on the screen is sent to the CPU 514 of the terminal apparatus 500, a program running on the CPU 514 of the terminal apparatus 500 shows the message on the display 509 of the terminal apparatus 500. Then, when the user enters the personal identification number via the input unit 513 of the terminal apparatus 500, the CPU 514 of the terminal apparatus 500 accepts it, and sends it to the PPV subprogram 805 running on the CPU 706 of the POD 504. The PPV subprogram 805 sends, to the head end 101, the accepted personal identification number via the network subprogram 803. When such personal identification number is valid, the head end 101 notifies, via the network subprogram 803, the PPV subprogram 805 of descrambling information required for descrambling such as a fourth key. The PPV subprogram 805 provides the first descrambler unit 701 with the accepted descrambling information such as the fourth key, and then the first descrambler unit 701 descrambles the signal being inputted.

As shown in FIG. 7, the TS decoder 505 performs filtering on the signal accepted from the POD 504, and passes necessary data to the audio decoder 506, the video decoder 508, and the CPU 514. Here, the signal sent from the POD 504 is an MPEG2 transport stream. A detailed description of an MPEG-2 transport stream is given in the MPEG specification ISO/IEC 13818-1, and therefore detailed descriptions shall be omitted in the present embodiment. An MPEG2 transport stream is composed of plural fixed-length packets, and a packet ID is assigned to each packet.

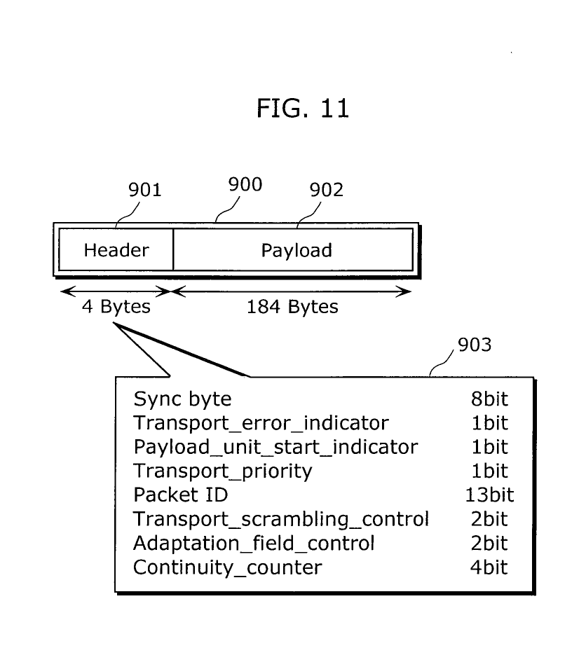

FIG. 11 is a diagram showing the structure of a packet. 900 is a packet configured of 188 bytes having fixed length. The top four bytes are a header 901 storing information for identifying the packet, and the remaining 184 bytes are a payload 902 which contains the information to be transmitted. The header 901 is configured like a configuration 903. A packet ID is included in the 13 bits of the twelfth to twenty-fourth bits from the top.

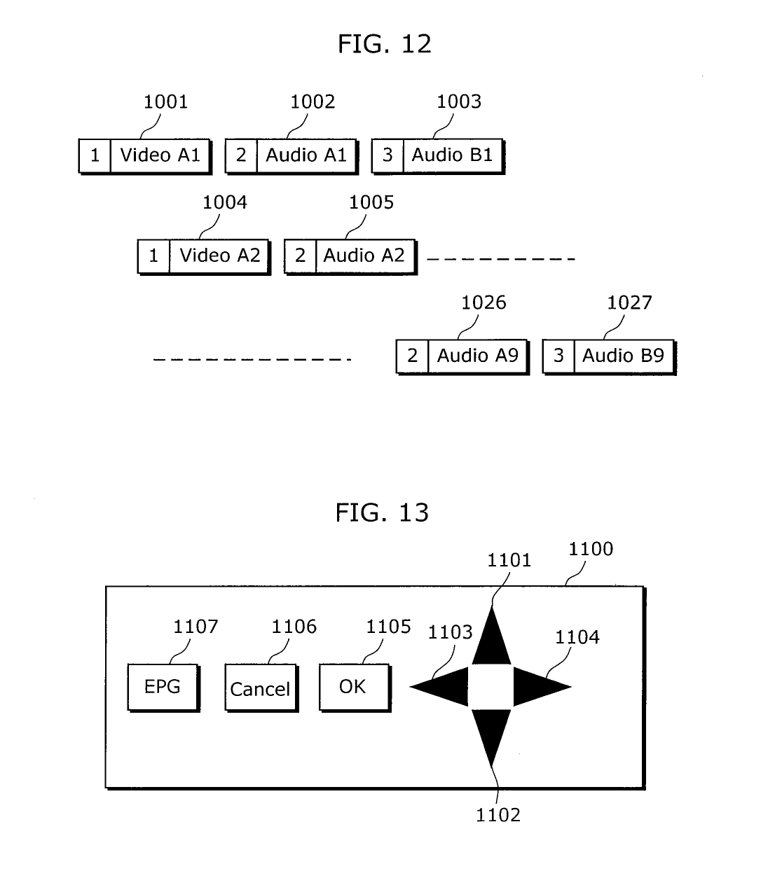

FIG. 12 is a schematic diagram illustrating plural packet strings to be transmitted. A packet 1001 carries a packet ID “1” in its header and includes the first information of video A in its payload. A packet 1002 carries a packet ID “2” in its header and includes the first information of audio A in its payload. A packet 1003 carries a packet ID “3” in its header and includes the first information of audio B in its payload.

A packet 1004 carries the packet ID “1” in its header and includes the second information of the video A in its payload, and is the continuation of the packet 1001. Similarly, packets 1005, 1026, and 1027 carry follow-on data of the other packets. By concatenating the contents of the payloads of packets with the same packet IDs in the above manner, it is possible to reproduce a continuing video and audio.

As shown in FIG. 12, when the CPU 514 indicates, to the TS decoder 505, the packet ID “1” as well as “the video decoder 508” as an output destination, the TS decoder 505 extracts packets with the packet ID “1” from the MPEG2 transport stream received from the POD 504, and passes them to the video decoder 508. Therefore, in FIG. 12, only the video data is passed over to the video decoder 508. At the same time, when the CPU 514 indicates, to the TS decoder 505, the packet ID “2” as well as “the audio decoder 506”, the TS decoder 505 extracts packets with the packet ID “2” from the MPEG2 transport stream received from the POD 504, and passes them to the audio decoder 506. In FIG. 12, only the audio data is passed over to the audio decoder 506.

This process of extracting only necessary packets according to the packet IDs corresponds to the filtering performed by the TS decoder 505. The TS decoder 505 is capable of performing more than one filtering processing simultaneously, at the instruction of the CPU 514.

As shown in FIG. 7, the audio decoder 506 concatenates audio data embedded in the packets in the MPEG2 transport stream provided by the TS decoder 505, performs digital-to-analog conversion on the concatenated data, and outputs the resultant to the speaker 507.

The speaker 507 performs the audio output of the signal provided by the audio decoder 506.

The video decoder 508 concatenates video data embedded in the packets in the MPEG2 transport stream provided by the TS decoder 505, performs digital-to-analog conversion on the concatenated data, and outputs the resultant to the display 509.

The display 509, specifically configured of a CRT or a liquid crystal and the like, outputs a video signal provided by the video decoder 508 and displays a message specified by the CPU 514, and so forth.

The secondary storage unit 510, specifically made up of a flash memory, a hard disk, or the like, stores and deletes data and programs specified by the CPU 514. Stored data and programs are referred to by the CPU 514. The stored data and programs are kept in storage even when power to the terminal apparatus 500 is cut off.

The primary storage unit 511, specifically made up of a RAM and the like, temporarily stores and deletes data and programs specified by the CPU 514. Stored data and programs are referred to by the CPU 514. The stored data and programs are deleted when power to the terminal apparatus 500 is cut off.

The ROM 512 is a read-only memory device, specifically made up of a ROM, a CD-ROM, or a DVD, and the like. The ROM 512 stores a program to be executed by the CPU 514.

The input unit 513, specifically made up of a front panel or remote control, accepts an input from the user.

FIG. 13 is a diagram showing an example of the input unit 513 in the case where it is configured as a front panel. A front panel 1100 corresponds to the front panel unit 603 shown in FIG. 8. The front panel 1100 is made up of seven buttons: an up-cursor button 1101, a down-cursor button 1102, a left-cursor button 1103, a right-cursor button 1104, an OK button 1105, a cancel button 1106, and an EPG button 1107. When the user presses a button, the identifier of the pressed button is notified to the CPU 514.

The CPU 514 executes the program stored in the ROM 512. Following the instructions from the program to be executed, the CPU 514 controls the QAM demodulation unit 501, the QPSK demodulation unit 502, the QPSK modulation unit 503, the POD 504, the TS decoder 505, the display 509, the secondary storage unit 510, the primary storage unit 511, and the ROM 512.

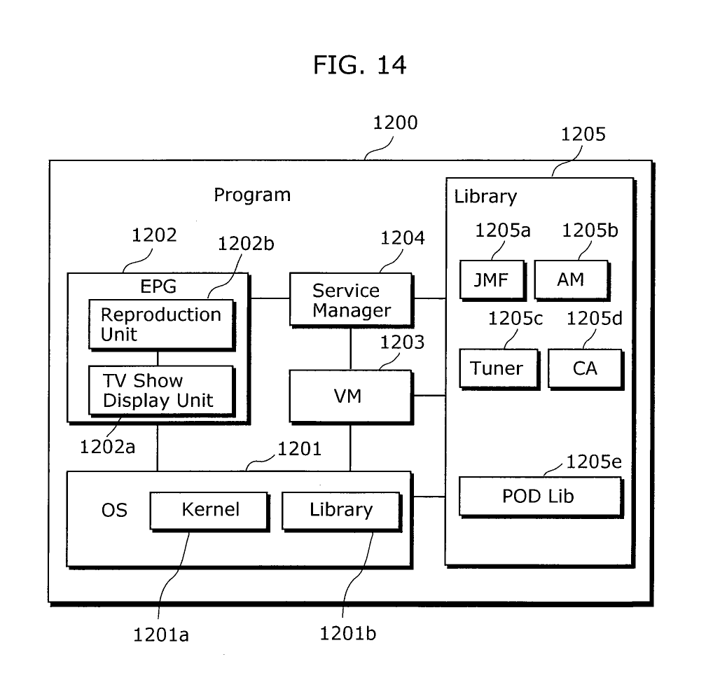

FIG. 14 is a structural diagram showing an example of the program that is stored in the ROM 512 and executed by the CPU 514.

A program 1200 is made up of plural subprograms. To be more specific, the program 1200 is made up of an OS 1201, an EPG 1202, a Java (R) VM 1203 (hereafter, VM 1203), a service manager 1204, and a Java library 1205 (hereafter, library 1205).

The OS 1201 is a subprogram activated by the CPU 514 when power to the terminal apparatus 500 is turned on. The OS 1201 stands for operating system, an example of which is Linux (R) and the like. The OS 1201 is a generic name for publicly known technology made up of a kernel 1201a for executing a subprogram in parallel with another subprogram and a library 1201b, and therefore a detailed description is omitted. In the present embodiment, the kernel 1201a of the OS 1201 executes the EPG 1202 and the VM 1203 as subprograms. Meanwhile, the library 1201b provides these subprograms with plural functions required for controlling the constituent elements of the terminal apparatus 500.

A tuning function can be introduced as one example of these functions. In the tuning function, tuning information including a frequency is received from another subprogram and then passed over to the QAM demodulation unit 501. Accordingly, it is possible for the QAM demodulation unit 501 to perform demodulation based on the provided tuning information, and pass the demodulated data to the POD 504. As a result, the other subprograms can control the QAM demodulation unit via the library 1201b.

The EPG 1202 is made up of a TV show display unit 1202a for displaying a list of TV shows to the user and for accepting an input from the user, and a reproduction unit 1202b for selecting channels. Here, EPG stands for Electric Program Guide. The EPG 1202 is activated by the kernel 1201a when power to the terminal apparatus 500 is turned on. In the activated EPG 1202, the TV show display unit 1202a waits for an input from the user via the input unit 513 of the terminal apparatus 500. Here, in the case where the input unit 513 takes the form of the front panel illustrated in FIG. 13, when the user presses the EPG button 1107 on the input unit 513, the CPU 514 is notified of the identifier of the EPG button. The TV show display unit 1202a of the EPG 1202, which is a subprogram running on the CPU 514, accepts this identifier and shows TV show information on the display 509.

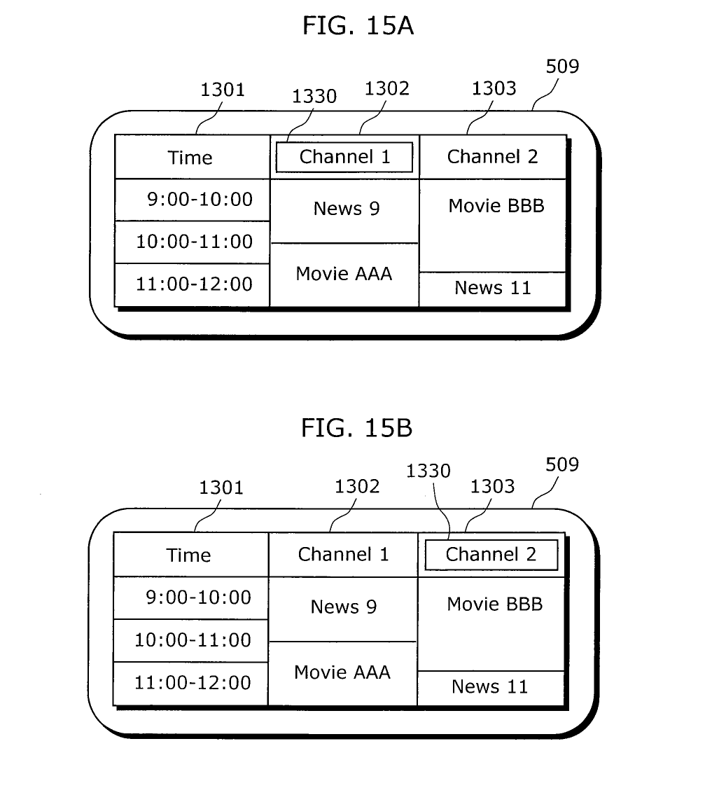

FIGS. 15A and 15B are diagrams showing examples of a TV show chart displayed by the display 509. As shown in FIG. 15A, the TV show information is displayed on the display 509 in a grid pattern. A column 1301 displays time information. A column 1302 displays a channel name “Channel 1” and TV shows to be broadcast during time periods corresponding to the respective times displayed in the column 1301. “Channel 1” shows that a TV show “News 9” is shown from 9:00 to 10:30, and “Movie AAA” is shown from 10:30 to 12:00. A column 1303 displays a channel name “Channel 2” and TV shows to be broadcast during time periods corresponding to the respective times displayed in the column 1301, as in the case of the column 1302. A TV show “Movie BBB” is shown from 9:00 to 11:00, and “News 11” is shown from 11:00 to 12:00. The cursor 1330 moves at the press of the left-cursor button 1103 or the right-cursor button 1104 on the front panel 1100. When the right-cursor button 1104 is pressed down in the state illustrated in FIG. 15A, the cursor button 1330 moves to the right, as shown in FIG. 15B. Meanwhile, when the left-cursor 1103 is pressed down in the state illustrated in FIG. 15B, the cursor 1330 moves to the left, as shown in FIG. 15A.

When the OK button 1105 on the front panel 1100 is pressed down in the state shown in FIG. 15A, the TV show display unit 1202a notifies the reproduction unit 1202b of the identifier of “Channel 1”. Meanwhile, when the OK button 1105 on the front panel 1100 is pressed down in the state shown in FIG. 15B, the TV show display unit 1202a notifies the reproduction unit 1202b of the identifier of “Channel 2”.

Furthermore, the TV show display unit 1202a periodically stores TV show information to be displayed from the head end 101 into the primary storage unit 511 via the POD 504. Generally, it takes time to obtain TV show information from the head end. However, it becomes possible to quickly display a TV show table by displaying the TV show information that is pre-stored in the primary storage unit 511 at the press of the EPG button 1107 of the input unit 513.

The reproduction unit 1202b reproduces the channel using the received identifier of the channel. The relationship between channel identifiers and channels is pre-stored by the secondary storage unit 510 as channel information.

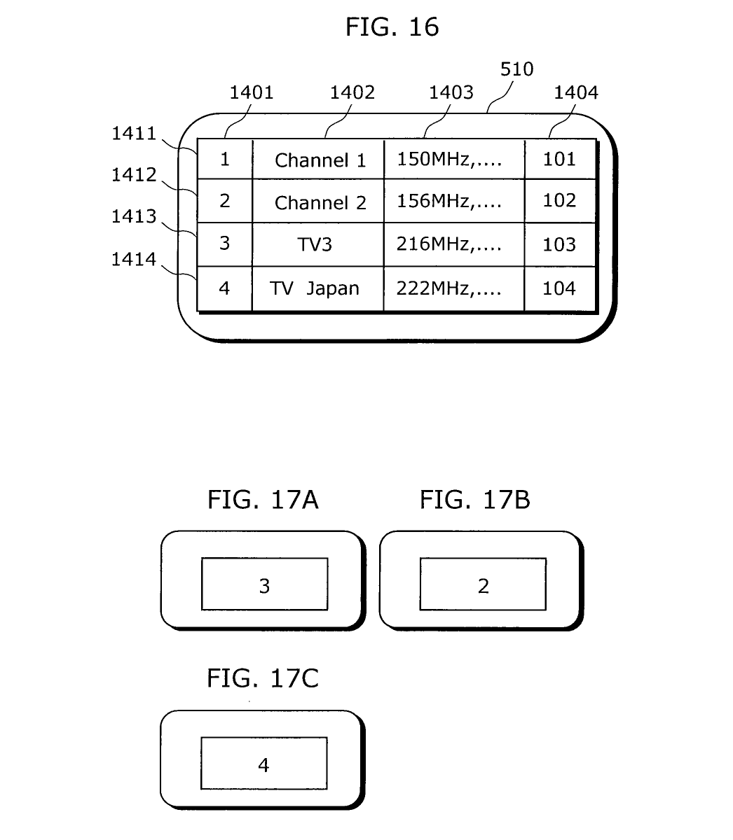

FIG. 16 is a diagram showing an example of the channel information stored in the secondary storage unit 510. The channel information is stored in tabular format. A column 1401 describes the identifiers of channels. A column 1402 describes channel names. A column 1403 describes tuning information. Here, the tuning information is represented by values to be provided to the QAM demodulation unit 501 such as frequency, transmission rate, and coding ratio. A column 1404 describes program numbers. Program numbers are numbers used to identify PMTs defined by the MPEG-2 standard. A description of PMTs is given later. Each of lines 1411 to 1414 indicates a set of the identifier, channel name, and tuning information of each channel. The line 1411 is a set that includes “1” as the identifier, “Channel 1” as the channel name, a frequency of “312 MHz” as the tuning information, and “101” as the program number. The reproduction unit 1202b passes the identifier of the received channel directly to the service manager in order to reproduce the channel. Moreover, when the user presses down the up-cursor button 1101 and the down-cursor button 1102 on the front panel 1100 while the reproduction is taking place, the reproduction unit 1202b receives a notification about such press by the user from the input unit 513 via the CPU 514, and switches the channel being reproduced to another one. First, the reproduction unit 1202b stores, in the primary storage unit 511, the identifier of the channel that is currently reproduced.

FIGS. 17A, 17B, and 17C show examples of channel identifiers stored in the primary storage unit 511. FIG. 17A shows that an identifier “3” is stored, and it is shown in FIG. 16 that a channel with the channel name “TV 3” is being reproduced. When the user presses the up-cursor button 1101 in a state illustrated in FIG. 17A, the reproduction unit 1202b refers to the channel information shown in FIG. 16, and passes the identifier “2” of a channel with the channel name of “Channel 2” to the service manager in order to newly reproduce a channel with the channel name of “Channel 2”, which is the previous channel in the table. At the same time, the reproduction unit 1202b rewrites the channel identifier stored in the primary storage unit 511 as “2”. FIG. 17B shows the state in which the channel identifier has been re-written. Meanwhile, when the user presses the down-cursor button 1102 in the state illustrated in FIG. 17A, the reproduction unit 1202b refers to the channel information shown in FIG. 14, and passes the identifier “4” of a channel with the channel name of “TV Japan” to the service manager in order to newly reproduce a channel with the channel name of “TV Japan”, which is the next channel in the table. At the same time, the reproduction unit 1202b rewrites the channel identifier stored in the primary storage unit 511 as “4”. FIG. 17B shows the state in which the channel identifier has been re-written.

The VM 1203 is a Java virtual machine that sequentially analyzes and executes programs written in the Java (R) language. Programs written in the Java language are compiled of intermediate code which does not depend on the hardware, called bytecode. The Java Virtual Machine is an interpreter which executes this bytecode. Some of the Java virtual machines translate the byte codes into an executable form which can be interpreted by the CPU 514 and pass the resultant to the CPU 514, which executes it. The VM 1203 is started with a Java program to be executed being specified by the kernel 1201a. In the present embodiment, the kernel 1201a specifies the service manager 1204 as a Java program to be executed. Details of the Java language are explained in many publications, such as “Java (R) Language Specification” (ISBN 0-201-63451-1). Here, those details are omitted. In addition, detailed operations of the Java Virtual Machine itself are explained in many publications, such as “Java (R) Virtual Machine Specification” (ISBN 0-201-63451-X). Here, those details are omitted.

The service manager 1204, which is a Java program written in the Java language, is sequentially executed by the VM 1203. It is possible for the service manager 1204 to call or be called by another subprogram not written in the Java language through the JNI (Java (R) Native Interface). JNI is described in many publications, such as “Java (R) Native Interface.” Here, those details are omitted.

The service manager 1204 accepts the identifier of the channel from the reproduction unit 1202b through the JNI.

First, the service manager 1204 passes the identifier of the channel to a Tuner 1205c in the library 1205 so as to request for tuning. The Tuner 1205c refers to the channel information stored in the secondary storage unit 510 to obtain the tuning information. Assuming that the service manager 1204 passes the identifier “2” of the channel to the Tuner 1205c, the Tuner 1205c refers to the line 1412 shown in FIG. 16, and obtains the tuning information “156 MHz,” corresponding to the channel. The Tuner 1205c passes the tuning information to the QAM demodulation unit 501 via the library 1201b of the OS 1201. The QAM demodulation unit 501 demodulates the signal sent from the head end 101 according to the tuning information given to the QAM demodulation unit 501, and passes the resultant signal to the POD 504.

Next, the service manager 1204 requests a CA 1205d inside the library 1205 to perform descrambling. The CA 1205d provides the POD 504 with information required for descrambling through the library 1201b in the OS 1201. On the basis of the provided information, the POD 504 descrambles the signal provided by the QAM demodulation unit 501, and passes the resultant signal to the TS decoder 505.

Next, the service manager 1204 provides a JMF 1205a inside the library 1205 with the identifier of the channel, so as to request for the reproduction of the video and audio.

First, the JMF 1205a obtains, from a PAT and a PMT, packet IDs used to specify the video and audio to be reproduced. PAT and PMT are tables defined by the MPEG-2 standard that show the program line-up included in an MPEG-2 transport stream. PAT and PMT are carried in the payloads in packets included in an MPEG-2 transport stream, together with audio and video. Refer to the specification for a detailed description of PAT and PMT. Here, only an overview of PAT and PMT is given. PAT, which is an abbreviation of Program Association Table, is carried in packets with the packet ID “0”. In order to obtain the PAT, the JMF 1205a indicates, to the TS decoder 505, the packet ID “0” and the CPU 514 through the library 1201b of the OS 1201. Then, the TS decoder 505 performs filtering based on the packet ID “0”, and passes the resultant to the CPU 514. Accordingly, the JMF 1205a can collect the PAT packets.

FIG. 18 illustrates a table that schematically shows an example of the collected PAT information. A column 1601 describes program numbers. A column 1602 describes packet IDs. The packet IDs shown in the column 1602 are used to obtain the PAT. Each of lines 1611 to 1613 is a pair of the program number of a channel and a packet ID corresponding to it. Here, three channels are defined. The line 1611 defines a pair of the program number “101” and the packet ID “501”. Assuming that the channel identifier provided to the JMF 1205a is “2”, the JMF 1205a refers to the line 1412 in FIG. 16, so as to obtain the program number “102” corresponding to the channel identifier, and then refers to the line 1612 in the PAT shown in FIG. 18, so as to obtain the packet ID “502” corresponding to the program number “102”. PMT, which is an abbreviation of Program Map Table, is carried in packets with the packet IDs specified in the PAT. In order to obtain the PMT, the JMF 1205a indicates, to the TS decoder 505, a packet ID and the CPU 514 through the library 1201b of the OS 1201. Here, a packet ID to be specified is “502”. Then, the TS decoder 505 performs filtering based on the packet ID “502”, and passes the resultant to the CPU 514. Accordingly, the JMF 1205a can collect the PMT packets.

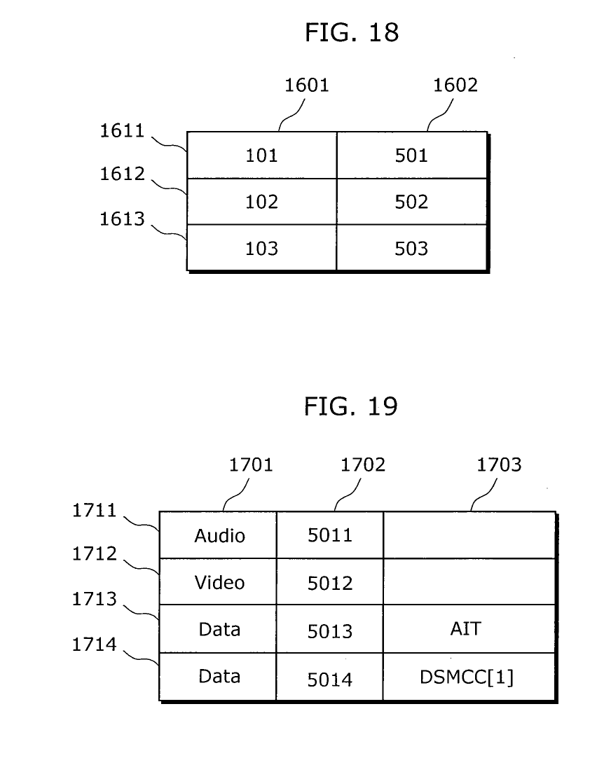

FIG. 19 is a diagram that schematically shows an example of the collected PMT information. A column 1701 describes a stream type, and a column 1702 describes the packet ID. Information specified in the respective stream types is carried in the payloads of packets with the packet IDs specified in the column 1702. A column 1703 describes additional information. Each of lines 1711 to 1714 is a pair of a packet ID and the type of information being transmitted, which is known as an elementary stream. The line 1711, which is a pair of the stream type “audio” and the packet ID “5011”, indicates that audio data is stored in the payload of the packet with the packet ID “5011”. The JMF 1205a obtains, from the PMT, the packet IDs of the video and audio to be reproduced. As shown in FIG. 19, the JMF 1205a obtains the audio packet ID “5011” from the line 1711, and the video packet ID “5012” from the line 1712.

Then, the JMF 1205a provides the TS decoder 505 with pairs of the obtained audio packet ID and the audio decoder 506 as an output destination as well as the video packet ID and the video decoder 508 as an output destination, via the library 1201b of the OS 1201. The TS decoder 505 performs filtering based on such provided packet IDs and the output destinations. Here, the packet with the packet ID “5011” is passed to the audio decoder 506 and the packet with the packet ID “5012” is passed to the video decoder 508. The audio decoder 506 performs digital-to-analog conversion on the provided packet, so as to reproduce the audio via the speaker 507. The video decoder 508 performs digital-to-analog conversion on the provided packet, so as to display the video on the display 509.

Finally, the service manager 1204 provides the channel identifier to an AM 1205b in the library 1205, so as to request for data broadcast reproduction. Here, data broadcast reproduction means to extract a Java program included in the MPEG2 transport stream and cause the VM 1203 to execute it. A format called DSMCC, which is noted in the MPEG specifications ISO/IEC 13818-6, is used as the method to embed the Java program in the MPEG-2 transport stream. Here, detailed descriptions of DSMCC are omitted. DSMCC specification defines a method of encoding a file system comprised of directories and files used by a computer, in packets within an MPEG2 transport stream. Information about the Java program to be executed is carried in packets in the MPEG2 transport stream in the form of AIT. AIT is an abbreviation of Application Information Table, as defined by the OCAP specification (officially, OCAP 1.0 Profile OC-SP-OCAP 1.0-IF-I09-031121).

First, in order to obtain the AIT, the AM 1205b obtains the PAT and PMT as in the case of the JMF 1205a, so as to obtain the packet ID of the packet that stores the AIT. Assuming that “2” is the provided channel identifier and that the PAT shown in FIG. 18 and the PMT shown in FIG. 19 are being transmitted, the AM 1205b obtains the PMT shown in FIG. 19 according to the same procedure followed by the JMF 1205a. Subsequently, the AM 1205b extracts, from the PMT, the packet ID of the elementary stream whose stream type is “Data” and which has “AIT” as additional information. As shown in FIG. 19, the elementary stream in the line 1713 corresponds to this elementary stream, and therefore the AM 1205b obtains the packet ID “5013” from it.

The AM 1205b provides the TS decoder 505 with the packet ID of the AIT and the CPU 514 as an output destination through the library 1201b of the OS 1201. Then, the TS decoder 505 performs filtering based on the provided packet ID, and passes the resultant to the CPU 514. Accordingly, the AM 1205b can collect the packets of AIT.

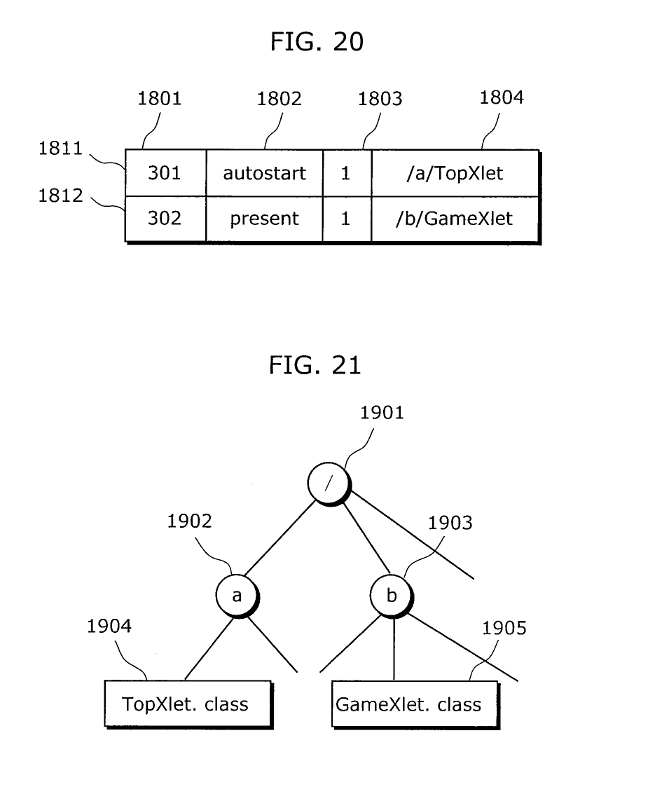

FIG. 20 is a diagram that schematically shows an example of information of the collected AIT. A column 1801 describes identifiers of Java programs. A column 1802 describes control information for controlling the Java programs. The control information includes “autostart”, “present”, and “kill”. “autostart” means that the terminal apparatus 500 automatically executes the program promptly. “present” means that the program is not executed automatically. “kill” means that the program is to be terminated. A column 1803 describes DSMCC identifiers used to extract packet IDs that include Java programs in the DSMCC format. A column 1804 describes program names of the Java programs. Each of lines 1811 and 1812 is a set of information about a Java program. The information of the Java program defined in the line 1811 is a set of an identifier “301”, control information “autostart”, a DSMCC identifier “1”, and a program name “a/TopXlet”. The information of the Java program defined in the line 1812 is a set of an identifier “302”, control information “present”, a DSMCC identifier “1”, and a program name “b/GameXlet”. Here, these two Java programs have the same DSMCC identifier. This indicates that two Java programs are included in the file system which has been encoded according to the same DSMCC method. Here, four types of information are prescribed for the Java program, but in reality, more types of information are defined. Details can be found in the OCAP specification (OCAP 1.0 Profile OC-SP-OCAP1.0-IF-I09-031121).

The AM 1205b finds the “autostart” Java program from the AIT, and extracts the corresponding DSMCC identifier and Java program name. As shown in FIG. 20, the AM 1205b extracts the Java program in the line 1811, and obtains the DSMCC identifier “1” and the Java (R) program name “a/TopXlet”.

Next, the AM 1205b obtains, from the PMT, the packet ID of packets that store Java programs in the DSMCC format, using the DSMCC identifier obtained from the AIT. More specifically, the AM 1205b obtains, from the PMT, the packet ID included in the elementary stream whose stream type is “Data” and whose DSMCC identifier in the additional information matches.

Here, assuming that such DSMCC identifier is “1” and the PMT is the one shown in FIG. 19, the elementary stream in the line 1714 satisfies the above condition. Therefore, the packet ID “5014” is to be extracted.

The AM 1205b indicates, to the TS decoder 505, the packet ID of packets in which data is embedded in the DSMCC format as well as the CPU 514 as an output destination through the library 1201b of the OS 1201. Here, the packet ID “5014” is provided. Then, the TS decoder 505 performs filtering based on such provided packet ID, and passes the resultant to the CPU 514. Accordingly, the AM 1205b can collect the required packets. The AM 1205b reconstructs the file system from the collected packets according to the DSMCC method, and stores the reconstructed file system in the primary storage unit 511. The process for extracting data such as the file system from packets in the MPEG2 transport stream and storing the extracted data into storage units such as the primary storage unit 511 is hereafter called downloading.

FIG. 21 is a diagram showing one example of a downloaded file system. In the diagram, circles represent directories and squares represent files; the filesystem includes a root directory 1901, a directory “a” 1902, a directory “b” 1903, a file “TopXlet.class” 1904, and a file “GameXlet.class” 1905.

Subsequently, the AM 1205b passes, to the VM 1203, a Java program to be executed out of the file system downloaded into the primary storage unit 511. At this time, when the name of the Java program to be executed is “a/TopXlet,” the file to be executed is the file “a/TopXlet.class,” which is the Java program name with “.class” added. “/” is a delimiter between a directory and a file name, and as shown in FIG. 21, the file 1904 is a Java program to be executed. Next, the AM 1205b passes the file 1904 to the VM 1203.

The VM 1203 executes the received Java program. Upon the receipt of the identifier of another channel, the service manager 1204 terminates the reproduction of the video and audio as well as the execution of the Java program which are being carried out through each library included in the library 1205, through each library included in the same library 1205, and then performs the reproduction of the video and audio as well as the execution of a Java program based on the newly received channel identifier.

The library 1205 is a collection of plural Java libraries stored in the ROM 512. In the present embodiment, the library 1205 includes a JMF 1205a, and AM 1205b, a Tuner 1205c, a CA 1205d, and a PODLib 1205e.

Next, functions of downloading, storing, and executing the Java program shall be described.

The service manager 1204 can accept information from the head end 101 by communicating with the head end 101 via the PODLib 1205e, which is included in the library 1205. This communication can be realized by the POD Lib 1205e using the QPSK demodulation unit 502 via the library 1201b of the OS 1201 and the POD 504.

Through this communication, the service manager 1204 accepts information of the Java program which the terminal apparatus 500 is to store in the secondary storage unit 510 from the head end 101. Such information is referred to as XAIT information. The XAIT information is transmitted between the head end 101 and the POD 504 in an arbitrary form. The present invention can be implemented regardless of transmission format, as long as information required for the XAIT information is included.

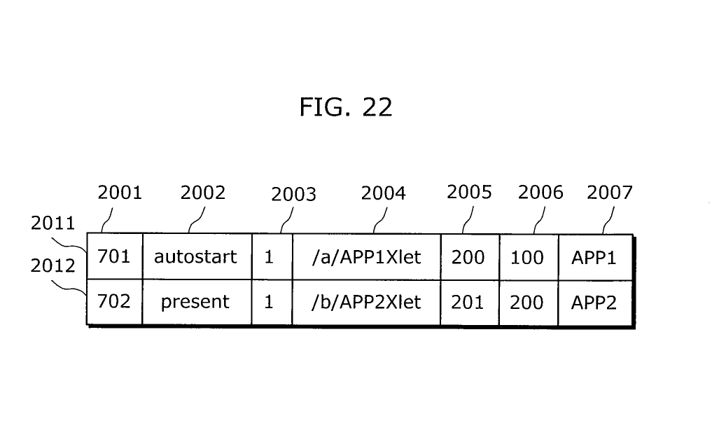

FIG. 22 is a diagram that schematically shows an example of the XAIT information obtained from the head end 101. A column 2001 describes the identifiers of Java programs. A column 2002 describes control information for controlling the Java programs. The control information includes “autostart” and “present”. “autostart” means that the program is executed automatically when the terminal apparatus 500 is powered on, and “present” means that the program is not to be executed automatically. A column 2003 describes DSMCC identifiers used to extract packet IDs that include Java programs in the DSMCC format. A column 2004 describes the program names of the Java programs. A column 2005 describes a priority of the Java programs. The priority is for deciding which Java program to execute when the executable Java programs are limited. A column 2006 describes a storage priority of the Java program. The storage priority is a value specified in individual Java programs and written in the XAIT information, and is for deciding what data is necessary for the Java program and for execution of the Java program when saving the data necessary for the Java program and for execution of the Java program in the secondary storage unit 510. The column 2007 describes an application name of the Java program. The application name is a name a user uses to identify the Java program. Each of rows 2011 and 2012 is a set of information about the respective Java programs. The Java program defined in the row 2011 is a set of an identifier “701”, control information “autostart”, a DSMCC identifier “1”, a program name “a/APP1Xlet”, a priority “200”, a storage priority “100”, and an application name “APP1”. Here, although only 7 items of information are specified for the Java program, the present invention can be implemented even when more items of information are defined.

Note that the application name in column 2007 is, for example, a name used for identifying each Java program described in the XAIT information to the user; however, if enough information for the user to be able to identify the Java program is presented to the user, the present invention can be implemented even without the application name.

Next, the service manager 1204 transfers the XAIT information to the AM 1205b in the library 1205 and requests extraction, downloading, and execution of the Java program described in the XAIT information from the MPEG-2 transport stream.

Upon the receipt of the XAIT information, the AM 1205b stores the file system from the MPEG2 transport stream in the primary storage unit 511, according to the same procedure as that for downloading the Java program from the AIT information. After that, the file system stored in the primary storage unit 511 is copied to the secondary storage unit 510. Note that it is also possible to download the filesystem directly to the secondary storage unit 510, without going through the primary storage unit 511.

Next, the AM 1205b associates a storage position of the downloaded filesystem with the XAIT information and stores it in the secondary storage unit 510.

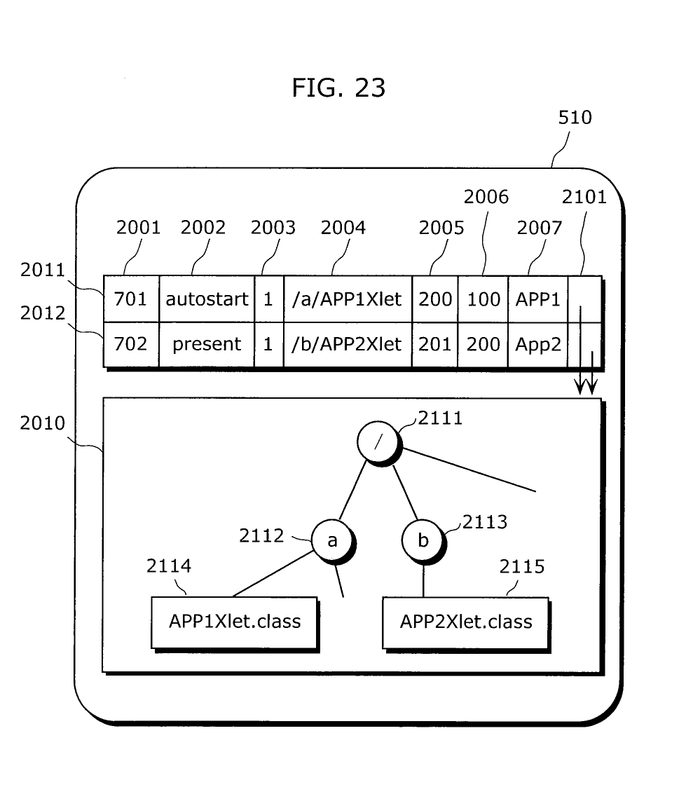

FIG. 23 is a diagram showing an example of the XAIT information and the downloaded file system stored in the secondary storage unit 510, in association with each other. Elements in FIG. 23 with the same numbers as those in FIG. 22 are identical, and therefore descriptions are omitted. Column 2101 stores the storage position of the downloaded file system corresponding to each Java program. In the diagram, such storage positions are indicated by arrows. A downloaded file system 2210 holds, internally, a top directory 2111, a directory “a” 2112, a directory “b” 2113, a file “APP1Xlet.class” 2114, and a file “APP2Xlet.class” 2115.

Here, the XAIT information is stored after the Java program is stored, but the XAIT information may instead be stored before the Java program is stored. Note that the XAIT information is stored in the secondary storage 510, but the XAIT information may also be stored in the primary storage unit 511. In the case where the XAIT information is stored in the primary storage unit 511, all saved XAIT information disappears when the power is turned off.

Here, to be more specific, the file system is formed from data necessary for plural Java programs described in the XAIT information and for the execution of such Java programs. Hereafter, the data necessary for the individual Java programs described in the XAIT information and for the execution of such Java programs is called an application. Furthermore, downloading the application to the secondary storage unit 510 is hereafter called storing. In addition, an area in the secondary storage unit 510 for storing the application is called a storage area. Also, the VM 1203 executing the Java program made up of an application is called execution of the application.

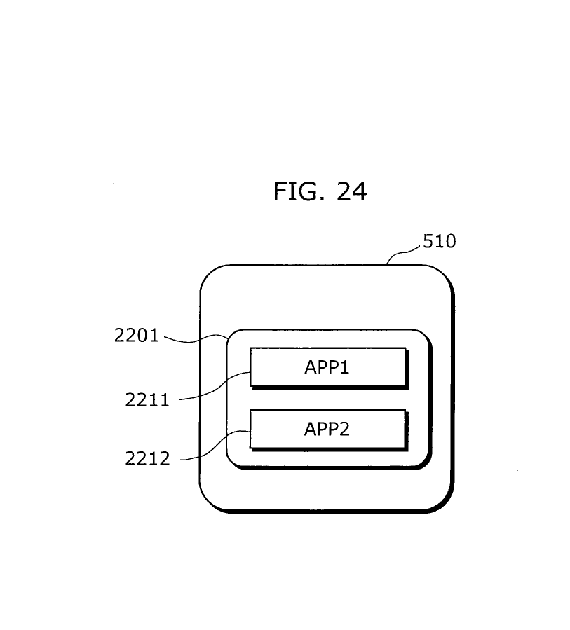

FIG. 24 is a diagram showing an example of a state in which an application described in the XAIT information is stored in an application storage area 2201. In FIG. 24, the application storage area 2201 stores an application 2211 having an application name “APP1” and an application 2212 having an application name “APP2”.

Here, the capacity of the application storage area 2201 is generally limited. The capacity of the application storage area 2201 may be pre-set, or may be variable. Note that although the application is assumed to be stored in the storage area 2201 of the secondary storage unit, the application may be stored in the primary storage unit. In addition, in the case where the application is saved in the primary storage unit, all saved applications disappear when the power is turned off.

Next, the AM 1205b refers to the XAIT information stored in the primary storage unit 511 or the secondary storage unit 510, and passes the application downloaded to the primary storage unit 511, or the Java program with an application specified as “autostart” from among the applications stored in the storage area 2201 of the secondary storage unit 510, to the VM 1203. As shown in FIG. 23, the Java program “a/APP1Xlet” of the application “APP1” as defined in row 2011 is passed to the VM 1203. Assuming the name of the Java program name of the application to be executed is “a/APP1Xlet,” the file to be executed is the file “a/APP1Xlet.class,” which is the Java program name with “.class” added. The VM 1203 executes the received Java program. Hereafter, passing of the application from the AM 1205b to the VM 1203 is called an application start-up instruction to the VM 1203.

In processing from the point in time at which the AM 1205b receives the XAIT information to the point in time at which the AM 1205b provides the application startup instruction to the VM 1203, the processing that generally takes the most time is processing in which the file system is taken from the MPEG-2 transport stream and stored in the primary storage unit, or processing in which the file system is taken from the MPEG-2 transport stream and stored directly in the storage area 2201 of the secondary storage unit 510 without going through the primary storage unit 511. Here, in the case where one of the applications described in the XAIT information has already been stored at the point in time at which the AM 1205b has received the XAIT information, it is possible for the AM 1205b to omit, for the file system of the already-stored application, the processing of storing the file system from the MPEG-2 transport stream into the primary storage unit 511 and the processing of storing the file system from the primary storage unit 511 into the storage area 2201 of the secondary storage unit 510, or the processing of storing the file system from the MPEG-2 transport stream directly into the storage area 2201 of the secondary storage unit 510 without going through the primary storage unit 511. Thus, by storing the application in the storage area 2201 beforehand, it is possible to reduce the time from the point where the AM 1250b receives the XAIT information to the point where the AM 1250b provides the application startup instruction to the VM 1203.

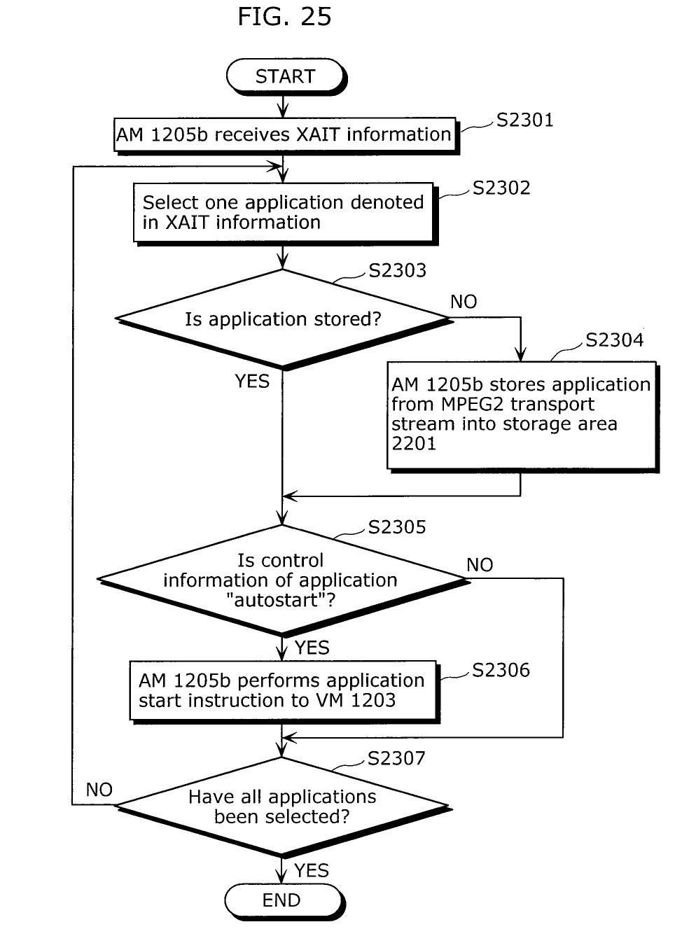

FIG. 25 is a flowchart showing an example of an operation from the point in time at which the AM 1250b accepts XAIT information to when the AM 1250b provides the application startup instruction to the VM 1203. As shown in FIG. 25, when the AM 1205b receives the XAIT information (S2301), the applications described in the XAIT information are selected in order from the applications that have not yet been selected (S2302). Here, the AM 1205b judges whether or not a selected application is stored (S2303), and in the case where a selected application is not stored (NO of S2303), the AM 1205b stores such application from the MPEG-2 transport stream into the storage area 2201 (S2304). Next, the AM 1205b judges whether or not the control information of the selected application is “autostart” (S2305), and in the case where the control information of the selected application is “autostart”, the AM 1205b provides the application startup instruction to the VM 1203 (S2306). Then, the AM 1205b judges whether or not all the applications described in the XAIT information have been selected (S2307), and in the case where all the applications described in the XAIT information have not yet been selected (NO of S2307), the AM 1205b selects the next application, and continues the processing from the receipt of the XAIT information to application startup instruction; in the case where all the applications described in the XAIT information have already been selected (YES of S2307), the processing from the receipt of the XAIT information to the application startup instruction finishes.

As has been made clear by the example of operations of the AM 1205b as shown in FIG. 25, at the point in time at which the AM 1205b receives the XAIT information, the AM 1205b judges whether or not the application described in the XAIT is stored (S2303), and in the case where the application described in the XAIT is already stored, it is possible to omit the processing in which the AM 1205b stores the application from the MPEG-2 transport stream in the storage area 2201 (S2304). As a result, the amount of time from when the AM 1205b receives the XAIT information (S2301) to when the AM 1205b provides the application startup instruction to the VM 1203 (S2306) is reduced.

Furthermore, here, in the processing of selecting one application described in the XAIT information (S3202), by selecting in order applications that, for example, are both stored and have “autostart” denoted, it is possible to particularly reduce the amount of time up until providing the start instruction for individual stored applications.

Note that the method for shortening the amount of time up until providing the start instructions for the individual applications in not limited to the method shown in FIG. 25. Note that in FIG. 25, the processing for storing the application described in the XAIT information from the MPEG-2 transport stream into the storage area 2201 is performed per application, but another method may be used, such as performing the processing simultaneously for all applications described in the XAIT.

In this manner, a merit of storing the application is that, when receiving the next XAIT, there is no need to download the application from the DSMCC or store the application; therefore, the processing from the point in time at which the AM 1205b receives XAIT information to the point in time at which the AM 1205b provides the application startup instruction to the VM 1203 takes less time.

On the other hand, in the case where the application is not stored, it is necessary for the AM 1205b, when receiving the next AIT, to download the file system of that application from the MPEG-2 transport stream to the primary storage unit 511 or to store the file system in the storage area 2201 of the secondary storage unit 510; therefore, compared to when the application is already stored, the processing from the point in time at which the AM 1205b receives XAIT information to the point in time at which the AM 1205b provides the application startup instruction to the VM 1203 takes more time.

Note that here, the AM 1205b is described as providing the application startup instruction to the VM 1203b after the AM 1205b finishes downloading the application from the DSMCC into the primary storage unit, or after storing the application from the DSCMM into the storage area; however, the AM 1205b may provide the application startup instruction to the VM 1203 after receiving the XAIT information but before downloading the application from the DSMCC into the primary storage unit, or before storing the application from the DSCMM into the storage area. Here, the start instruction is realized by the AM 1205b delivering the program name of the application to be executed to the VM 1203. In this case, after being provided with the application startup instruction from the AM 1205b, the VM 1203 reads the application from the DSMCC, the primary storage unit 511, or the storage area, and executes the application. In general, the processing of reading a file system from the DSMCC is slower than the processing of reading a file system already stored in the primary storage unit or the storage area. Thus, by storing the application in the storage area 2201 beforehand, it is possible to reduce the amount of time from when the AM 1205b receives the XAIT information to when the VM 1203 commences execution of the application.

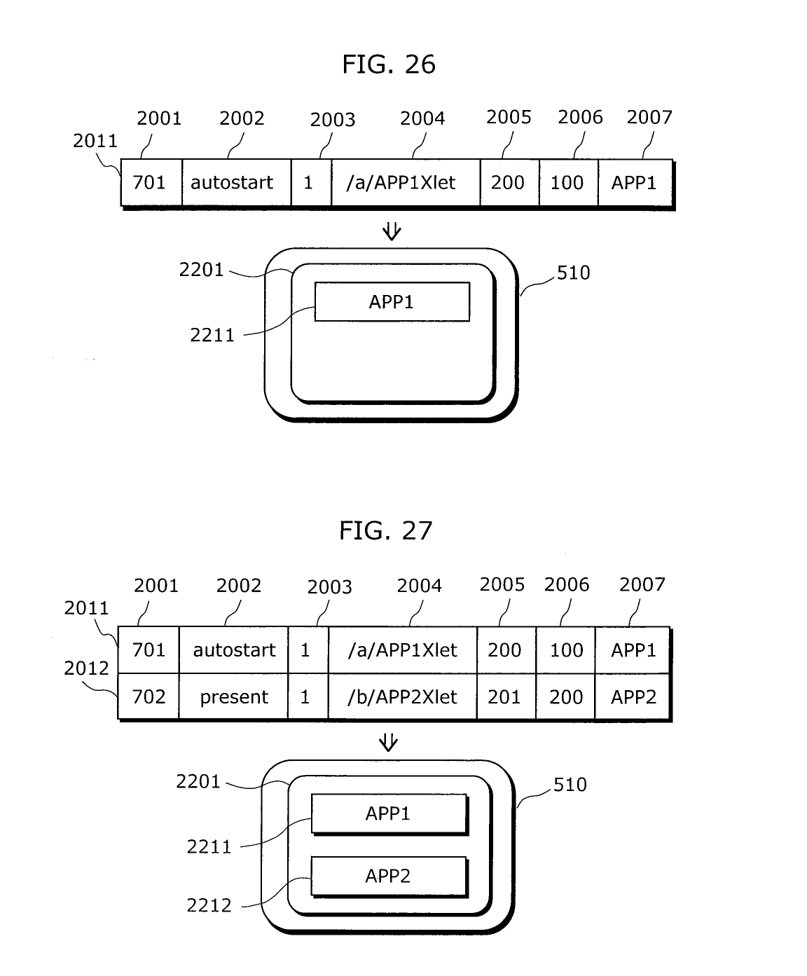

As shown in FIG. 26 and FIG. 27, when the XAIT information is updated, the application stored in the storage area 2201 is updated along with the XAIT information.

FIG. 26 is a diagram showing a state of an application 2011 stored in the storage area 2201 in accordance with pre-update XAIT information, which specifies the storage of the one application 2011. Here, when storage of the one application 2011 is specified in the pre-update XAIT information, the application 2011 is stored as shown in state 2211.

FIG. 27 is a diagram showing an example of a state of applications stored in a storage area in accordance with post-update XAIT information, which specifies the storage of two applications 2011 and 2012. When storage of the two applications 2011 and 2012 is specified in the post-update XAIT information, the application 2011 is stored, as shown in a state 2211, and the application 2012 is also stored, as shown in state 2212.

Next, a storage function for an application described in the XAIT information as performed by the AM 1205b that has received the XAIT information, which is a main function of the present invention, is described.

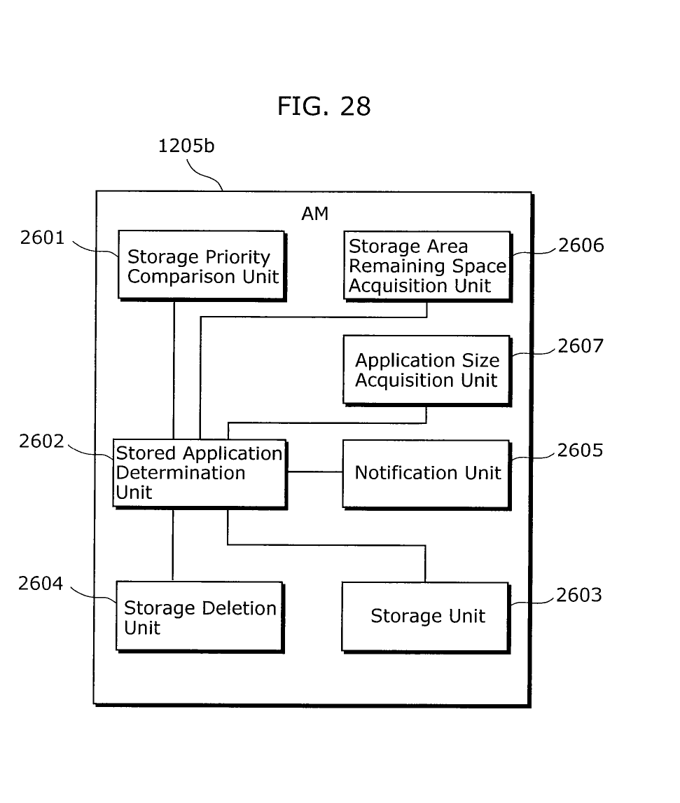

FIG. 28 is a diagram showing only constituent elements of the AM 1205b that are related to storage processing. Other constituent elements that have no direct relation to the present invention are omitted. The AM 1205b includes: a storage priority comparison unit 2601; a stored application determination unit 2602; an application storage unit 2603; an application storage deletion unit 2604; a notification unit 2605; a storage area remaining space acquisition unit 2606; and an application size acquisition unit 2607.

Upon receipt of an acquisition request from the stored application determination unit 2602, the storage priority comparison unit 2601 acquires a storage priority 2006 of an individual application from the XAIT information, and compares the storage priorities 2006 specified in individual applications. Here, in the case where an already-stored application is not denoted in the XAIT information, the storage priority comparison unit 2601 considers the storage priority of the application to be a minimum value. A result of the comparison is returned to the stored application determination unit 2602. Here, a method of returning the comparison result can be performed by rearranging all applications described in the XAIT information into an array ordered from the highest priority down; however, any format is possible as long as it provides information necessary for knowing the degree of the storage priority for all the applications that the stored application determination unit 2602 has described in the XAIT information.

Upon receipt of an acquisition request from the stored application determination unit 2602, the storage area remaining space acquisition unit 2606 acquires the remaining space in the storage area 2201 into which an application can be stored, and returns this acquisition result to the stored application determination unit 2602. Here, a method of returning the acquisition result can be performed by returning the result as numerical value information; however, any format is possible as long as it provides information necessary for the stored application determination unit 2602 to know the remaining space in the storage area 2201 into which an application can be stored.

Upon receipt of an acquisition request from the stored application determination unit 2602, the application size acquisition unit 2607 acquires the capacity necessary for the storage of each application described in the XAIT and each application already stored in the storage area, and returns this acquisition result to the stored application determination unit 2602. Here, a method of returning the acquisition result can be performed by returning the result with a numerical value associated per application; however, any format is possible as long as it provides information necessary for the stored application determination unit 2602 to know the amount of space required for the storage of each application.

The stored application determination unit 2602 determines a set which includes an application to be stored in the storage area 2201 and an application to be deleted from the storage area 2201. Here, the stored application determination unit 2602 requests acquisition of the storage priority comparison result from the storage priority comparison unit 2601, acquisition of the space remaining in the storage area 2201 from the storage area remaining space acquisition unit 2606, and acquisition of the space necessary for storage of each application from the application size acquisition unit 2607. Then, based on these acquired pieces of information, applications with a high storage priority are determined to be preferentially stored, so that as many applications as possible, starting with applications with a high storage priority, can be preferentially stored in the storage area 2201, to an extent in which the size of all the applications stored in the storage area 2201 do not exceed the total size of the storage area 2201. Furthermore, even if the application is an already-stored application, the stored application determination unit 2602 determines to delete the application from the storage area 2201 in order from applications with a low storage priority up. Then, after the stored application determination unit 2602 has determined the set including the application to store in the storage area 2201 and the application to delete from the storage area 2201, it provides a notification instruction to the notification unit 2605, an application storage instruction to the storage unit 2603, and an application deletion instruction to the storage deletion unit 2604. Here, providing the notification instruction to the notification unit 2605 and the application deletion instruction to the application storage deletion unit 2604 is performed after it is determined that the already-stored application is to be deleted from the storage area 2201; however, in this case, by providing the notification instruction to the notification unit 2605 before providing the application deletion instruction to the application storage deletion unit 2604, it is possible to provide the user with the application deletion notification before deleting the application from the storage area.

The storage unit 2603 stores the application, in accordance with a result of the determination carried out by the application determination unit 2602.

The storage deletion unit 2604 deletes the application from the storage area 2201, in accordance with a result of the determination carried out by the stored application determination unit 2602.

The notification unit 2605 notifies the user that the application is deleted, in accordance with the result of the determination carried out by the stored application determination unit 2602. Here, the application deletion notification provided to the user by the notification unit 2605 is realized by the notification unit 2605 sending, to the CPU 514 of the terminal apparatus 500, deletion notification information of a screen to be displayed, and a dialog display program included in the library 1201b of the OS 1201 displaying the deletion notification in the display 509. Here, the dialog is assumed as disappearing from the display 509 after a predetermined amount of time has passed.

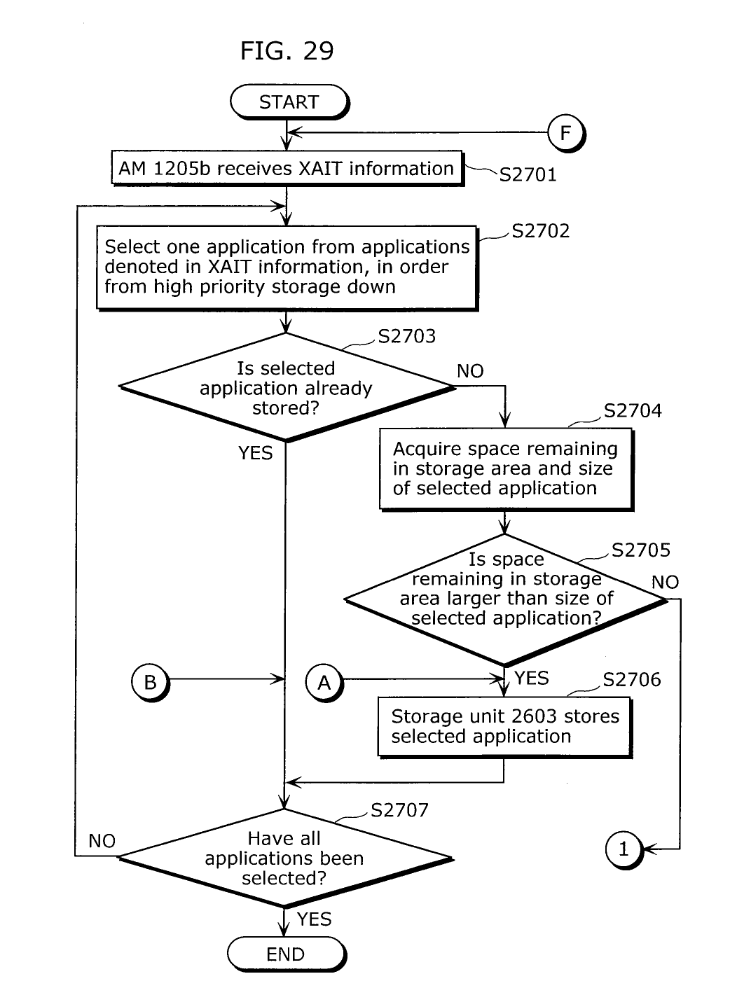

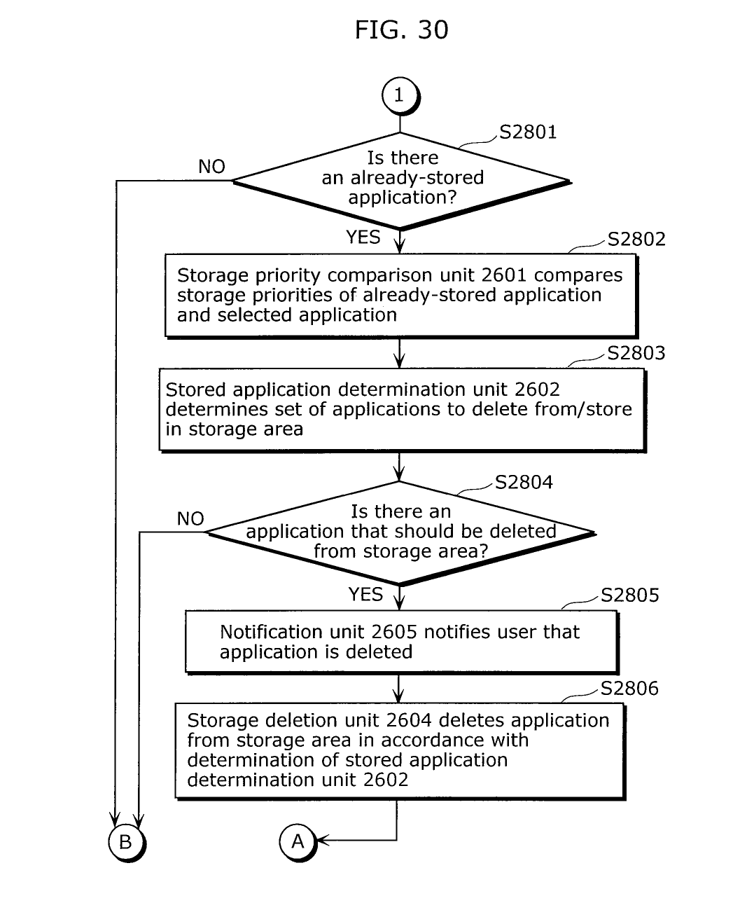

FIGS. 29 and 30 are flowcharts showing examples of application storage processing operations carried out by the AM 1205b that has received the XAIT information in the present embodiment. In particular, these flowcharts show examples of storage processing operations for an application from the MPEG-2 transport stream into the storage area 2201, as carried out by the AM 1205b, in the case where the space in the storage area 2201 is insufficient when storing the application denoted in the XAIT information from the MPEG-2 transport stream into the storage area 2201.

As shown in FIGS. 29 and 30, upon receiving the XAIT information (S2701), the AM 1205b selects, from among the applications described in the XAIT information, one application that has not yet been selected, in order from applications with a high storage priority down. However, here, in storage processing carried out in accordance with the received XAIT information, the storage deletion unit 2604 selects one application aside from the applications already deleted from the storage area 2201 (S2702). Then, the AM 1205b judges whether or not the selected application has been stored (S2703).

In the case where the selected application has been stored (YES of S2703), the AM 1205b judges whether or not all the applications denoted in the XAIT information have been selected (S2707). Here, in the case where all the applications denoted in the XAIT information have not been selected (NO of S2707), the AM 1205b selects the next application, and the storage processing continues. Here, in the case where all the applications denoted in the XAIT information have been selected (YES of S2707), the AM 1205b finishes the storage processing.

On the other hand, in the case where the selected application has not been stored (NO of S2703), the stored application determination unit 2602 acquires the space remaining in the storage area from the storage area remaining space acquisition unit 2606, and acquires the application size from the application size acquisition unit 2607 (S2704). Then, based on the space remaining in the storage area acquired from the storage area remaining space acquisition unit 2606 and the application size acquired from the application size acquisition unit 2607, the stored application determination unit 2602 determines whether or not the space remaining in the storage area is larger than the selected application (S2705).

In the case where the space remaining in the storage area is judged to be larger than the selected application (YES of S2705), the storage unit 2603 stores the selected application (S2706). Then, the AM 1205b judges whether or not all the applications described in the XAIT information have been selected (S2707), and in the case where all applications described in the XAIT information have not been selected, the AM 1205b selects the next application and continues the storage processing; in the case where all applications described in the XAIT information have been selected, the storage processing finishes.

On the other hand, in the case where the space remaining in the storage area is judged to be smaller than the selected application (NO of S2705) the AM 1205b judges whether or not there is an application which is already stored (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area so that the space remaining in the storage area becomes larger than the size of the selected application, and determines that the selected application is to be stored. However, in the case where the space remaining in the storage area is still not large enough for the selected application even after those applications which are already stored are deleted from the storage area, those applications which are already stored are not deleted from the storage area, and the selected application is not stored. On the other hand, in the case where, among the applications already stored, there is no application with a storage priority lower than the storage priority of the selected application, the stored application determination unit 2602 determines not to delete any of the applications already stored in the storage area, and not to store the selected application. Continuing on, the stored application determination unit 2602 judges whether or not the already-stored applications have been determined to be deleted from the storage area 2201 (S2804).

In the case where the stored application determination unit 2602 judges that the already-stored applications have been determined to be deleted from the storage area 2201 (YES of S2804), the stored application determination unit 2602 instructs the notification unit 2605 to perform a deletion notification, the storage deletion unit 2604 to delete the application from the storage area 2201, and the storage unit 2603 to store another application. Then, in accordance with a result of the determination performed by the stored application determination unit 2602, the notification unit 2605 notifies the user that the application is deleted (S2805). In accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application (S2706). Here, the storage deletion unit 2604 may delete the application from the storage area 2201 after having detected that the user has been notified by the notification unit 2605. Then, the AM 1205b determines whether or not all the applications denoted in the XAIT information have been selected (S2707), and in the case where all applications denoted in the XAIT information have not yet been selected, the AM 1205b selects the next application, and the storage processing continues; in the case where all applications denoted in the XAIT information have already been selected, the storage processing finishes.

On the other hand, in the case where the stored application determination unit 2602 has determined that the already stored application is not to be deleted from the storage area 2201 (NO of S2804), it is not possible to secure a storage area in which to store the selected application, and thus the AM 1205b judges whether or not all the applications denoted in the XAIT information have been selected (S2707). Then, in the same manner as described above, in the case where all applications denoted in the XAIT information have not yet been selected, the AM 1205b chooses the next application, and the storage processing continues; in the case where all applications denoted in the XAIT information have been selected, the storage processing finishes.

On the other hand, during judgment of whether or not there is already a stored application (S2801), in the case where there is not an already stored application (NO of S2801), or in other words, in the case where space in storage area 2201 is insufficient when an application denoted in the XAIT information is stored into the storage area 2201 from the MPEG-2 transport stream but there is not an already stored application, it is not possible to secure a storage area in which to store the selected application, and thus the AM 1205b judges whether or not all applications denoted in the XAIT have been selected (S2707). Then, in the same manner as described above, in the case where all applications denoted in the XAIT information have not yet been selected, the AM 1205b chooses the next application, and the storage processing continues; in the case where all applications denoted in the XAIT information have been selected, the storage processing finishes.

Note that in the case where space in the storage area 2201 is insufficient when an application denoted in the XAIT information is stored into the storage area 2201 from the MPEG-2 transport stream but there is not an already stored application, it is not possible to secure a storage area in which to store the selected application; in such a case, the AM 1205b may end the storage processing without storing the selected application.

Here, in the present embodiment, in the case where an application which is already stored is not denoted in the XAIT information, the storage priority comparison unit 260 considers the storage priority of that application to be a minimum, but in the present case, a method may be used in which the stored application determination unit 2602 unconditionally determines to delete that application from the storage area 2201.

Note that here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification in the display 509. However, the deletion notification provided to the user by notification unit 2605 may be realized through another method, as long as that method allows the user to detect deletion of the application.

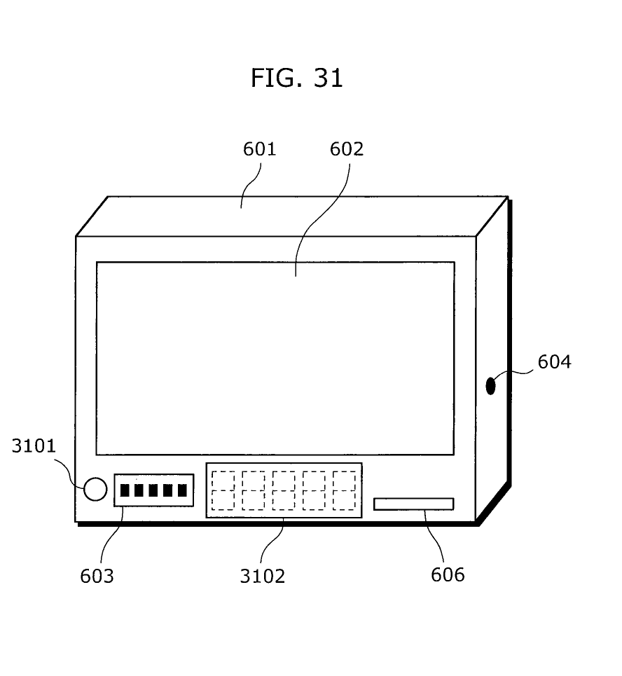

FIG. 31 is a descriptive diagram for describing a display position of the deletion notification.

The deletion notification provided to the user by notification unit 2605 may be implemented by, for example, displaying the deletion notification in a liquid crystal display of a remote control; or, as shown in FIG. 31, displaying the deletion notification in a 7-segment LED 3102 on the main body of the terminal apparatus; or, by illuminating a lamp 3101 on the main body of the terminal apparatus. In FIG. 31, constituent elements identical to those shown in FIG. 8 are given the same numbers as in FIG. 8, and descriptions are omitted.

In addition, here, the notification unit 2605 may notify the user than the application has been stored upon completing storage of an application.

In addition, here, the stored application determination unit 2602 does not necessarily have to determine deletion from the storage area 2201 in order from the application with a low storage priority. For example, with a cable system as described in the OCAP specifications (OCAP 1.0 Profile OC-SP-OCAP1.0-IF-I09-031121), in the case where an already stored application is executed, execution of that application must not be interrupted by deleting that same application from storage; therefore, even if the application has the lowest storage priority among the applications already stored in the storage area, the stored application determination unit 2602 does not determine to delete that application from the storage area if that application is currently being executed.

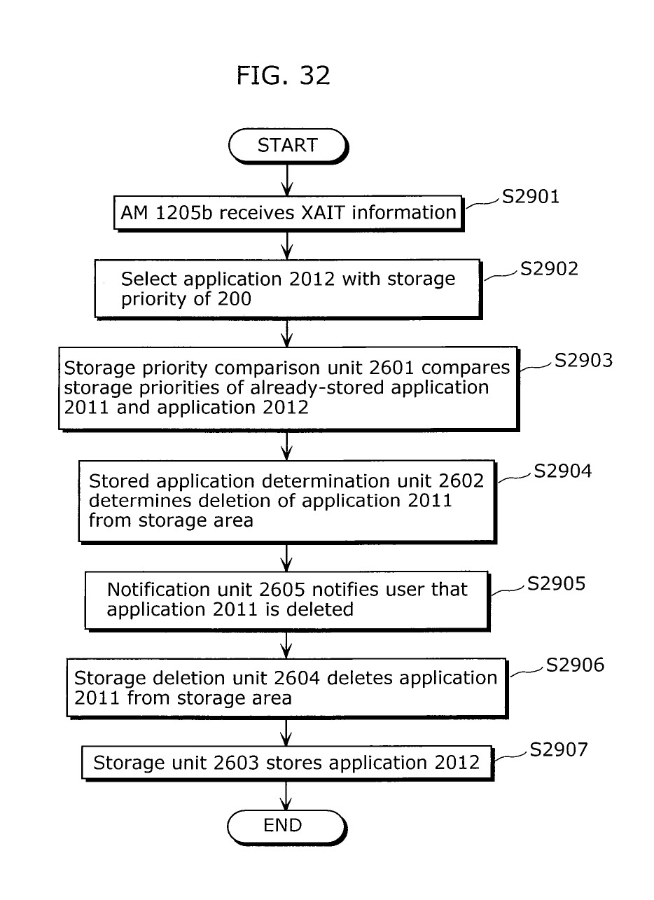

FIG. 32 is a flowchart which shows an overall example of the operation in which the AM 1205b stores an application. In particular, this operation shows the case where the application 2011 is already stored in the storage area 2201, and the AM 1205b, as shown in FIG. 22, acquires the XAIT information in which the application 2011 and application 2012 are denoted, and the space in the storage area 2201 is insufficient. Here, the storage priority of the application 2011 denoted in the XAIT information is 100, and the storage priority of the application denoted in the XAIT information 2012 is 200. In addition, here, the capacity of the storage area 2201 is assumed to be less than a total of the size of the application 2011 and the application 2012. In addition, in the OCAP specifications, storage processing must not interfere with execution of the currently executed application; therefore, here, the application 2011 is not started.

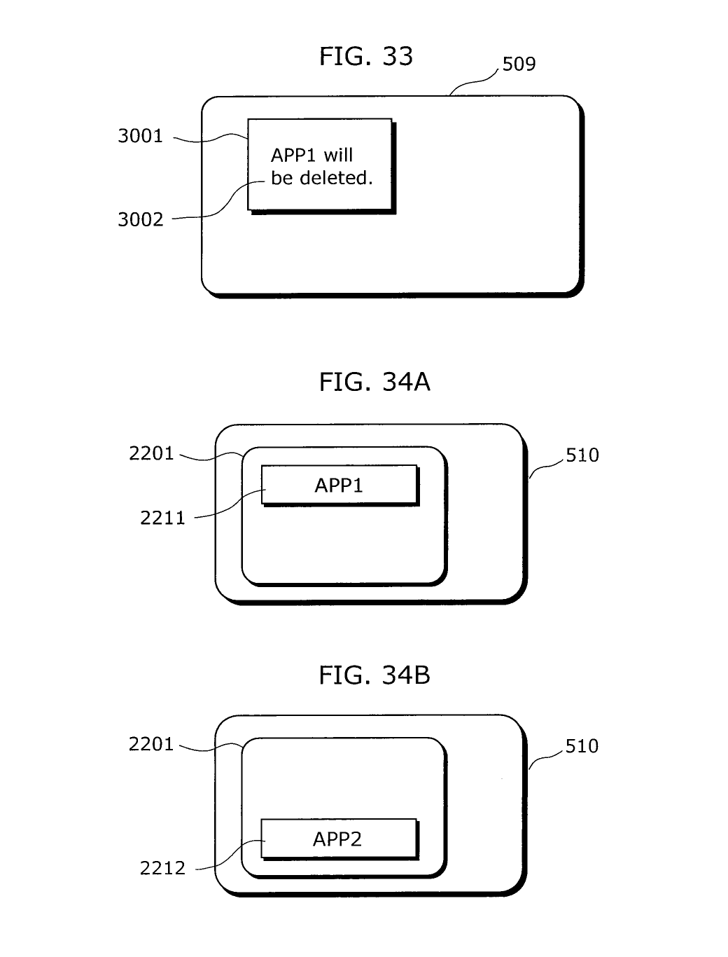

When the AM 1205b acquires the XAIT information (S2901), the application 2012, which has the highest storage priority, 200, is selected from among the applications denoted in the XAIT information (S2902). Because the application 2011 is already stored, and because the space remaining in the storage area 2201 is less than the space necessary for storage of the application 2012, the storage priority comparison unit 2601 compares the storage priority of the already-stored application 2011 with that of the application 2012 (S2903). The stored application determination unit 2602 determines to delete the application 2011, which has a low storage priority, from the storage area 2201 (S2904). Because the already-stored application 2011 has been determined to be deleted from the storage area 2201, the stored application determination unit 2602 instructs the notification unit 2605 to provide a notification, the storage deletion unit 2604 to delete the application 2011, and the storage unit 2603 to store the application 2012. Then, the notification unit 2605 notifies the user that the application 2011 is deleted (S2905). Here, the application deletion notification provided to the user by the notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 33, in the display 509.

FIG. 33 is a diagram showing a deletion notification displayed in a display.

A dialog box 3001 has display elements of a message 3002. Note that a character string of the message 3002 may be a character string aside from the character string shown in FIG. 33 as long as it provides information necessary for notifying deletion of the application to the user; the message 3002 may be of a format aside from a character string. Moreover, the display elements of the dialog box 3001 are not limited to the display elements shown in FIG. 33; they may be other display elements as long as the user can be notified of the deletion of the application 2011. Next, the storage deletion unit 2604 deletes the application 2011 from the storage area 2201 (S2906). Then, the storage unit 2603 stores the application 2012 (S2907).

FIG. 34A is a diagram showing an example of a state of the application stored in the storage 2201 area prior to acquisition of the XAIT information. Here, a state 2211 shows the state of the stored application 2011.

FIG. 34B is a diagram showing an example of a state of the application stored in the storage area 2201 after acquisition of the XAIT information. Here, a state 2212 shows the state of the stored application 2012.

Note that in the present embodiment, determination of the application to be stored, as performed by the stored application determination unit 2602, is realized, as shown in FIG. 29, by a method of storage processing that selects the application in order from applications with a high storage priority, based on the result of the comparison performed by the storage priority comparison unit (S2702). However, a method may be used in which the stored application determination unit 2602 determines a set that includes the application to be stored and the application to be deleted from the storage area 2201, simultaneously for all applications denoted in the XAIT information. For example, a method may be used in which the stored application determination unit 2602 refers to the received XAIT information, and determines, for all applications denoted in the XAIT information, to store the applications in order from applications with a high storage priority, when the size of all the applications to be stored in the storage area 2201 does not exceed the total size of the storage area 2201; and applications that are already stored but have not been determined to be stored are determined to be deleted from the storage area 2201.

Note that the present embodiment can still be implemented in the case where the AM 1205b does not have the storage area remaining space acquisition unit 2606 and the application size acquisition unit 2607, as well as in the case where the AM 1205b has the application size acquisition unit 2607 but the application size acquisition unit 2607 cannot acquire the size of the application. For example, a method may be used in which, in the case where the AM 1205b does not have the storage area remaining space acquisition unit 2606 and the application size acquisition unit 2607, the stored application determination unit 2602 determines to store the applications in order from the application with a high storage priority, in accordance with the result of the comparison performed by the storage priority comparison unit 2601, and in the case where the storage unit 2603 fails to store the application, the stored application determination unit 2602 determines to delete the application from the storage area 2201 in order from the application with a low storage priority.

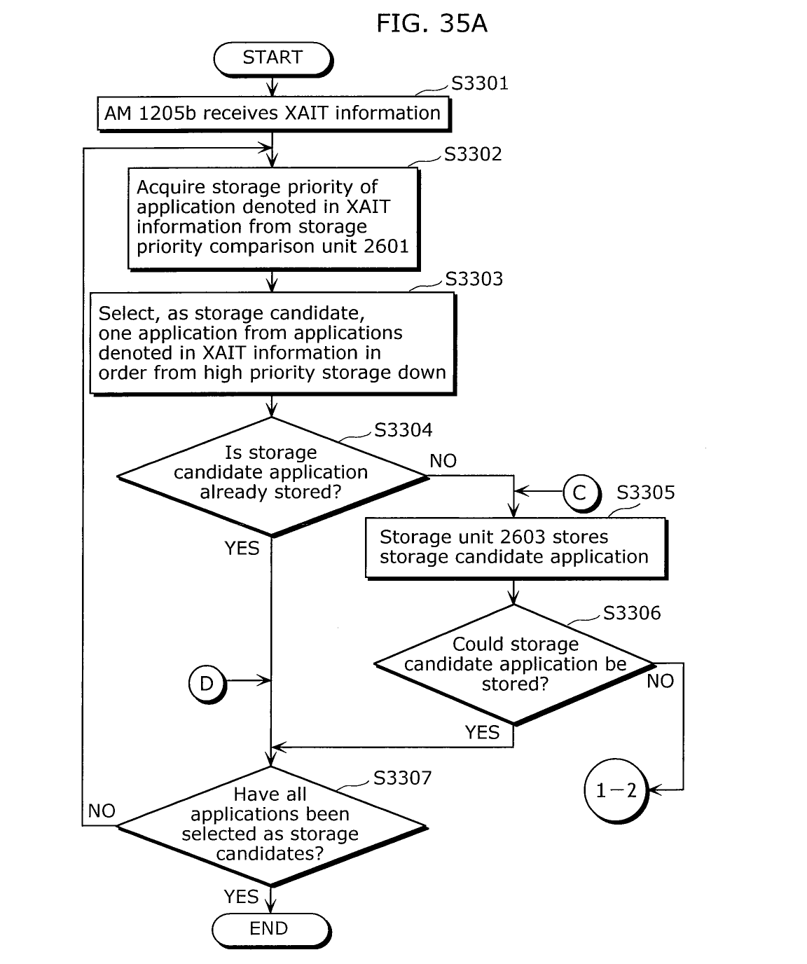

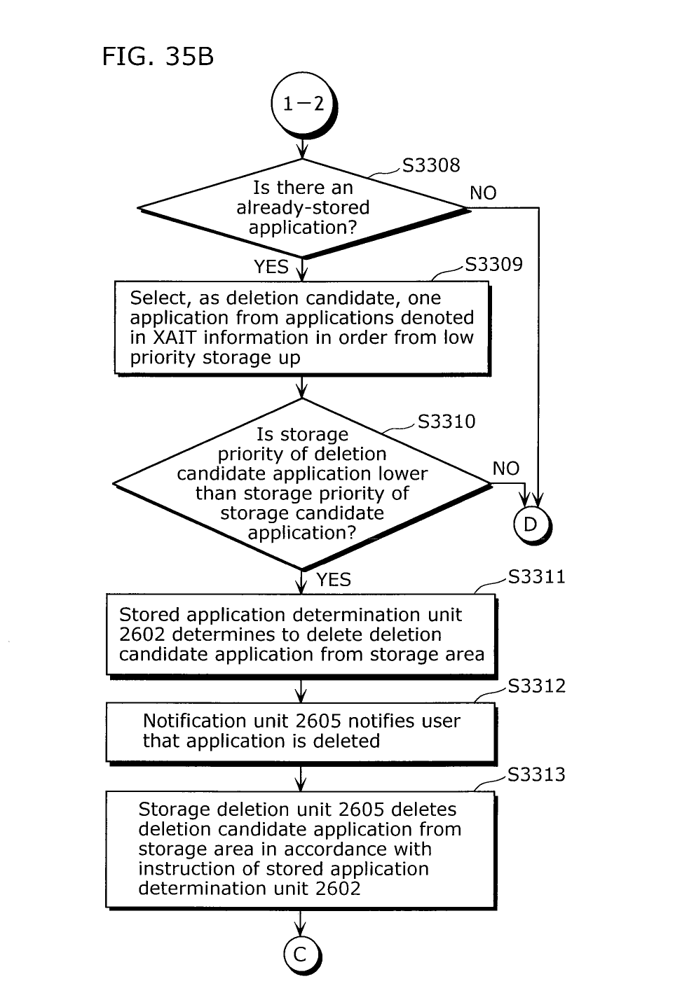

FIGS. 35A and 35B are flowcharts showing an example of an operation of storage processing for an application carried out by the AM 1205b, which does not have the storage area remaining space acquisition unit 2606 and the application size acquisition unit 2607, upon receiving the XAIT information. In particular, these flowcharts show examples of storage processing operations for an application from the MPEG-2 transport stream into the storage area 2201, as carried out by the AM 1205b, which does not have the storage area remaining space acquisition unit 2606 and the application size acquisition unit 2607, in the case where the space in the storage area 2201 is insufficient when storing the application denoted in the XAIT information from the MPEG-2 transport stream into the storage area 2201.

As shown in FIG. 35A, when the AM 1205b receives the XAIT information (S3301), the stored application determination unit 2602 acquires the storage priority of the applications denoted in the XAIT information from the storage priority comparison unit 2601 (S3302). Then, the stored application determination unit 2602 selects, from the applications denoted in the XAIT information, one application that has not been selected yet, in order from the application with a high storage priority, as a storage candidate (S3303). Next, the stored application determination unit 2602 determines whether or not the application selected as the storage candidate is stored (S3304).

In the case where the application selected as the storage candidate is stored (YES of S3304), the stored application determination unit 2602 determines whether or not all the applications denoted in the XAIT information have been selected as storage candidates (S3307). Here, in the case where all the applications denoted in the XAIT information have not yet been selected as storage candidates (NO of S3307), the stored application determination unit 2602 selects the next application as the storage candidate and continues the storage processing; in the case where all the applications denoted in the XAIT information have already been selected as storage candidates (YES of S3307), the storage processing ends.

On the other hand, in the case where the application selected as the storage candidate is not stored (NO of S3304), the storage unit 2603 stores the storage candidate application (S3305). Then, the AM 1205b determines whether or not the storage candidate application was successfully stored (S3306).

In the case where the storage candidate application was successfully stored (YES of S3306), the stored application determination unit 2602 determines whether or not all the applications denoted in the XAIT information have been selected as storage candidates (S3307). In the same manner as above, in the case where all the applications denoted in the XAIT information have not yet been selected as storage candidates (NO of S3307), the stored application determination unit 2602 selects the next application as the storage candidate and continues the storage processing; in the case where all the applications denoted in the XAIT information have already been selected as storage candidates (YES of S3307), the storage processing ends.

On the other hand, in the case where the storage candidate application was not able to be stored (NO of S3306), the stored application determination unit 2602 determines whether or not there is an already-stored application, as shown in FIG. 35B (S3308).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 selects one application from among the already-stored applications, in order from the application with a low storage priority, as a deletion candidate (S3309). Then, based on a result of the acquisition from the storage priority comparison unit 2601, the stored application determination unit 2602 determines whether or not the storage priority of the application selected as the deletion candidate is lower than the storage priority of the application selected as the storage candidate (S3310).

In the case where the storage priority of the application selected as the deletion candidate is lower than the storage priority of the application selected as the storage candidate (YES of S3310), the stored application determination unit 2602 determines to delete the deletion candidate application from the storage area (S3311). Then, the stored application determination unit 2602 instructs the notification unit 2605 to perform a deletion notification for the application selected as the deletion candidate, the storage deletion unit 2604 to delete the application selected as the deletion candidate from the storage area 2201, and the storage unit 2603 to store the application selected as the storage candidate. Then, the notification unit 2605 notifies the user that the application is deleted, in accordance with a result of the determination performed by the stored application determination unit 2602 (S3312), and the storage deletion unit 2604 deletes the application from the storage area 2201, in accordance with the result of the determination performed by the stored application determination unit 2602 (S3313). As shown in FIG. 35A, the storage unit 2603 stores the application, in accordance with the result of the determination carried out by the stored application determination unit 2602. In the case where the application selected as the storage candidate was successfully stored (YES of S3306), the stored application determination unit 2602 determines, in the same manner as above, whether or not all the applications denoted in the XAIT information have been selected as storage candidates (S3307). In the case where all the applications denoted in the XAIT information have not yet been selected as storage candidates (NO of S3307), the stored application determination unit 2602 selects the next application as the storage candidate and continues the storage processing; in the case where all the applications denoted in the XAIT information have already been selected as storage candidates (YES of S3307), the storage processing ends.

On the other hand, in the case where the application selected as the storage candidate was not able to be stored, the stored application determination unit 2602 selects the next application as the deletion candidate, and the storage processing continues. However, in the case where the storage priority of the application selected as the deletion candidate is higher than the storage priority of the application selected as the storage candidate (NO of S3310), a storage area for storing the application selected as the storage candidate cannot be secured. Therefore, as shown in FIG. 35A, the stored application determination unit 2602 determines whether or not all the applications denoted in the XAIT information have been selected as storage candidates (S3307); in the case where all the applications denoted in the XAIT information have not yet been selected as storage candidates (NO of S3307), the stored application determination unit 2602 selects the next application as the storage candidate and continues the storage processing, and in the case where all the applications denoted in the XAIT information have already been selected as storage candidates (YES of S3307), the storage processing ends.

On the other hand, during judgment of whether or not there is already a stored application (S3308), in the case where there is not an already stored application (NO of S3308), or in other words, in the case where space in storage area 2201 is insufficient when an application denoted in the XAIT information is stored into the storage area 2201 from the MPEG-2 transport stream but there is not an already stored application, it is not possible to secure a storage area in which to store the application selected as the storage candidate. Accordingly, as shown in FIG. 35A, the stored application determination unit 2602 determines whether or not all the applications denoted in the XAIT information have been selected (S3307). As a result, in the case where all the applications denoted in the XAIT information have not yet been selected as storage candidates (NO of S3307), the stored application determination unit 2602 selects the next application as the storage candidate and continues the storage processing; in the case where all the applications denoted in the XAIT information have already been selected as storage candidates (YES of S3307), the storage processing ends.

Moreover, in the present embodiment, in the case where the storage priority is the same for plural applications, the AM 1205b may determine a set of applications to delete from the storage area 2201 through another determination means, such as an inquiry directed to the user.

In addition, in the present embodiment, receipt of the XAIT information by the AM 1205b is performed when power is supplied to the terminal apparatus 500, or when the XAIT information is updated. In other words, in the present embodiment, receipt of the XAIT information by the AM 1205b corresponds to receipt of the XAIT information by the AM 1205b when power is supplied to the terminal apparatus 500 and receipt of the XAIT information by the AM 1205b when the XAIT information is updated after power is supplied to the terminal apparatus 500. However, the present invention can still be implemented with another method of updating of the XAIT information aside from directly updating the XAIT information transmitted from the head end 101, such as updating the XAIT information through the AM 1205b or an application.

Here, updating the XAIT information through an application is realized by the AM 1205b preparing an API for carrying out the XAIT information update for an application having a special privilege. In the API for updating the XAIT information, there is an application with a special privilege that makes newly-created XAIT information registerable, an application in which the AM 1205b makes XAIT information that is already stored in the primary storage or secondary storage modifiable, and the like.

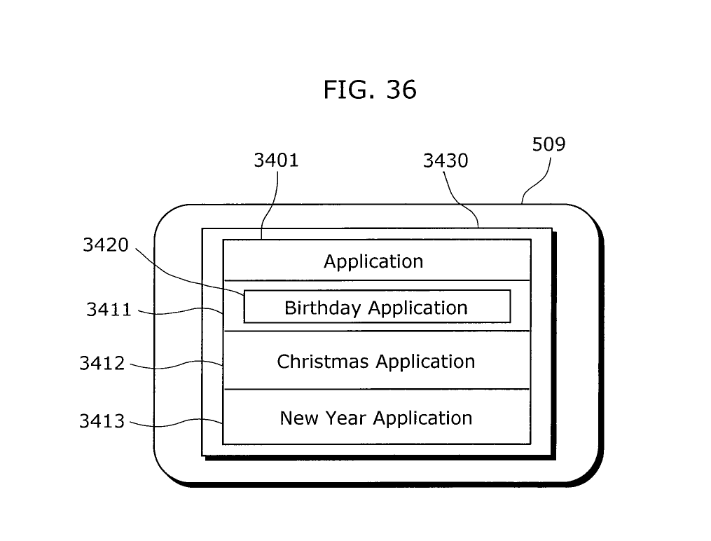

FIG. 36 is a diagram showing an example of a message for prompting the user to select an application to store. The dialog display program included in the library 1201b of the OS 1201 displays the above message in the display 509 by the application with a special privilege, which has been provided with the API for updating the XAIT information, sending the information to be displayed to the CPU 514 of the terminal apparatus 500. A column 3401 in a dialog box 3430 describes an application name of each application. Lines 3411, 3412, and 3413 is a list of information of the applications. When the user selects the application shown in line 3411, the application with the special privilege uses the API for updating the XAIT information, instructing the AM 1205b to update the XAIT information so that the application shown in line 3411 is caused to be stored. Here, selection of the application shown in line 3411 is realized by, for example, the user pushing an OK key assigned to a remote control when an indicator 3420 highlights the application with an application name of “birthday application” shown in line 3411, as indicated in FIG. 36.

When the application that has a special privilege calls the API for updating the XAIT information, the AM 1205b generates or edits the XAIT information and stores the XAIT information in the primary storage or secondary storage, in accordance with the instruction from the application that has a special privilege. Such API for updating the XAIT information is realized by publicly-known technology. For example, the API for registering the XAIT information is defined by the org.ocap.application.AppManagerProxy class registerUnboundApp method, as found in the OCAP specifications (OCAP 1.0 Profile OC-SP-OCAP 1.0-IF-I09-031121). Using the API which the application having a special privilege registers the XAIT information with, when new XAIT information is registered (registration of the XAIT newly created by the application having a special privilege), the AM 1205b accepts, as the update of the XAIT information, the XAIT information registered through the application having a special privilege.

In this manner, with the first embodiment, by using the storage priority, it is possibly to always preferentially store an application with a high storage priority. Furthermore, in the case where an application is deleted from the storage area 2201, by notifying the user that the application is deleted, the user can know, in advance, of behavioral changes in the application, such as more time being taken from acquisition of the XAIT information to starting of the application, caused by the deletion of an already-stored application. As a result, the user can use the terminal 500 with peace of mind.

### Second Embodiment

In the first embodiment, in the case where the stored application determination unit 2602 has determined to delete an already-stored application from the storage area 2201, the notification unit 2605 notifies a user that the application is deleted. However, the application storage deletion unit 2604 deletes the application from the storage area 2201 regardless of whether or not the user has confirmed the deletion notification. For example, there is the possibility that the application is deleted from the storage area 2201 without the user noticing the application deletion notification.

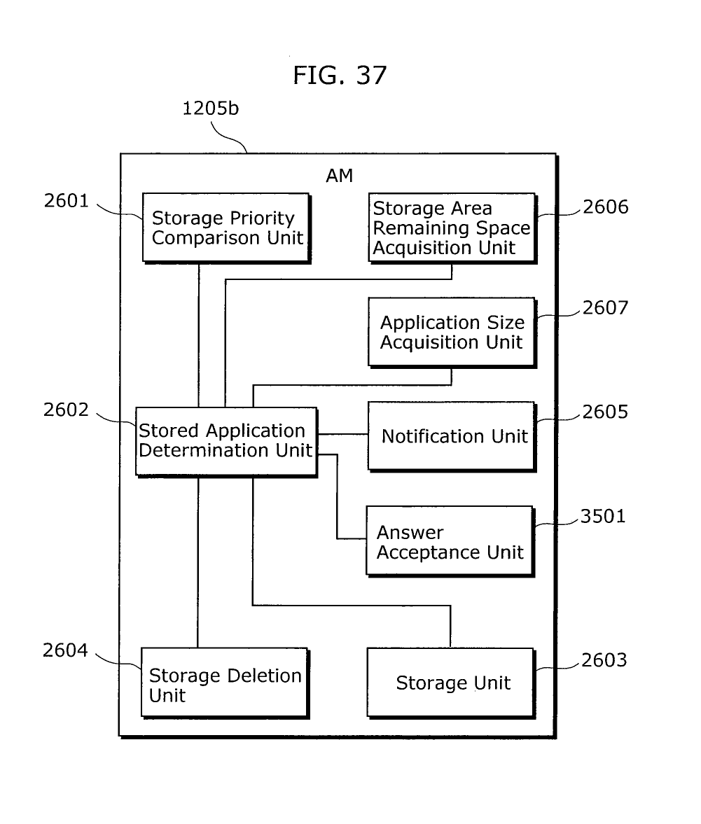

Accordingly, in the present embodiment, an AM 1205b includes an answer acceptance unit 3501 for accepting an answer from the user, as is further shown in FIG. 37.

FIG. 37 is a structural diagram which shows a configuration of the AM 1205b in the present embodiment.

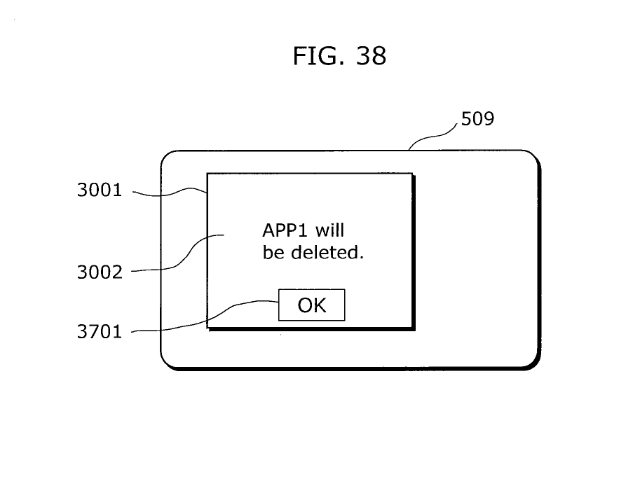

In the present embodiment, a notification unit 2605 notifies the user that an application is deleted, in accordance with an instruction from a stored application determination unit 2602. Here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 38, in a display 509.

FIG. 38 is a diagram showing an example of a deletion notification displayed in the display 509 in the present embodiment.

A dialog box 3001 has display elements of a message 3002 and an OK button 3701. Note that the character string may be a character string aside from the character string shown in FIG. 38 as long as it provides information necessary for notifying deletion of the application to the user, and the message 3002 may be of a format aside from a character string. In addition, the character string of the OK button 3701 is not limited to the character string shown in FIG. 38, and may be a different character string. Moreover, the display elements of the dialog box 3001 are not limited to the display elements shown in FIG. 38; they may be other display elements as long as the user can be notified of the deletion of the application 2011 and the CPU 514 can confirm that the user has selected to confirm the deletion notification.

The answer acceptance unit 3501 accepts selection information from the CPU 514 when the user selects to confirm the deletion notification by selecting the OK button 3701, and upon accepting the selection information from the CPU 514, notifies the stored application determination unit 2602 of notification confirmation information.

Furthermore, in the present embodiment, the stored application determination unit 2602 determines a set of an application to be stored in the storage area 2201 and an application to delete from the storage area 2201 through the same method described in the first embodiment, and in the case of determining to delete the already-stored application from the storage area 2201, provides a notification instruction to the notification unit 2605, an application storage instruction to the storage unit 2603, and an application deletion instruction to the storage deletion unit 2604. However, in the present embodiment, the stored application determination unit 2602 provides the application deletion instruction to the storage deletion unit 2604 and the application storage instruction to the storage unit 2603 for the first time after accepting the notification confirmation information from the answer acceptance unit 3501. Notifying the user of deletion of the application before the application storage deletion unit 2604 deletes the application from the storage area 2201 is realized in this manner.

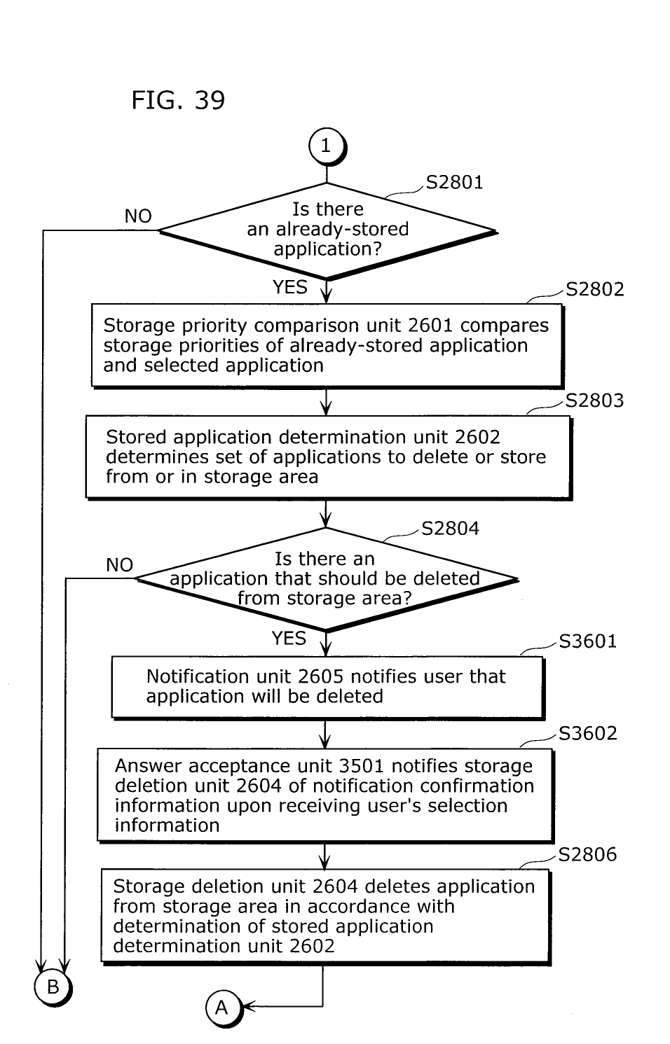

FIG. 39 is a flowchart showing an example of a characteristic application storage processing operation carried out by the AM 1205b that has received the XAIT information, in the present embodiment. FIG. 39 shows a processing occurring after step S2705 shown in FIG. 29, and in particular, shows an example of a storage processing operation carried out by the AM 1205b in the case where the space in the storage area 2201 is insufficient when storing the application denoted in the XAIT information from the MPEG-2 transport stream into the storage area 2201.

In FIG. 39, steps identical to those in FIG. 30 are given the same numbers as in FIG. 30.

As shown in FIG. 29, upon receiving the XAIT information (S2701), the AM 1205b selects, from among the applications denoted in the XAIT information, one application that has not yet been selected, in order from applications with a high storage priority down. However, here, in storage processing carried out in accordance with the received XAIT information, the storage deletion unit 2604 selects one application aside from the applications already deleted from the storage area 2201 (S2702). Then, the AM 1205b judges whether or not the selected application has been stored (S2703).

In the case where the selected application is stored (YES of S2703), the AM 1205b judges whether or not all the applications denoted in the XAIT information have been selected (S2707). Here, in the case where all the applications denoted in the XAIT information have not been selected (NO of S2707), the AM 1205b selects the next application, and the storage processing continues. In the case where all the applications denoted in the XAIT information have been selected (YES of S2707), the AM 1205b finishes the storage processing.

On the other hand, in the case where the selected application has not been stored (NO of S2703), the stored application determination unit 2602 acquires the space remaining in the storage area from the storage area remaining space acquisition unit 2606, and acquires the application size from the application size acquisition unit 2607 (S2704). Then, based on the space remaining in the storage area acquired from the storage area remaining space acquisition unit 2606 and the application size acquired from the application size acquisition unit 2607, the stored application determination unit 2602 determines whether or not the space remaining in the storage area is larger than the selected application (S2705).

In the case where the space remaining in the storage area is judged to be larger than the selected application (YES of S2705), the storage unit 2603 stores the selected application (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

On the other hand, in the case where the space remaining in the storage area is judged to be smaller than the selected application (NO of S2705) the AM 1205b judges whether or not there is an application which is already stored, as shown in FIG. 39 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is still not large enough for the selected application even after those applications which are already stored are deleted from the storage area, the stored application determination unit 2602 determines not to delete those applications which are already stored from the storage area, and not to store the selected application. Continuing on, the stored application determination unit 2602 judges whether or not the stored application determination unit 2602 has determined the already-stored applications to be deleted from the storage area 2201 (S2804).

In the case where the stored application determination unit 2602 judges that the already-stored applications have been determined to be deleted from the storage area 2201 (YES of S2804), the stored application determination unit 2602 instructs the notification unit 2605 to perform a deletion notification. Then, in accordance with a result of the determination performed by the stored application determination unit 2602, the notification unit 2605 notifies the user that the application is deleted (S3601). Here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 38, in the display 509. The dialog box 3001 has display elements of a message 3002 and the OK button 3701. When the user selects the OK button 3701 by operating the remote control, the CPU 514 sends the selection information from the user to the answer acceptance unit 3501 of the AM 1205b. Upon receipt of the selection information from the user, the answer acceptance unit 3501 notifies the stored application determination unit 2602 of the notification confirmation information (S3602). Upon receipt of the notification of the notification confirmation information from the answer acceptance unit 3501, the stored application determination unit 2602 instructs the storage deletion unit 2604 to delete the application from the storage area 2201, and instructs the storage unit 2603 to store the other application. In other words, upon receipt of the user's selection information, the answer acceptance unit 3501 notifies the storage deletion unit 2604 and storage unit 2603 of that selection information via the stored application determination unit 2602. Then, in accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application (S2706). The AM 1205b then judges whether or not all the applications denoted in the XAIT information have been selected (S2707). Then, in the same manner as described above, in the case where all applications denoted in the XAIT information have not yet been chosen, the AM 1205b chooses the next application, and the storage processing continues; in the case where all applications denoted in the XAIT information have been selected, the storage processing finishes.

On the other hand, in the case where the stored application determination unit 2602 has determined that the already stored application is not to be deleted from the storage area 2201 (NO of S2804), it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing ends.

On the other hand, in the case where there is not an already stored application (NO of S2801), or in other words, in the case where space in the storage area 2201 is insufficient when an application denoted in the XAIT information is stored in the storage area 2201 from the MPEG-2 transport stream but there is not an already stored application, it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing ends.

Note that in the case where space in storage area 2201 is insufficient when an application denoted in the XAIT information is stored into the storage area 2201 from the MPEG-2 transport stream but there is not an already stored application, it is not possible to secure a storage area in which to store the selected application; in such a case, the AM 1205b may end the storage processing without storing the selected application.

Here, in the case where an already-stored application is not denoted in the XAIT information, the storage priority comparison unit 2601 considers the storage priority of the application to be a minimum value. In such a case, a method may be used in which the stored application determination unit 2602 unconditionally determines to delete that application from the storage area 2201.

Note that in the case where the user can set a timeout time in the answer acceptance unit 3501, and there is no answer from the user while the answer acceptance unit 3501 is in that timeout time, the storage deletion unit 2604 may consider the application deletion notification to be confirmed by the user and the OK button 3701 to be selected, and delete the application from the storage area 2201.

In such a manner, in the second embodiment, in the case where an application is deleted from the storage area 2201, by deleting the application from the storage area 2201 after notifying the user that the application is to be deleted and obtaining the user's confirmation, the user can more accurately know, in advance, of behavioral changes in the application, such as more time being taken from acquisition of the XAIT information to starting of the application, caused by the deletion of an already-stored application.

### Third Embodiment

In the second embodiment, in the case where the stored application determination unit 2602 has determined to delete an already-stored application from the storage area 2201, the notification unit 2605 notifies a user that the application is deleted, and an answer acceptance unit 3501 accepts notification confirmation information from the user. After that, the storage deletion unit 2604 deletes the application from storage area 2201, in accordance with the determination carried out by the stored application determination unit 2602. However, in the second embodiment, the user cannot reject deletion of the application from the storage area 2201. For example, there is a possibility that a certain application is deleted from the storage area 2201 even when the user does not want to delete the application from the storage area 2201.

Accordingly, in the present embodiment, the stored application determination unit 2602 of the AM 1205b can further change the determination result in accordance with answer information from the user which the answer acceptance unit 3501 receives from the user.

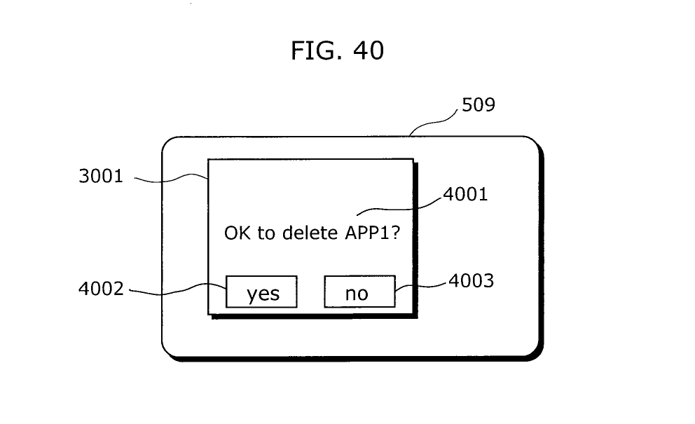

In the present embodiment, the notification unit 2605 confirms with the user whether the application may be deleted before the storage deletion unit 2604 deletes the application 2011 from the storage area 2201, in the case where the stored application determination unit 2602 has determined to delete the already-stored application from the storage area 2201. Here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 40, in the display 509.

FIG. 40 is a diagram showing an example of a deletion notification displayed in the display 509 in the present embodiment.

A dialog box 3001 has display elements of a message 4001, a Yes button 4002, and a No button 4003. Note that the character string of the message 4001 may be a character string aside from the character string shown in FIG. 40 as long as it provides information necessary for notifying deletion of the application to the user; the message 4001 may be of a format aside from a character string. In addition, character strings of the Yes button 4002 and the No button 4003 are not limited to the character strings shown in FIG. 40, and may be different character strings. Moreover, the display elements of the dialog box 3001 are not limited to the display elements shown in FIG. 40; they may be other display elements as long as the user can be notified of the deletion of the application and the CPU 514 can confirm that the user has selected allowance or rejection in response to the deletion notification.

In addition, in the present embodiment, the answer acceptance unit 3501 accepts, from the CPU 514, the selection information indicated by the user when allowing or rejecting deletion of the application through selection of the Yes button 4002 or the No button 4003. Then, upon receiving the selection information from the CPU, the answer acceptance unit 3501 judges whether that selection information indicates allowance of application deletion or rejection of application deletion. The answer acceptance unit 3501 notifies the stored application determination unit 2602 of the notification confirmation information, in the case of indicating allowance of the deletion of the application, and notifies the stored application determination unit 2602 of notification rejection information in the case of indicating rejection of the deletion of the application.

Furthermore, in the present embodiment, the stored application determination unit 2602 determines, through the same method as mentioned in the first embodiment, a set which includes an application to be stored in the storage area 2201 and an application to be deleted from the storage area 2201. Then, in the case of determining to delete the already-stored application from the storage area 2201, the stored application determination unit 2602 provides a notification instruction to the notification unit 2605, an application storage instruction to the storage unit 2603, and an application deletion instruction to the storage deletion unit 2604. However, in the present embodiment, in the case where the user has allowed deletion of the application, the stored application determination unit 2602 provides the application deletion instruction to the storage deletion unit 2604 application storage instruction to the storage unit 2603 and the application deletion instruction to the storage deletion unit 2604 for the first time after accepting the notification confirmation information from the answer acceptance unit 3501. On the other hand, in the case where the user does not allow the deletion of the application, upon receiving the notification of the notification rejection information from the answer acceptance unit 3501, the stored application determination unit 2602 changes the determination of the set of the application to delete from the storage area 2201 and the application to store.

Here, changing the determination is realized through, for example, a method in which the stored application determination unit 2602 determines deletion, from the storage unit 2201, of the application with the next lowest storage priority, and the like. Note that another method may be used as long as the method does not delete an application from the storage area for which the user has rejected the deletion.

Then, the stored application determination unit 2602 provides, for the first time after changing the determination, an application storage instruction to the storage unit 2603 and an application deletion instruction to the application storage deletion unit 2604, so as to comply with the changed determination result.

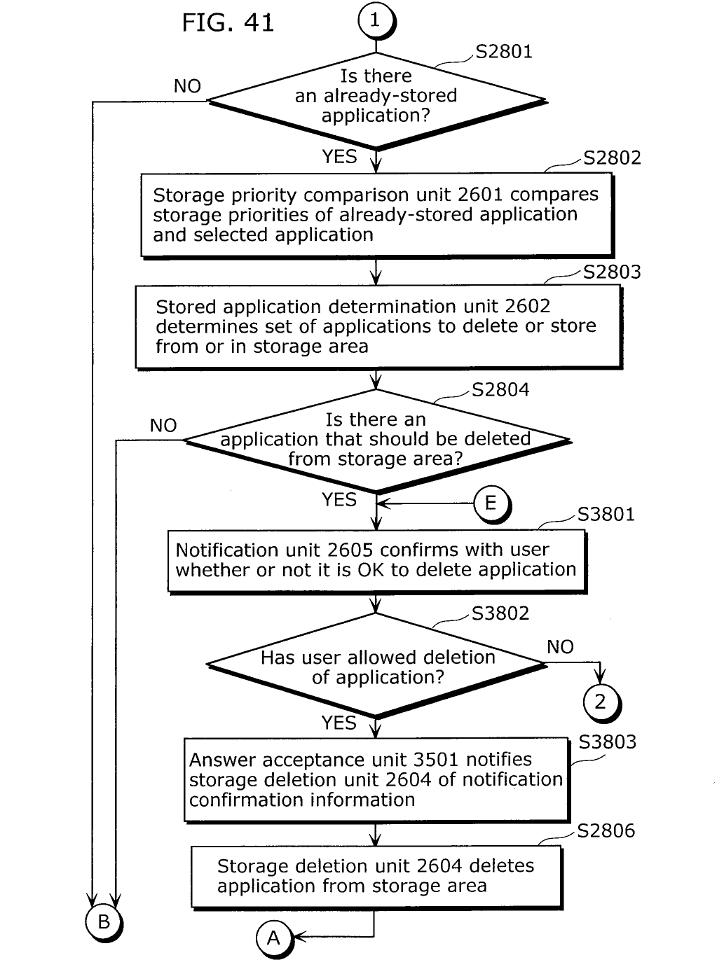

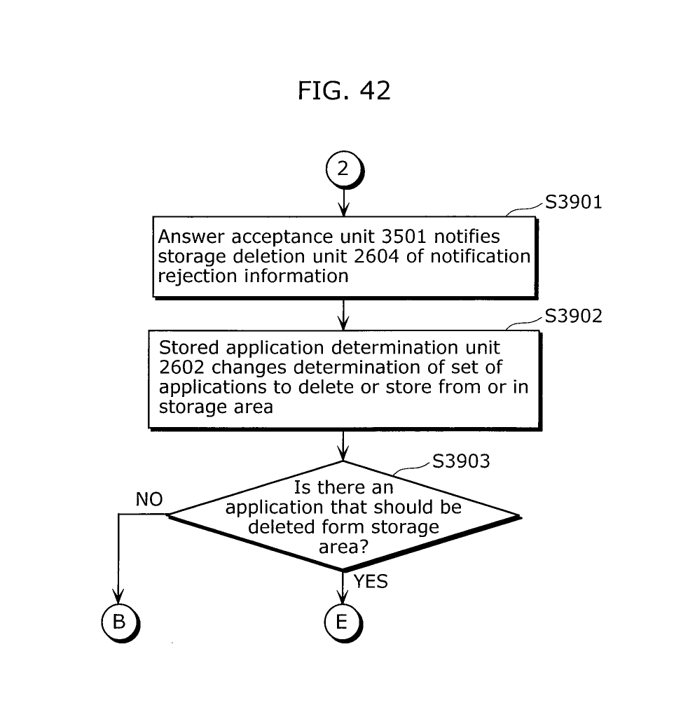

FIGS. 41 and 42 are flowcharts showing an example of a characteristic application storage processing operation carried out by the AM 1205b that has received the XAIT information, in the present embodiment. FIGS. 41 and 42 shows a processing occurring after step S2705 shown in FIG. 29, and in particular, shows an example of a storage processing operation carried out by the AM 1205b in the case where the space in the storage area 2201 is insufficient when storing the application denoted in the XAIT information from the MPEG-2 transport stream into the storage area 2201.

In FIG. 41, steps identical to those in FIG. 30 are given the same numbers as in FIG. 30.

As shown in FIG. 29, upon receiving the XAIT information (S2701), the AM 1205b selects, from among the applications denoted in the XAIT information, one application that has not yet been selected, in order from applications with a high storage priority down. However, here, in storage processing carried out in accordance with the received XAIT information, the storage deletion unit 2604 selects one application aside from the applications already deleted from the storage area 2201 (S2702). Then, the AM 1205b judges whether or not the selected application has been stored (S2703).

In the case where the selected application is stored (YES of S2703), the AM 1205b judges whether or not all the applications denoted in the XAIT information have been selected (S2707). Here, in the case where all the applications denoted in the XAIT information have not been selected (NO of S2707), the AM 1205b selects the next application, and the storage processing continues. In the case where all the applications denoted in the XAIT information have been selected (YES of S2707), the storage processing ends.

On the other hand, in the case where the selected application has not been stored (NO of S2703), the stored application determination unit 2602 acquires the space remaining in the storage area from the storage area remaining space acquisition unit 2606, and acquires the application size from the application size acquisition unit 2607 (S2704). Then, based on the space remaining in the storage area acquired from the storage area remaining space acquisition unit 2606 and the application size acquired from the application size acquisition unit 2607, the stored application determination unit 2602 determines whether or not the space remaining in the storage area is larger than the selected application (S2705).

In the case where the space remaining in the storage area is judged to be larger than the selected application (YES of S2705), the storage unit 2603 stores the selected application (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing ends.

On the other hand, in the case where the space remaining in the storage area is judged to be smaller than the selected application (NO of S2705) the AM 1205b judges whether or not there is an application which is already stored, as shown in FIG. 41 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is still not large enough for the selected application even after those applications which are already stored are deleted from the storage area, the stored application determination unit 2602 determines not to delete those applications which are already stored from the storage area, and not to store the selected application. Continuing on, the stored application determination unit 2602 judges whether or not the stored application determination unit 2602 has determined the already-stored applications to be deleted from the storage area 2201 (S2804).

In the case where the stored application determination unit 2602 judges that the already-stored applications have been determined to be deleted from the storage area 2201 (YES of S2804), the stored application determination unit 2602 instructs the notification unit 2605 to perform a deletion notification. Then, the notification unit 2605 confirms with the user whether or not the application may be deleted (S3801). Here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 40, in the display 509. A dialog box 3001 has display elements of a message 4001, a Yes button 4002, and a No button 4003.

When the user selects the Yes button 4002 or the No button 4003 by operating the remote control, the CPU 514 sends the selection information from the user to the answer acceptance unit 3501 of the AM 1205b.

Upon receiving the user's selection information from the CPU 514, the answer acceptance unit 3501 judges whether the user's selection information indicates allowance of deletion of the application or rejection of deletion of the application (S3802).

In the case where the user's selection information indicates allowance of deletion of the application, the answer acceptance unit 3501 notifies the stored application determination unit 2602 of the notification confirmation information (S3803). Upon receipt of the notification of the notification confirmation information from the answer acceptance unit 3501, the stored application determination unit 2602 instructs the storage deletion unit 2604 to delete the application from the storage area 2201, and instructs the storage unit 2603 to store the other application. Then, in accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application, as shown in FIG. 29 (S2706). Then, the AM 1205b judges whether or not all the applications denoted in the XAIT information have been selected (S2707), and in the case where all applications denoted in the XAIT information have not been selected (NO of S2707), the AM 1205b selects the next application and continues the storage processing; in the case where all applications denoted in the XAIT information have been selected (YES of S2707), the AM 1205b finishes the storage processing.

On the other hand, when the user's selection information indicates rejection of deletion of the application (NO of S3802), the answer acceptance unit 3501 notifies the stored application determination unit 2602 of the notification rejection information, as shown in FIG. 42 (S3901). Upon receiving the notification rejection information from the answer acceptance unit 3501, the stored application determination unit 2602 changes the determined set of the application to delete from the storage area 2201 and the application to store (S3902). Here, the stored application determination unit 2602 determines to delete the application which has a low storage priority from the storage area 2201. However, the determination is carried out so that the storage priority of the application to be deleted is lower than the storage priority of the application to be stored. In the case where an application with a storage priority lower than that of the application, the application is determined not to be deleted from the storage area 2201.

Continuing on, the stored application determination unit 2602 judges whether or not the stored application determination unit 2602 has determined the already-stored applications to be deleted from the storage area 2201 (S3903). In the case where the stored application determination unit 2602 judges that the already-stored applications have been determined to be deleted from the storage area 2201 (YES of S3903), the stored application determination unit 2602 once again instructs the notification unit 2605 to perform a deletion notification. Once again, the notification unit 2605 confirms with the user whether the application may be deleted (S3801), and the storage processing is continued. On the other hand, in the case where the stored application determination unit 2602 has determined that the already stored application is not to be deleted from the storage area 2201 (NO of S3903), it is not possible to secure a storage area in which to store the selected application. Accordingly, the AM 1205b judges whether or not all the applications denoted in the XAIT information have been selected (S2707), and in the case where all applications denoted in the XAIT information have not been selected (NO of S2707), the AM 1205b selects the next application and continues the storage processing; in the case where all applications denoted in the XAIT information have been selected (YES of S2707), the storage processing ends.

On the other hand, in the case where the stored application determination unit 2602 has determined that the already stored application is not to be deleted from the storage area 2201 (NO of S2804), it is not possible to secure a storage area in which to store the selected application. Accordingly, as mentioned above, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

On the other hand, in the case where there is not an already stored application (NO of S2801), or in other words, in the case where space in storage area 2201 is insufficient when an application denoted in the XAIT information is stored into the storage area 2201 from the MPEG-2 transport stream but there is not an already stored application, it is not possible to secure a storage area in which to store the selected application. Accordingly, as mentioned above, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

Note that in the case where space in storage area 2201 is insufficient when an application denoted in the XAIT information is stored into the storage area 2201 from the MPEG-2 transport stream but there is not an already stored application, it is not possible to secure a storage area in which to store the selected application. Therefore, the storage processing may finish without the AM 1205b storing the selected application.

Here, in the case where an already-stored application is not denoted in the XAIT information, the storage priority comparison unit 2601 considers the storage priority of the application to be a minimum value. In such a case, a method may be used in which the stored application determination unit 2602 unconditionally determines to delete that application from the storage area 2201.

In addition, here, not deleting the application for which the user has rejected deletion from the storage area 2201 is realized by the stored application determination unit 2602 changing the determined set of the application to be deleted from the storage area 2201 and the application to store, when the answer acceptance unit 3501 receives the notification rejection information of a user. However, not deleting the application for which the user has rejected deletion from the storage area 2201 may also be realized by the AM 1205b updating the XAIT information and changing the storage priority of the application. For example, a method may be used in which the storage priority of the application for which the user has rejected deletion is re-set to a maximum value.

In such a manner, in the third embodiment, the user can reject deleting an application from the storage area 2201 upon receiving confirmation that the application is to be deleted from the storage area 2201. In addition, not deleting the application for which deletion has been rejected from the storage area 2201 can be realized.

### Fourth Embodiment

In the present embodiment, when an AM 1205b receives XAIT information sent from a head end 101, prior to storing that XAIT information, and prior to performing processing in accordance with the XAIT information, such as application storage processing, an instruction to start an application, and the like, an API that provides a right to determine whether or not it is acceptable to receive that XAIT, or in other words, whether or not it is acceptable to perform the processing in accordance with that XAIT information, is further provided to an application having a special privilege. Furthermore, in the present embodiment, an API which changes a storage priority denoted in the XAIT information is provided to the application having the special privilege.

Here, the API that provides the right to determine whether or not it is acceptable to receive the XAIT information when that XAIT information is sent from the head end 101 is realized by publicly-known technology. The API that provides the right to determine whether or not it is acceptable to receive the XAIT information when that XAIT information is sent from the head end 101 and which is provided to the application having a special privilege is defined as an org.ocap.application.AppManagerProxy class setAppSignalHandler method, in an AnnexGOCAP 1.0 Application API of the OCAP specifications (OCAP 1.0 Profile OC-SP-OCAP 1.0-IF-I09-031121).

An API that updates the XAIT information, as described in the first embodiment, an API that changes the storage priority denoted in the XAIT information, and the API that provides the right to determine whether or not it is acceptable to receive the XAIT information when that XAIT information is sent from the head end 101 are hereafter called an update API, a change API, and a determination API respectively, when differentiating between the APIs. The application having a special privilege, to which these APIs are provided, is called a monitor application.

In the present embodiment, the API that changes the storage priority denoted in the XAIT information is an API that makes it possible for the monitor application to change the storage priority of an application denoted in the XAIT information sent from the head end 101.

In the present embodiment, in the case where the AM 1205b has received a request from the monitor application to provide, using the determination API, the right to determine whether or not it is acceptable to receive the XAIT information, the AM 1205b leaves the determination of whether or not it is acceptable to receive the XAIT information to the monitor application, at the time of receiving the XAIT information sent from the head end 101.

In the case of allowing the receipt of the XAIT information, the monitor application receives the XAIT information sent from the head end 101, or, in the case where the change API is used, receives the changed XAIT information. Then, the AM 1205b receives the XAIT information and performs processing for storing the application denoted in the XAIT information, through one of the methods described in the first and second embodiments. Note that here, the processing described in the third embodiment may be used to more stringently guard against overlapping storage priorities, rather than leaving this solely to the judgment of the monitor application. On the other hand, in the case where receipt of the XAIT information has been rejected, the monitor application ignores that XAIT information sent from the head end 101.

Moreover, in the case where the AM 1205b has not received, from the monitor application, the request to provide the right to determine whether or not it is acceptable to receive the XAIT information, the AM 1205b receives the XAIT information and carries out processing for storing the application denoted in the XAIT information, through one of the methods described in the first or second embodiment. Note that the processing described in the third embodiment may be used to more stringently guard against overlapping storage priorities, rather than leaving this solely to the judgment of the monitor application.

In addition, in the case where the receipt of the XAIT information is caused by an update of the XAIT information performed by the monitor application through use of the update API, a change of the XAIT information performed by the monitor application through use of the change API, and the like, the AM 1205b receives the XAIT information and performs processing for storing the application described in that XAIT information through one of the methods described in the first or second embodiment, without leaving the determination of whether or not it is acceptable to receive that XAIT information to the monitor application.

Note that the processing described in the third embodiment may be used to more stringently guard against overlapping storage priorities, rather than leaving this solely to the judgment of the monitor application.

In the present embodiment, at the time of receipt of the XAIT information sent from the head end 101 using the determination API, the monitor application performs a request to the AM 1205b that the determination of whether or not it is acceptable to receive the XAIT information be left to the monitor application itself.

When the determination of whether or not it is acceptable to receive the XAIT information is left to the monitor application be the AM 1205b, operations identical to those performed by the AM 1205b in the first and second embodiments are performed. In other words, the monitor application determines preferential storage of applications with a high storage priority from among the application denoted in the XAIT information and already-stored applications, and determines deletion of applications from the storage area 2201 in order starting with applications with a low storage priority. Here, the monitor application has a means for comparing storage priorities, a means for acquiring space remaining in the storage area, and a means for acquiring a size of the already-stored applications and the application denoted in the XAIT information.

In the case of determining that the already-stored application is to be deleted from the storage area 2201, the monitor application displays an application deletion notification to the user. Here, the application deletion notification provided to the user by the monitor application is realized with a method identical to that in which the notification unit 2605 provides the application deletion notification to the user in the third embodiment. The monitor application sends the deletion notification information to be shown on the screen to the CPU 514 of the terminal apparatus 500, and the dialog display program included in the library 1201b of the OS 1201 is realized by the deletion notification, as shown in FIG. 40, being displayed in the display 509. A dialog box 3001 has display elements of a message 4001, a Yes button 4002, and a No button 4003. Note that the character string of the message 4001 may be a character string aside from the character string shown in FIG. 40 as long as it provides information necessary for notifying deletion of the application to the user; the message 4001 may be of a format aside from a character string. In addition, the character strings of the Yes button 4002 and the No button 4003 are not limited to the character strings shown in FIG. 40, and may be different character strings. Moreover, the display elements of the dialog box 3001 are not limited to the display elements shown in FIG. 40; they may be other display elements as long as the user can be notified of the deletion of the application and the CPU 514 can confirm that the user has selected allowance or rejection in response to the deletion notification.

The monitor application accepts, from the CPU 514, the selection information indicated by the user when allowing or rejecting deletion of the application through selection of the Yes button 4002 or the No button 4003. Then, upon receiving the selection information from the CPU, the monitor application judges whether that selection information indicates allowance of the deletion of the application or rejection of the deletion of the application. Then, in the case where the selection information indicates allowance of deletion of the application, the monitor application allows the AM 1205b to receive the XAIT information. On the other hand, in the case where the selection information indicates rejection of deletion of the application, the monitor application uses the change API and changes the storage priority of the application for which the user has rejected deletion to a maximum value, and thus not deleting the application for which the user has rejected deletion from the storage area 2201 is realized. Note that not deleting the application for which the user has rejected deletion from the storage area 2201 may also be realized by the monitor application not allowing the AM 1205b to receive the XAIT information.

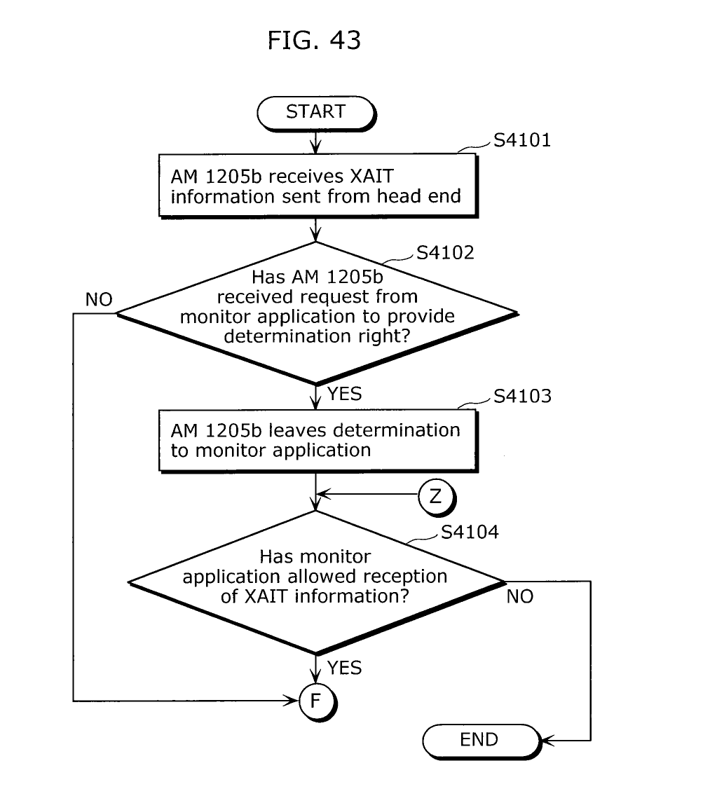

FIG. 43 is a flowchart showing an operation for handling of the XAIT information by the AM 1205b, which has received the XAIT information from the head end 1205b, in the present embodiment.

As shown in FIG. 43, upon receiving the XAIT information from the head end 101 (S4101), the AM 1205b judges whether or not it has received, from the monitor application, the request to provide the right, which uses the determination API, to determine whether or not it is acceptable to receive the XAIT (S4102). In the case of receiving the request to provide the right to determine whether or not it is acceptable to receive the XAIT from the monitor application, the AM 1205b leaves the determination of whether or not it is acceptable to receive the XAIT to the monitor application (S4103).

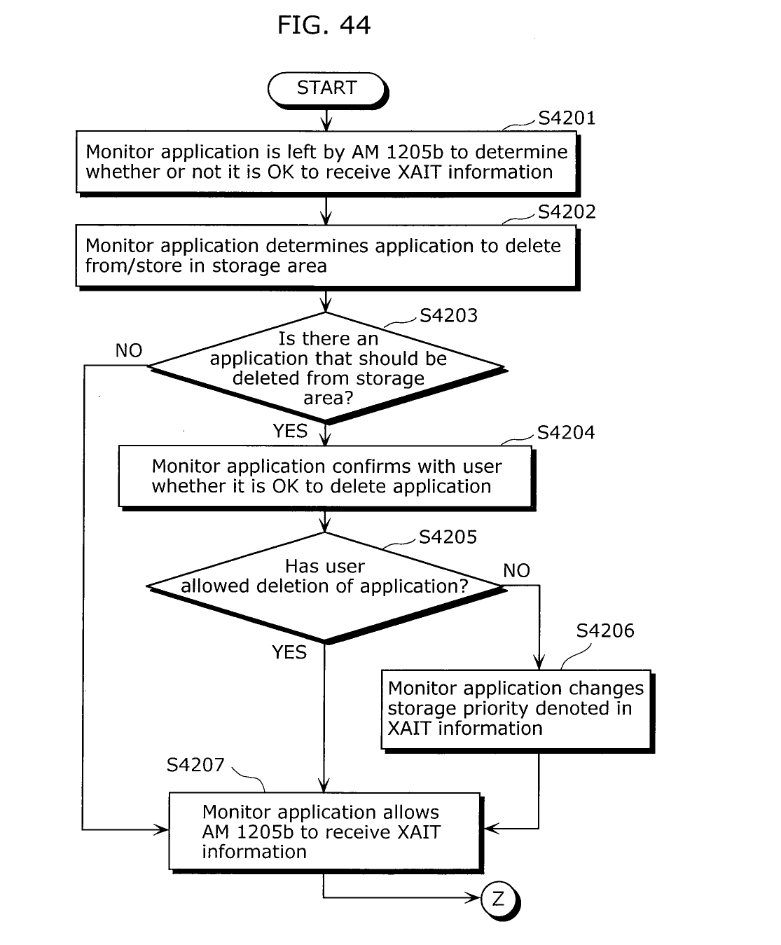

FIG. 44 is a flowchart showing an example of an operation of the monitor application in the present embodiment. Specifically, in this example of the operation, the monitor application is assumed as requesting the AM 1205b to provide the right to determine, using the determination API, whether or not it is acceptable to receive the XAIT information.

As shown in FIG. 44, the monitor application, which has been left, by the AM 1205b, to determine whether or not it is acceptable to receive the XAIT information (S4201), determines a set of the applications to be stored in the storage area 2201, and a set of the applications to be deleted from the storage area 2201, from among the applications described in that XAIT information and the already-stored applications (S4202). Here, determining the set of the applications to be stored in the storage area 2201 and the set of the applications to be deleted from the storage area 2201 is realized by, for example, determining to preferentially store applications with a high storage priority, and determining to preferentially delete applications from the storage area 2201 in order, starting with applications with a low storage priority. Note that the monitor application may also determine these application sets through a different method. Continuing on, the monitor application judges whether or not the monitor application has determined the already-stored applications to be deleted from the storage area 2201 (S4203). In the case where the monitor application has determined to delete the already-stored application from the storage area 2201 (YES of S4203), the monitor application displays an application deletion notification to the user (S4204). Then, the monitor application determines whether or not the user has allowed deletion of the application (S4205), and in the case where the user has allowed deletion of the application (YES of S4205), the monitor application allows the AM 1205b to receive the XAIT information sent from the head end 101 (S4207). On the other hand, in the case where the user has rejected deletion of the application from the storage area (NO of S4205), the monitor application, for example, uses the change API and re-sets the storage priority of the application, the deletion of which the user has rejected, to a maximum value. In such a manner, the monitor application changes the storage priority within the XAIT information so that the application which the user has rejected deletion of is not deleted from the storage area 2201 (S4206) and allows the AM 1205b to receive the changed XAIT information (S4207).

Next, as shown in FIG. 43, the AM 1205b judges whether or not the monitor application has allowed receipt of the XAIT information (S4104). In the case where the AM 1205b has not been allowed by the monitor application to receive the XAIT information (NO of S4104), AM 1205b finishes the storage processing. On the other hand, in the case where the AM 1205b has been allowed by the monitor application to receive the XAIT information (YES of S4104), the AM 1205b receives the XAIT information from the head end 101, as shown in FIG. 29, or, in the case where the monitor application has used the change API, receives the changed XAIT information (S2701). Then, the AM 1205b selects, from among the applications denoted in the XAIT information, one application that has not yet been selected, in order from applications with a high storage priority down. However, here, in storage processing carried out in accordance with the received XAIT information, the storage deletion unit 2604 selects one application aside from the applications deleted from the storage area 2201 (S2702). Then, the AM 1205b judges whether or not the selected application has been stored (S2703).

In the case where the selected application is stored (YES of S2703), the AM 1205b judges whether or not all the applications denoted in the XAIT information have been selected (S2707), and in the case where all applications denoted in the XAIT information have not yet been selected, the AM 1205b selects the next application and continues the storage processing; in the case where all applications denoted in the XAIT information have been selected, the storage processing ends.

On the other hand, in the case where the selected application has not been stored (NO of S2703), the stored application determination unit 2602 acquires the space remaining in the storage area from the storage area remaining space acquisition unit 2606, and acquires the application size from the application size acquisition unit 2607 (S2704). Then, based on the space remaining in the storage area acquired from the storage area remaining space acquisition unit 2606 and the application size acquired from the application size acquisition unit 2607, the stored application determination unit 2602 determines whether or not the space remaining in the storage area is larger than the selected application (S2705).

In the case where the space remaining in the storage area is judged to be larger than the selected application (YES of S2705), the storage unit 2603 stores the selected application (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

On the other hand, in the case where the space remaining in the storage area is judged to be smaller than the selected application (NO of S2705) the AM 1205b judges whether or not there is an application which is already stored, as shown in FIG. 30 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Then, based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is still not large enough for the selected application even after those applications which are already stored are deleted from the storage area, those applications which are already stored are not deleted from the storage area, and the selected application is not stored. Continuing on, the stored application determination unit 2602 judges whether or not the stored application determination unit 2602 has determined the already-stored applications to be deleted from the storage area 2201 (S2804).

In the case where the stored application determination unit 2602 judges that the already-stored applications have been determined to be deleted from the storage area 2201 (YES of S2804), the stored application determination unit 2602 instructs the notification unit 2605 to perform a deletion notification, the storage deletion unit 2604 to delete the application from the storage area 2201, and the storage unit 2603 to store another application. Then, in accordance with a result of the determination performed by the stored application determination unit 2602, the notification unit 2605 notifies the user that the application is deleted (S2805). Then, in accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

On the other hand, in the case where the stored application determination unit 2602 has determined that the already stored application is not to be deleted from the storage area 2201 (NO of S2804), it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

On the other hand, in the case where there is not an already stored application (NO of S2801), or in other words, in the case where space in storage area 2201 is insufficient when an application denoted in the XAIT information is stored into the storage area 2201 from the MPEG-2 transport stream but there is not an already stored application, it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing finishes.

Note that in the case where space in storage area 2201 is insufficient when an application denoted in the XAIT information is stored into the storage area 2201 from the MPEG-2 transport stream but there is not an already stored application, it is not possible to secure a storage area in which to store the selected application. Therefore, the AM 1205b may finish the storage processing without storing the selected application.

Here, in the case where an already-stored application is not denoted in the XAIT information, the storage priority comparison unit 2601 considers the storage priority of the application to be a minimum value. However, a method may be used in which the stored application determination unit 2602 unconditionally determines to delete that application from the storage area 2201.

In such a manner, in the fourth embodiment, it is possible to obtain an effect identical to that of the third embodiment through the monitor application providing the user with a deletion notification, and changing the storage priority. In other words, upon receiving confirmation that an application is to be deleted from the storage area 2201, the user can reject deleting the application from the storage area 2201, and the application which the user has rejected deletion of is not deleted from the storage unit 2201.

### Fifth Embodiment

In the first through third embodiments, when determining a set of an application to store and an application to delete from a storage area 2201, an AM 1205b, through a stored application determination unit 2602, preferentially stores applications with a high storage priority and determines to delete applications from the storage area 2201 in order starting with applications with a low storage priority, based on result of comparison performed by a storage priority comparison unit 2601. However, in the case where plural applications have the same storage priority, it is possible that the AM 1205b cannot determine which application to delete form the storage area 2201 and which application to store.

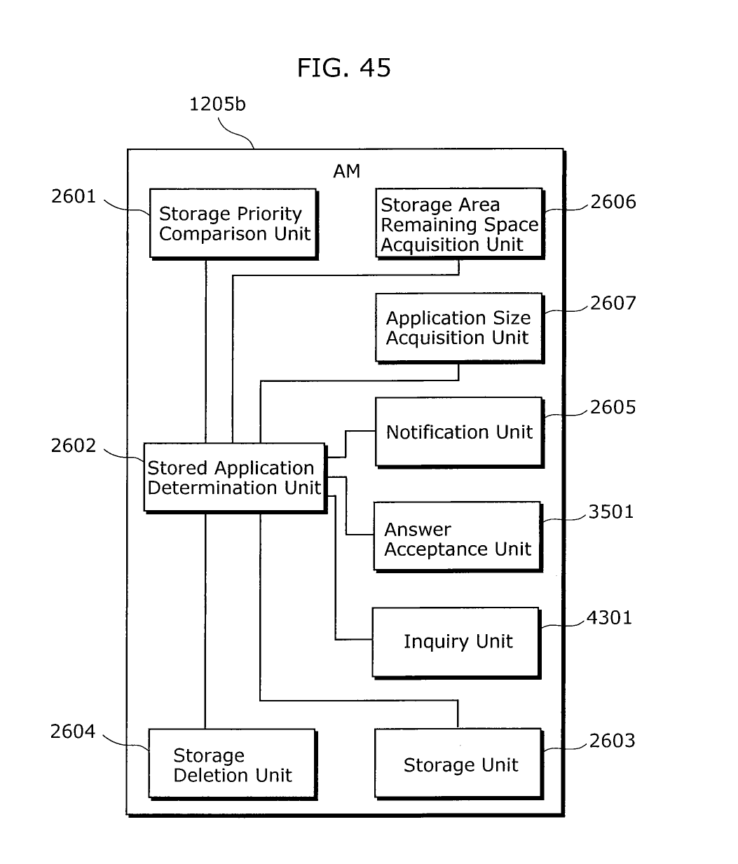

Therefore, in the present embodiment, as shown in FIG. 45, the AM 1205b includes an inquiry unit 4301 for inquiring with the user in the case where the stored application determination unit 2602 cannot determine a set of applications to store or delete.

FIG. 45 is a structural diagram which shows a configuration of the AM 1205b in the present embodiment.

Upon receiving an inquiry instruction from the stored application determination unit 2602, the inquiry unit 4301 inquires, with the user, which application to store in or delete from the storage area 2201. Here, the inquiry with the user performed by the inquiry unit 4301 is realized by the inquiry unit 4301 sending, to the CPU 514 of the terminal apparatus 500, deletion notification information of a screen to be displayed, and a dialog display program included in the library 1201b of the OS 1201 displaying an inquiry dialog in the display 509.

Then, the inquiry unit 4301 receives, from the CPU 514, selection information from the user when the user selects the application to delete or store, and upon receiving the selection information from the CPU 514, notifies the stored application determination unit 2602 of a result of the application selection, based on the selection information.

Furthermore, in the present embodiment, the stored application determination unit 2602 attempts to determine, through the same method as mentioned in the first through third embodiments, a set which includes an application to be stored in the storage area 2201 and an application to be deleted from the storage area 2201. Here, in the case where the set of the applications to store in or delete from the storage area 2201 have been determined, storage processing continues in the same manner as in the first to third embodiments. However, in the present embodiment, because plural applications with the same storage priority are present, the stored application determination unit 2602 provides an inquiry instruction to the inquiry unit 4301 in the case where the stored application determination unit 2602 cannot determine to delete or store the application from or in the storage area 2201. Then, upon receiving a notification of an application selection result from the inquiry unit 4301, the stored application determination unit 2602 determines the application to be stored in or deleted from the storage area 2201, in accordance with the application selection result. After the determination, the stored application determination unit 2602 provides, in the same manner as in any of the first through third embodiments, a notification instruction to the notification unit 2605, an application deletion instruction to the storage unit 2603, and an application storage instruction to the storage unit 2604.

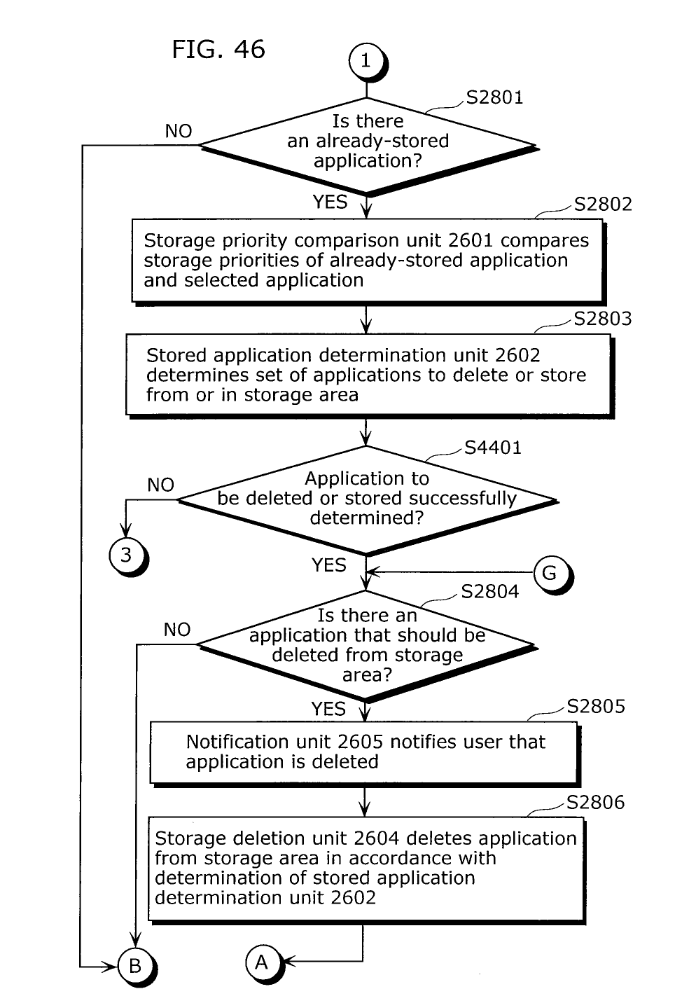

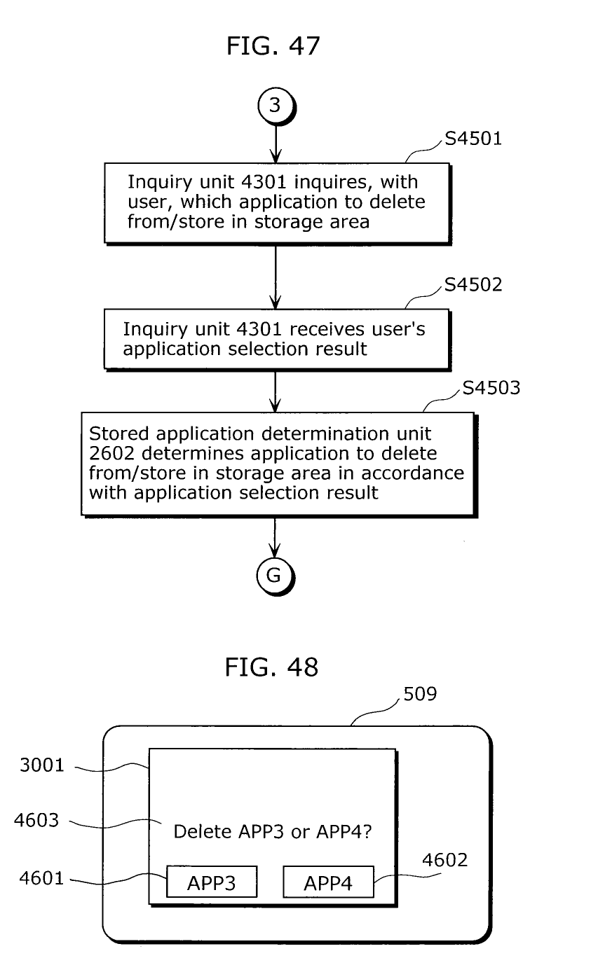

FIGS. 46 and 47 are flowcharts showing an example of a characteristic application storage processing operation carried out by the AM 1205b that has received the XAIT information, in the present embodiment. FIGS. 46 and 47 show a processing occurring after step S2705 shown in FIG. 29, and in particular, show an example of a storage processing operation carried out by the AM 1205b in the case where the space in the storage area 2201 is insufficient when storing the application denoted in the XAIT information from the MPEG-2 transport stream into the storage area 2201.

In FIG. 46, steps identical to those in FIG. 30 are given the same numbers as in FIG. 30.

As shown in FIG. 29, upon receiving the XAIT information (S2701), the AM 1205b selects, from among the applications denoted in the XAIT information, one application that has not yet been selected, in order from applications with a high storage priority down. However, here, in storage processing carried out in accordance with the received XAIT information, the storage deletion unit 2604 selects one application aside from the applications already deleted from the storage area 2201 (S2702). Then, the AM 1205b judges whether or not the selected application has been stored (S2703).

In the case where the selected application is stored (YES of S2703), the AM 1205b judges whether or not all the applications denoted in the XAIT information have been selected (S2707). Here, in the case where all the applications denoted in the XAIT information have not been selected (NO of S2707), the AM 1205b selects the next application, and the storage processing continues. Here, in the case where all the applications denoted in the XAIT information have been selected (YES of S2707), the AM 1205b finishes the storage processing.

On the other hand, in the case where the selected application has not been stored (NO of S2703), the stored application determination unit 2602 acquires the space remaining in the storage area from the storage area remaining space acquisition unit 2606, and acquires the application size from the application size acquisition unit 2607 (S2704). Then, based on the space remaining in the storage area acquired from the storage area remaining space acquisition unit 2606 and the application size acquired from the application size acquisition unit 2607, the stored application determination unit 2602 determines whether or not the space remaining in the storage area is larger than the selected application (S2705).

In the case where the space remaining in the storage area is judged to be larger than the selected application (YES of S2705), the storage unit 2603 stores the selected application (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing finishes.

On the other hand, in the case where the space remaining in the storage area is judged to be smaller than the selected application (NO of S2705) the AM 1205b judges whether or not there is an application which is already stored, as shown in FIG. 46 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is still not large enough for the selected application even after those applications which are already stored are deleted from the storage area, the stored application determination unit 2602 determines not to delete those applications which are already stored from the storage area, and not to store the selected application.

Continuing on, the stored application determination unit 2602 judges whether the application to delete from or store in the storage area 2201 could be determined (S4401). Here, because plural applications with the same storage priority are present, in the case where the application to delete from or store in the storage area 2201 cannot be determined (S4401), the inquiry unit 4301 inquires, with the user, which application to delete from or store in the storage area 2201, as shown in FIG. 47 (S4501). Here, the inquiry provided to the user by the inquiry unit 4301 is realized by the inquiry unit sending deletion notification information to be shown on the screen to the CPU 514 of terminal apparatus 500, and the dialog display program included in the library 1201b of the OS 1201 displaying the inquiry dialog, as shown in FIGS. 48 to 50, in the display 509.

FIGS. 48 to 50 are diagrams showing examples of a deletion notification displayed in the display 509 in the present embodiment.

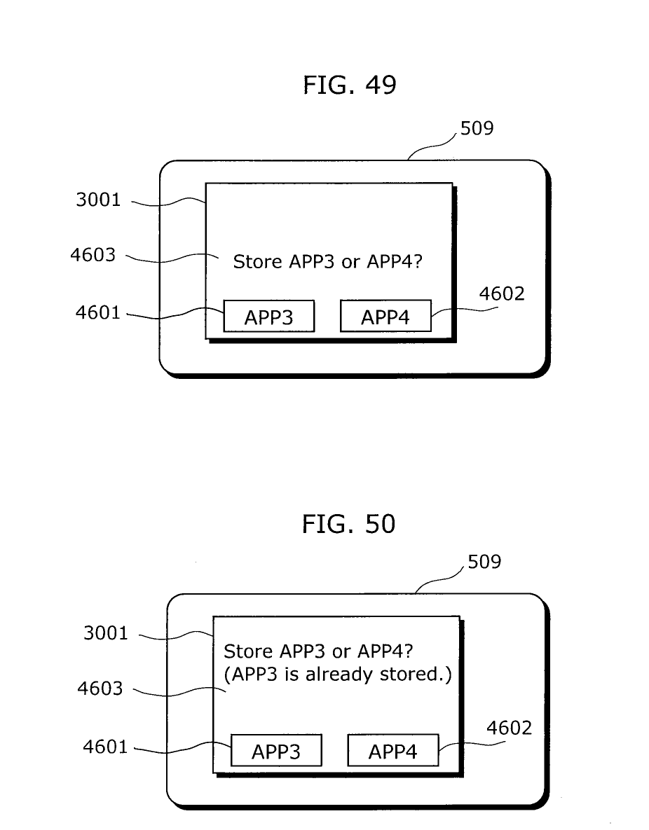

The dialog box 3001 has display elements of a message 4603 and application selection buttons 4601 and 4602. FIG. 48 is an example of display for inquiring with the user which application should be deleted from the storage area 2201, in the case where the storage priorities of two already-stored applications are the same and thus the stored application determination unit 2602 cannot determine the set of applications to delete from the storage area 2201. In other words, at this time, the stored application determination unit 2602 judges that two applications with identical storage priorities cannot both be stored. FIG. 49 is an example of display for inquiring with the user which application should be stored in the storage area 2201, in the case where the storage priorities of two applications that have not yet been stored are the same and thus the stored application determination unit 2602 cannot determine the set of applications to store in the storage area 2201. In other words, at this time, the stored application determination unit 2602 judges that two applications with identical storage priorities cannot both be stored. FIG. 50 is an example of display for inquiring with the user which application should be stored in the storage area 2201, in the case where the storage priorities of an already-stored application and an application that has not yet been stored are the same and thus the stored application determination unit 2602 cannot determine the set of applications to store in the storage area 2201. Here, in FIGS. 48 to 50, “APP3” and “APP4”, which are written in the message 4603 and the application selection buttons 4601 and 4602, are the respective application names of the applications. Note that instead of using application names, another method may be used as long as it can provide information necessary for the user to select the application.

Note that the character string of the message 4603 may be a character string aside from the character string shown in FIGS. 48 to 50, as long as it provides information necessary for the user to select the application; the message 4603 may be of a format aside from a character string. In addition, the character strings in the application selection buttons 4601 and 4602 may be character strings aside from the character strings shown in FIGS. 48 to 50. Furthermore, the display elements in the dialog box 3001 are not limited to the display elements shown in FIGS. 48 to 50; another display element, such as a list box and the like, may be used as long as it can provide the information necessary for the user to select the application and allow the CPU 514 to confirm that the user has selected the application.

Continuing on, when the user selects the application selection button 4601 or 4602, the CPU 514 sends the user's selection information to the inquiry unit 4301 of the AM 1205b. Upon receiving the selection information (S4502), the inquiry unit 4301 notifies the stored application determination unit 2602 of the application selection result, based on the selection information. Here, notification of the application selection result by the inquiry unit 4301 is realized by, for example, the inquiry unit 4301 notifying the stored application determination unit of a result that the user has selected deletion of the application with the application name “APP3”, in the case where the selection information received by the CPU 514 indicates that the button 4601 has been selected, when considering the example of the dialog display shown in FIG. 48.

Then, upon receiving the notification of the application selection result from the inquiry unit 4301, the stored application determination unit 2602 determines to delete or store the application from or in the storage area 2201, in accordance with the application selection result acquired from the inquiry unit 4301 (S4503).

Next, as shown in FIG. 46, the stored application determination unit 2602 judges whether or not the stored application determination unit 2602 has determined the already-stored applications to be deleted from the storage area 2201 (S2804).

In the case where the stored application determination unit 2602 judges that the already-stored applications have been determined to be deleted from the storage area 2201, the stored application determination unit 2602 instructs the notification unit 2605 to perform a deletion notification. Then, in accordance with a result of the determination performed by the stored application determination unit 2602, the notification unit 2605 notifies the user that the application is deleted (S2805). In addition, in accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application, as shown in FIG. 29 (S2706).

Note that processing from step S2804 shown in the above FIG. 46 may be carried out as the processing from step S2804 in FIG. 39. In other words, in the case where the stored application determination unit 2602 judges that the already-stored applications have been determined to be deleted from the storage area 2201, the stored application determination unit 2602 instructs the notification unit 2605 to perform a deletion notification. Then, in accordance with a result of the determination performed by the stored application determination unit 2602, the notification unit 2605 notifies the user that the application is deleted (S2805). Here, the application deletion notification provided to the user by notification unit 2605 is realized by the notification unit 2605 sending deletion notification information to be shown on the screen to the CPU 514 of terminal apparatus 500, and the dialog display program included in the library 1201b of the OS 1201 displaying the deletion notification, as shown in FIG. 38, in a display 509. A dialog box 3001 has display elements of a message 3002 and an OK button 3701. When the user selects the OK button 3701 by operating the remote control, the CPU 514 sends the notification confirmation information from the user to the answer acceptance unit 3501 of the AM 1205b. Upon receipt of the notification confirmation information of the user (S3602), the answer acceptance unit 3501 notifies the stored application determination unit 2602 of the notification confirmation information. Upon receipt of the notification of the notification confirmation information from the answer acceptance unit 3501, the stored application determination unit 2602 instructs the storage deletion unit 2604 to delete the application from the storage area 2201, and instructs the storage unit 2603 to store the other application. Then, in accordance with the result of the determination performed by the stored application determination unit 2602, the storage deletion unit 2604 deletes the application from the storage area 2201 (S2806); in accordance with the result of the determination performed by the stored application determination unit 2602, the storage unit 2603 stores the application, as shown in FIG. 29 (S2706). Then, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing finishes.

On the other hand, as shown in FIG. 46, in the case where the stored application determination unit 2602 has determined that the already stored application is not to be deleted from the storage area 2201 (NO of S2804), it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the storage processing finishes.

On the other hand, as shown in FIG. 46, in the case where there is not an already stored application (NO of S2801), or in other words, in the case where space in storage area 2201 is insufficient when an application denoted in the XAIT information is stored into the storage area 2201 from the MPEG-2 transport stream but there is not an already stored application, it is not possible to secure a storage area in which to store the selected application. Accordingly, the AM 1205b judges whether or not all the applications denoted in the XAIT information have been selected (S2707), and in the case where all applications denoted in the XAIT information have not been selected, the AM 1205b selects the next application and continues the storage processing; in the case where all applications denoted in the XAIT information have been selected, the AM 1205b finishes the storage processing.

Note that in the case where space in storage area 2201 is insufficient when an application denoted in the XAIT information is stored into the storage area 2201 from the MPEG-2 transport stream but there is not an already-stored application, it is not possible to secure a storage area in which to store the selected application; in such a case, the AM 1205b may end the storage processing without storing the selected application.

Here, in the case where an application which is already stored is not denoted in the XAIT information, the storage priority comparison unit 260 considers the storage priority of that application to be a minimum, but in the present case, a method may be used in which the stored application determination unit 2602 unconditionally determines to delete that application from the storage area 2201.

Note that in the present embodiment, while the case discussed is one in which the stored application determination unit 2602 cannot determine the application to delete from or store in the storage area 2201 because the storage priority of two applications is the same, the present invention can also be implemented in the case where the stored application determination unit 2602 cannot determine the application to delete from or store in the storage area 2201 because the storage priority of three or more applications is the same. For example, in the case where the stored application determination unit 2602 cannot determine the set of the applications to delete from the storage area 2201 because the storage priorities of three already-stored applications are the same, the inquiry provided to the user by the inquiry unit 4301 is realized by the dialog display program displaying a dialog that allows the user to select, from among the three applications, one or two applications to be deleted form the storage area 2201.

Furthermore, there are cases where the stored application determination unit 2602 cannot determine the application to delete from or store in the storage area 2201 through the notification of the application deletion result from the inquiry unit 4301 arising from a single inquiry instruction provided to the inquiry unit 4301. For example, there is the case where it is not possible to secure a storage area that can store a selected new application only by deleting one application from the storage area 2201 when there are three or more applications with the same storage priorities. In such a case, the stored application determination unit 2602 may provide the inquiry instruction to the inquiry unit 4301 after the first notification of the application selection result from the inquiry unit 4301. At this time, for example, the first inquiry provided to the user by the inquiry unit 4301 is realized by the dialog display program displaying a dialog that allows the user to select, from among the three applications, the application that should be deleted from the storage area 2201, and the second inquiry provided to the user by the inquiry unit 4301 is realized by the dialog display program displaying a dialog that allows the user to select, from among the two applications, the application that should be deleted from the storage area 2201,

In this manner, in the fifth embodiment, in the case where the storage priorities of plural applications denoted in the XAIT information are the same, it is possible to determine which application to delete from the storage area 2201, and which application to store, by inquiring with the user. Furthermore, by giving the user the selection right, it is possible to realize storage of an application more desirable to the user.

### Sixth Embodiment

In the present embodiment, when an application to be deleted is running, an AM 1205b performs a notification that provides a message regarding how the application is to be treated. In other words, in the OCAP specifications (OCAP 1.0 Profile OC-SP-OCAP 1.0-IF-I09-031121), it is prescribed that an application with a high storage priority is preferentially stored, and operations of a currently running application must not be interfered with; thus, in the present embodiment, the notification provides a message regarding the treatment of the application to be deleted while ensuring conformity with the abovementioned prescription.

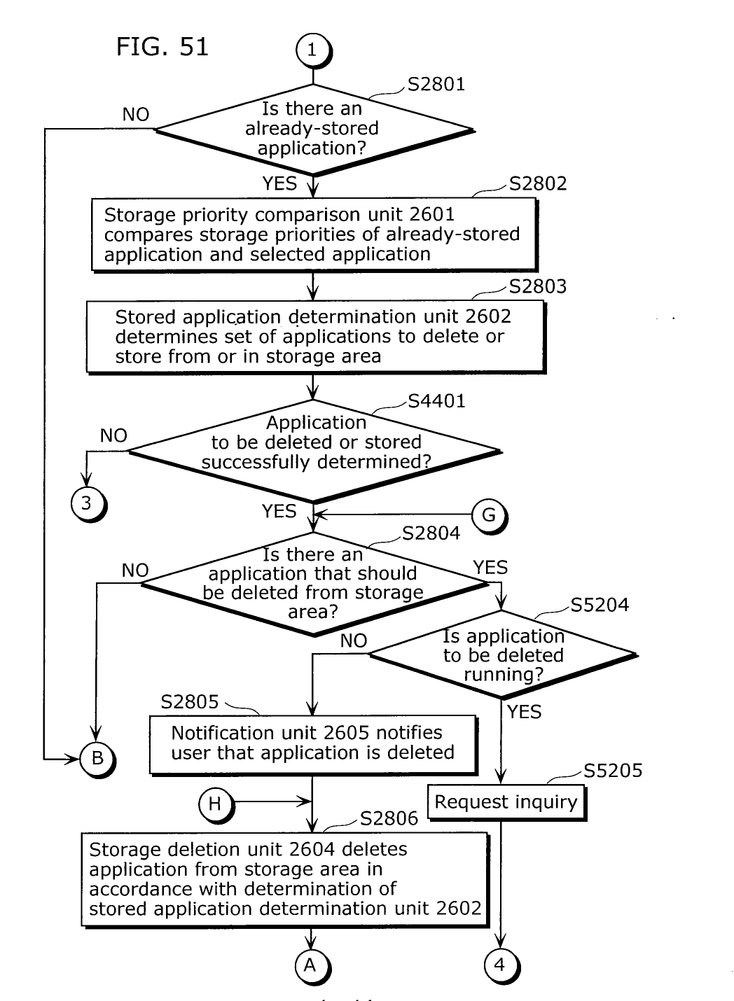

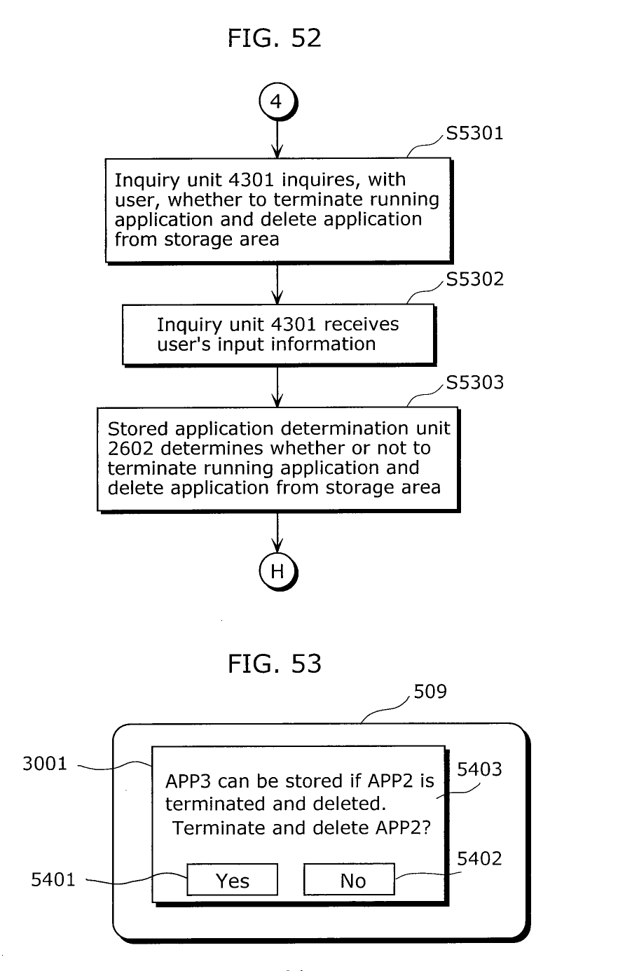

FIGS. 51 and 52 are flowcharts showing an example of a characteristic application storage processing operation carried out by the AM 1205b that has received the XAIT information, in the present embodiment. FIGS. 51 and 52 indicate processing following step S2705 shown in FIG. 29. In addition, FIGS. 51 and 52 show, in particular, an example of a storage processing operation carried out by the AM 1205b in the case where the space in the storage area 2201 is insufficient and the application stored in the storage area that is to be deleted is currently running, when storing the application denoted in the XAIT information from the MPEG-2 transport stream into the storage area 2201.

In FIG. 51, steps identical to those in FIG. 30 are given the same numbers as in FIG. 30.

In the case where the space remaining in the storage area is judged to be smaller than the selected application (S2705 in FIG. 29) the AM 1205b judges whether or not there is an application which is already stored, as shown in FIG. 51 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is smaller than the selected application even after those applications which are already stored are deleted from the storage area, the stored application determination unit 2602 determines not to delete those applications which are already stored from the storage area, and not to store the selected application.

Continuing on, the stored application determination unit 2602 judges whether or not the application to delete from or store in the storage area 2201 was successfully determined (S4401). Here, because plural applications with the same storage priority are present, in the case where the application to delete from or store in the storage area 2201 cannot be determined (NO of S4401), the AM 1205b follows the processing previously described in FIG. 47.

Next, the stored application determination unit 2602 judges whether or not the stored application determination unit 2602 has determined the already-stored applications to be deleted from the storage area 2201 (S2804).

In step S2804, in the case of determination not to delete (NO of S2804), the AM 1205b carries out the processing from step S2707 of FIG. 29.

In step S2804, in the case of determination to delete (YES of S2804), the stored application determination unit 2602 examines whether or not the application which should be deleted is running (S5204). Here, in the case where the application which should be deleted is not running (NO of S5204), the AM 1205b carries out processing identical to the processing from step S2805, as described in FIG. 46. On the other hand, when the application which should be deleted is running (YES of S5204), the application with a high storage priority can be stored if the running application is terminated and deleted; therefore, the notification unit 2605 requests the inquiry unit 4301 to inquire, with the user, whether to terminate and delete the application that should be deleted (S5205).

As shown in FIG. 52, the inquiry unit 4301 inquires with the user whether or not to delete the running application form the storage area 2201 (S5301). Here, the inquiry provided to the user by the inquiry unit 4301 is realized by the inquiry sending deletion notification information to be shown on the screen to the CPU 514 of terminal apparatus 500, and the dialog display program included in the library 1201b of the OS 1201 displaying the inquiry dialog, as shown in FIGS. 53, in the display 509.

FIG. 53 is a diagram showing an example of an inquiry dialog displayed in the display 509 in the present embodiment. A dialog box 3001 has display elements of a message 3001 and application selection buttons 5401 and 5402. Specifically, FIG. 53 shows an example of a display that inquires, with the user, whether or not to terminate and delete the application the be deleted, when it is possible to store the application with a high storage priority if the running application is terminated and deleted.

Note that in FIG. 53, the character string of the message 5403 may be a character string having a different expression, as long as it provides information necessary for the user to delete an application that is running; the message 5403 may also be of a format aside from a character string. In addition, the character strings of the application selection button 5401 and 5402 may be different character strings as long as they have the same meaning as the character strings in FIG. 53. Furthermore, the display elements in the dialog box 3001 are not limited to the display elements shown in FIG. 53; another display element, such as a list box and the like, may be used as long as it can provide the information necessary for the user to select the application and allow the CPU 514 to confirm that the user has selected the application.

Continuing on, when the user selects the application selection button 5401 or 5402, the CPU 514 sends input information from the user to the inquiry unit 4301 of the AM 1205b. Upon receiving the input information (S5302), the inquiry unit 4301 notifies the stored application determination unit 2602 of a result of the input, based on the input information. Here, notification of the input result by inquiry unit 4301 is realized by, for example, the inquiry unit notifying the stored application determination unit 2602 of a result in which the user selects termination and deletion of the running already-stored application “APP2” so that the application named “APP3” can be stored, in the case where the input information received from the CPU 514 indicates selection of the button 5401, when the dialog display is as shown in FIG. 53.

Then, upon being informed of the input result from inquiry unit 4301, the stored application determination unit 2602 determines, in accordance with the input result acquired from the inquiry unit 4301, whether or not to delete the application from the storage area 2201 (S5303). After that, the stored application determination unit 2602 carries out processing from step S2806 in FIG. 51.

In this manner, in the present embodiment, even if an application to be deleted is running, an application with a high storage priority is stored, according to the user's preference, after automatically terminating and deleting the running application.

### Seventh Embodiment

Like the sixth embodiment, in the present embodiment, a notification is performed which provides a message regarding treatment of an application to be deleted, while ensuring conformity with prescriptions in the OCAP specifications; that is, a prescription that an application with a high storage priority is preferentially stored, and operations of a currently running application must not be interfered with. Here, in the present embodiment, when an application to be deleted is running, an AM 1205b performs a notification that provides a message regarding how the application is to be treated; however, the details of the message differ from the details described in the sixth embodiment. In addition, operation of the AM 1205b in this embodiment differs from the operation described in the sixth embodiment. Hereafter, the operation of the AM 1205b of this embodiment is described in detail.

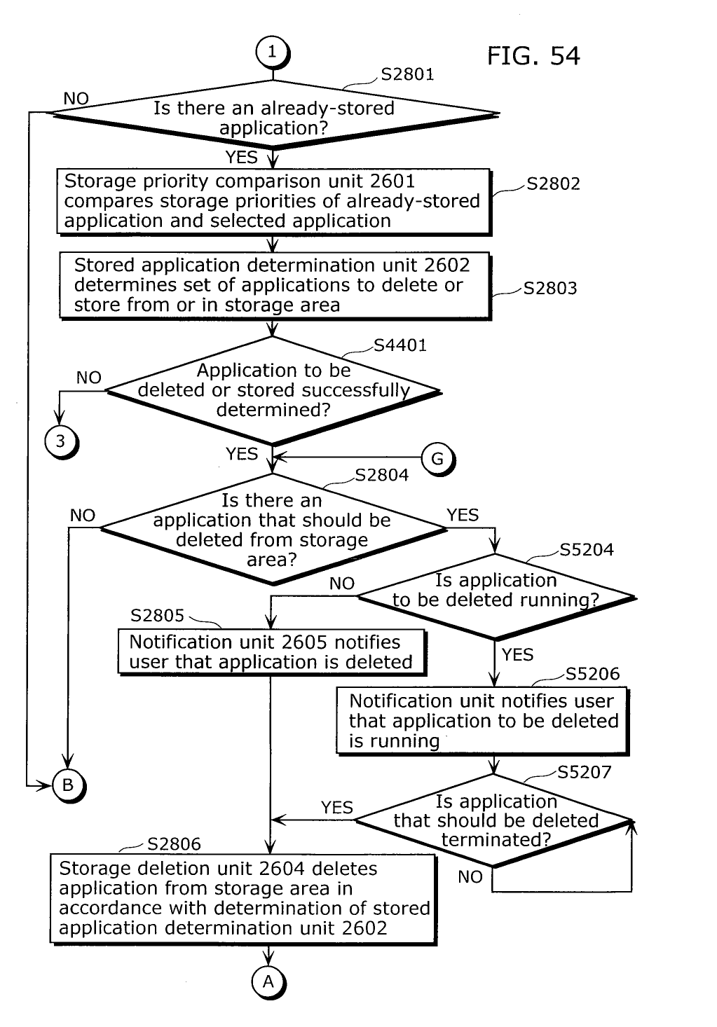

FIG. 54 is a flowchart showing an example of a characteristic application storage processing operation carried out by the AM 1205b that has received the XAIT information, in the present embodiment. FIG. 54 shows processing following step S2705 shown in FIG. 29. In addition, FIG. 54 shows, in particular, an example of a storage processing operation carried out by the AM 1205b in the case where the space in the storage area 2201 is insufficient and the application stored in the storage area that is to be deleted is currently running, when storing the application denoted in the XAIT information from the MPEG-2 transport stream into the storage area 2201.

In FIG. 54, steps identical to those in FIG. 30 and FIG. 51 are given the same numbers as in FIG. 30 and FIG. 51.

In the case where the space remaining in the storage area is judged to be smaller than the selected application (S2705 in FIG. 29) the AM 1205b judges whether or not there is an application which is already stored, as shown in FIG. 54 (S2801).

In the case where there is an application that is already stored (YES of S2801), or in other words, in the case where the capacity of the storage area 2201 is insufficient because there is already a stored application at the time of an application denoted in the XAIT information being stored from the MPEG-2 transport stream, the stored application determination unit 2602 acquires a result of a comparison between the storage priority 2006 specified by the storage priority comparison unit 2601 for the individual applications (S2802). Based on that comparison result, the stored application determination unit 2602 determines a set of the application to be stored and the application to be deleted from the storage area 2201 (S2803). Here, in the case where, among the applications already stored, there is an application with a storage priority lower than the storage priority of the selected application, the stored application determination unit 2602 determines that the already-stored application is to be deleted from the storage area, so that the space remaining in the storage area becomes larger than the size of the selected application, and determines that the selected application is to be stored. However, in the case where the space remaining in the storage area is smaller than the selected application even after those applications which are already stored are deleted from the storage area, the stored application determination unit 2602 determines not to delete those applications which are already stored from the storage area, and not to store the selected application.

Continuing on, the stored application determination unit 2602 judges whether or not the application to delete from or store in the storage area 2201 could be determined (S4401). Here, because plural applications with the same storage priority are present, in the case where the application to delete from or store in the storage area 2201 cannot be determined (NO of S4401), the AM 1205b follows the processing previously described in FIG. 47.

Next, the stored application determination unit 2602 judges whether or not the stored application determination unit 2602 has determined the already-stored applications to be deleted from the storage area 2201 (S2804).

In step S2804, in the case of determination not to delete (NO of S2804), the AM 1205b carries out the processing from step S2707 of FIG. 29.

In step S2804, in the case of determination to delete (YES of S2804), the stored application determination unit 2602 examines whether or not the application which should be deleted is running (S5204). Here, in the case where the application which should be deleted is not running (NO of S5204), the AM 1205b carries out processing identical to the processing from step S2805, as described in FIG. 46. On the other hand, in the case where the application which should be deleted is running (YES of S5204), the notification unit 2605 notifies the user of a message indicating that a new application will be stored after the running application is terminated (S5206).

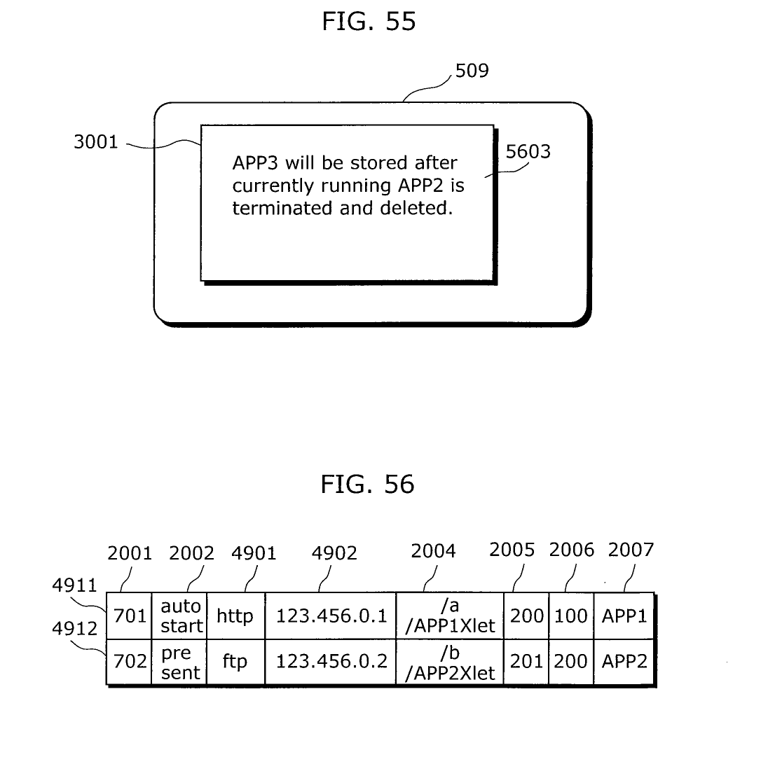

FIG. 55 is a diagram showing an example of a message displayed in the display 509 in the present embodiment. A message 5603 indicates that a new application will be stored after the running application is terminated.

Note that in FIG. 55, a character string of the message 5603 may be a different character string, as long as it provides the indication that that a new application will be stored after the running application is terminated.

Next, after step S5206, the AM 1205b judges, per set interval of time, whether or not the application to be deleted, which is currently running, has terminated (S5207). If the application has not terminated, the processing in step S5207 is performed again after the set interval of time.

In the case where it has been judged in step S5207 that the running application has been terminated (step S5207), the AM 1205b carries out processing from step S2806.

In this manner, in the present embodiment, the application with a high storage priority is stored after notifying the user of the situation in which the application to be deleted is running, and deleting the application when the user has terminated the application.

Note that in the above description, the AM 1205b carries out processing from step S2806 in the case where it has been judged that the running application has been terminated in step S5207; however, the AM 1205b may also carry out processing from step S2801 in FIG. 54.

A program execution device according to the present invention has hereby been described using the first through seventh embodiments, but the present invention is not limited to these descriptions.

For example, in the first through seventh embodiments, the Java (R) program may be a mixture of parts written in Java and parts in a binary format directly executable by the CPU, or may be configured only of parts in a binary format directly executable by the CPU.

In addition, in the first through seventh embodiments, the ROM 512 may be deleted by storing details which the ROM 512 stores in the secondary storage unit 510. In addition, it is also possible to configure the secondary storage unit 510 of a plurality of sub-secondary storage units, with each sub-secondary storage unit saving differing information. It is possible to meticulously divide the sub-secondary storage units; for example, only tuning information is saved in one of the sub-secondary storage units, the library 1201b of the OS 1201 is saved in another sub-secondary storage unit, downloaded Java programs are saved in yet another sub-secondary storage unit, and so on.

In addition, in the first through seventh embodiments, the registered Java program is stored in the secondary storage unit 510, but the program may be stored in the primary storage unit 511. In the case where the downloaded Java programs are saved in the primary storage unit 511, all saved information disappears when the power is turned off.

In addition, the present invention is applicable in information devices such as personal computers, cellular phones, and the like.

Also, the POD 504 is in a detachable state, but the POD 504 may be attached in a non-detachable state. Note that in the case where the POD 504 is attached in a non-detachable state, the CPU 706 may be removed from the POD 504, and the CPU 514 may carry out the operation of the CPU 706.

In addition, the Java programs registered in the PODLib 1205e may not only include downloaded Java programs but also pre-stored Java programs as well. Moreover, by including a slot unit in which a removable storage medium, such as an SD (Secure Digital) (R) memory card, can be attached/removed, a Java program may be received from the storage medium.

In addition, in the first through seventh embodiments, downloading of the Java program is described as the DSMCC method, but another download method, aside from the DSMCC method, may be used. For example, by installing a network unit for connecting to a network, downloading the Java program via IP, in which the Java program is fetched from the Internet, is possible. In the case of downloading the Java program via IP, the DSMCC identifier in the AIT and XAIT information is not necessary; instead, an IP address is required to acquire the Java program.

FIG. 56 is a diagram showing an example of XAIT information necessary for downloading a Java program via IP. A protocol 4901 is used to acquire the Java program. An IP address 4902 is also used to acquire the Java program. The Java program defined in the row 4911 is a set of an identifier “701”, control information “autostart”, a protocol “http”, an IP address “123.456.0.1”, a program name “a/APP1Xlet”, a priority “200”, a storage priority “100”, and an application name “APP1”. Upon acquiring the XAIT information shown in FIG. 51, the AM 1205b acquires a file system of the Java program using the IP address acquired from the XAIT information, and stores this file system in the primary storage unit 511 or the secondary storage unit 510.

### INDUSTRIAL APPLICABILITY

A program execution device according to the present invention has an effect in which a user can use the device with peace of mind, and can be applied informational devices that are controlled by software, such as digital televisions, personal computers, cellular phones, and the like; an operational method of the device is of use as technology for managing storage of applications.

1. A program execution device that downloads and executes a program, said device comprising:
a storage unit having an area for storing the downloaded program;
a storage judgment unit operable to judge whether or not it is possible for each of plural programs, including a program to be downloaded, to be held in said storage unit, based on a specific priority assigned in advance to each of the programs;
a notification unit operable to notify a user of a message regarding treatment of the program judged by said storage judgment unit as being impossible to be held;
a storage processing unit operable to store, in said storage unit, the program to be downloaded which has been judged by said storage judgment unit as being possible to be held; and
an execution unit operable to execute the program stored in said storage unit.

2. The program execution device according to claim 1, further comprising
a capacity acquisition unit operable to acquire a storage capacity required for storing each of the plural programs and an available space in said storage unit,
wherein said storage judgment unit is operable to judge, based on the storage capacity and the available space acquired by said space acquisition unit, that a program with a high priority can be preferentially stored, as long as the storage space of one program or all of the plural programs to be stored does not exceed a capacity in said storage unit.

3. The program execution device according to claim 2, further comprising
a deletion unit operable to delete a program stored in said storage unit, the program having been judged by said storage judgment unit as being impossible to be held,
wherein said notification unit is operable to notify the user of a message regarding the deletion of the program, and
said storage processing unit is operable to store, in the storage unit from which the program has been deleted, the program to be downloaded that has been judged by said storage judgment unit as being possible to be held.

4. The program execution device according to claim 3,
wherein said deletion unit is operable to delete the program stored in said storage unit after detecting that the user has been notified by said notification unit.

5. The program execution device according to claim 4,
wherein said notification unit is operable to notify the user of a message requesting the user to confirm the deletion of the program stored in said storage unit, and
said program execution device further comprises
a confirmation acquisition unit operable to acquire a result of a confirmation which the user has made in response to the message,
wherein said deletion unit is operable to delete the program stored in said storage unit upon detecting that said confirmation acquisition unit has acquired the result of the confirmation.

6. The program execution device according to claim 4,
wherein said notification unit is operable to notify the user of a message inquiring whether or not it is acceptable to delete the program stored in said storage unit, and
said program execution device further comprises
an answer acquisition unit operable to acquire a result of an answer which the user has made in response to the message,
wherein said deletion unit is operable to delete the program stored in said storage unit upon detecting that the result of the answer acquired by said answer acquisition unit indicates that deletion has been allowed.

7. The program execution device according to claim 6, further comprising
a priority change unit operable to raise the priority of the program stored in said storage unit, the program having been judged by said storage judgment unit as being impossible to be held, upon detecting that the result of the answer acquired by said answer acquisition unit indicates that deletion has been rejected,
wherein said storage judgment unit is operable to judge, again, whether or not it is possible to hold each of the programs in said storage unit, based on the priority changed by said priority change unit.

8. The program execution device according to claim 4,
wherein said storage judgment unit is further operable to judge whether or not the plural programs judged as being impossible to be held are stored in said storage unit;
said notification unit is operable to notify the user of a message prompting selection of which program, from among the plural programs judged to be stored by said storage judgment unit, to delete; and
said program execution device further comprises
a selection result acquisition unit operable to acquire a result of the selection made by the user in response to the message,
wherein said deletion unit is operable to delete the program indicated by the result of the selection acquired by said selection result acquisition unit.

9. The program execution device according to claim 4,
wherein said notification unit is operable to display the message to the user by using the program stored in said storage unit.

10. The program execution device according to claim 3, further comprising
an execution judgment unit operable to judge whether or not the program, which has been judged by said storage judgment unit as being impossible to be held, is being executed by said execution unit;
wherein said notification unit is operable to notify the user of a message regarding deletion of the program judged by said execution judgment unit as being executed.

11. The program execution device according to claim 10,
wherein said deletion unit is operable to terminate execution of the program judged by said execution judgment unit as being executed, and to delete the program.

12. The program execution device according to claim 11,
wherein said notification unit is operable to notify the user of a message inquiring whether or not it is acceptable to delete the program judged by said execution judgment unit as being executed, and
said program execution device further comprises
an answer acquisition unit operable to acquire a result of an answer which the user has made in response to the message, and
said deletion unit is operable to terminate and delete the program being executed, upon detecting that the result of the answer acquired by said answer acquisition unit indicates that deletion has been allowed.

13. The program execution device according to claim 10,
wherein upon detecting that the program being executed has been terminated based on a result of the judgment carried out by said execution judgment unit, said deletion unit is operable to delete the program.

14. The program execution device according to claim 2,
wherein said notification unit is operable to notify the user of a message regarding storage of the program to be downloaded that has been judged by said storage judgment unit as being impossible to be held.

15. The program execution device according to claim 14,
wherein said storage judgment unit is further operable to judge whether or not the plural programs judged as being impossible to be held are stored in said storage unit;
said notification unit is operable to notify the user of a message prompting selection of which program to store, from among the plural programs judged not to be stored by said storage judgment unit; and
said program execution device further comprises
a selection result acquisition unit operable to acquire a result of the selection made by the user in response to the message,
wherein said deletion unit is operable to store the program indicated in the result of the selection acquired by said selection result acquisition unit.

16. The program execution device according to claim 2,
wherein said storage judgment unit is operable to judge whether or not to store, in said storage unit, each of plural programs that are of types differing from one another.

17. A program execution method for downloading and executing a program, said method comprising:
a storage judgment step of judging whether or not it is possible for each of plural programs, including a program to be downloaded, to be held in a storage unit, based on a specific priority assigned in advance to each of the programs;
a notification step of notifying a user of a message regarding treatment of the program judged in said storage judgment step as being impossible to be held;
a storage processing step of storing, in said storage unit, the program to be downloaded which has been judged in said storage judgment step as being possible to be held; and
an execution step of executing the program stored in said storage unit.

18. A program for downloading an application program and causing a computer to execute the application program, said program comprising:
a storage judgment step of judging whether or not it is possible for each of plural application programs, including an application program to be downloaded, to be held in a storage unit, based on a specific priority assigned in advance to each of the application programs;
a notification step of notifying a user of a message regarding treatment of the application program judged in said storage judgment step as being impossible to be held;
a storage processing step of storing, in said storage unit, the application program to be downloaded which has been judged in said storage judgment step as being possible to be held; and
an execution step of executing the application program stored in said storage unit.
